(19) United States
(12) Patent Application Publication
(10) Pub. No.: US 2025/0111822 A1
(43) Pub. Date: Apr. 3, 2025

(54) CONTEXTUAL SYSTEMS

(71) Applicant: Apple Inc., Cupertino, CA (US)

(72) Inventors: Clarisse MAZUIR, San Jose, CA (US); Daamun MOHSENI, Campbell, CA (US); Christopher P. FOSS, San Francisco, CA (US); Kurt R. STIEHL, Los Gatos, CA (US); Lynne DEVINE, San Francisco, CA (US); Jonathan P. IVE, San Francisco, CA (US); Matthew J. ALLEN, Menlo Park, CA (US); Kevin M. LYNCH, Woodside, CA (US); Alan C. DYE, San Francisco, CA (US); Xiaofeng TANG, Santa Clara, CA (US); Daniel DE ROCHA ROSARIO, San Francisco, CA (US); Ronak J. SHAH, Sunnyvale, CA (US); Tom HSU, Santa Clara, CA (US); Tao ZHAN, Saratoga, CA (US); Rong LIU, Cupertino, CA (US); Morteza AMOOREZAEI, San Jose, CA (US); Syed Tauseen Aqeel SHAH, San Jose, CA (US); Ziruo HONG, San Jose, CA (US); Yanhui XIE, Cupertino, CA (US); Yu P. SUN, Yorba Linda, CA (US); Yong Seok CHOI, Pleasanton, CA (US)

(21) Appl. No.: 18/897,108

(22) Filed: Sep. 26, 2024

Related U.S. Application Data
(60) Provisional application No. 63/541,814, filed on Sep. 30, 2023.

(51) Int. Cl. G09G 3/32

(52) U.S. Cl. CPC G09G 3/32; G09G 2320/0626; G09G 2340/045; G09G 2380/10

(57) ABSTRACT

A system may include a display having a housing, a cover lens coupled to the housing, a light plate assembly in the housing, a diffuser that overlaps the light plate assembly, a louver layer that overlaps the diffuser, and a ring light source that emits additional light around the periphery of the light plate assembly and through the cover lens. The light plate assembly may include an array of light-emitting components. To improve the efficiency and contrast of the light plate assembly, reflective fill material may be formed around each light-emitting component, and absorptive fill material may surround the reflective fill material. The absorptive fill material may absorb ambient light, while the reflective fill material may redirect stray light out of the display. Dam material may surround the absorptive fill material and/or the reflective fill material.

### CROSS-REFERENCE TO RELATED APPLICATIONS

This application claims priority to U.S. Provisional Patent Application Ser. No. 63/541,814 entitled “CONTEXTUAL SYSTEMS,” filed Sep. 30, 2023, which is hereby incorporated by reference in its entirety for all purposes.

### BACKGROUND

Automobiles and other vehicles have lights such as headlights and taillights. These lights may be provided with sources of illumination such as light-emitting diodes or lamps.

### SUMMARY

In some embodiments, a mobile system is described. In some embodiments, the mobile system comprises an exterior surface at least partially surrounding an interior, one or more sensors configured to detect signals corresponding to an environment exterior to the exterior surface of the mobile system, wherein the signals correspond to the proximity of an object relative to the mobile system, and a display positioned on the exterior surface of the mobile system, wherein the display is configured to display a representation of the object, and wherein the display is obscured from the interior such that the representation of the object is not visible from a first position within the interior.

In some embodiments, a non-transitory computer-readable storage medium storing one or more programs configured to be executed by one or more processors of a computer system that includes an exterior surface and that is in communication with one or more sensors and a display is described. In some embodiments, the exterior surface at least partially surrounds an interior. In some embodiments, the one or more sensors are configured to detect signals corresponding to an environment exterior to the exterior surface of the mobile system. In some embodiments, the signals correspond to proximity of an object relative to the mobile system. In some embodiments, the display is positioned on the exterior surface of the mobile system and configured to display a representation of the object. In some embodiments, the display is obscured from the interior such that the representation of the object is not visible from a first position within the interior. In some embodiments, the one or more programs include instructions for: detecting, via the one or more sensors, proximity of an object relative to the mobile system; and, in response to detecting the proximity of the object relative to the mobile system, displaying, via the display, a representation of the object such that the representation of the object is not visible from a first position within an interior that is at least partially surrounded by the exterior surface.

In some embodiments, a transitory computer-readable storage medium storing one or more programs configured to be executed by one or more processors of a computer system that includes an exterior surface and that is in communication with one or more sensors and a display is described. In some embodiments, the exterior surface at least partially surrounds an interior. In some embodiments, the one or more sensors are configured to detect signals corresponding to an environment exterior to the exterior surface of the mobile system. In some embodiments, the signals correspond to proximity of an object relative to the mobile system. In some embodiments, the display is positioned on the exterior surface of the mobile system and configured to display a representation of the object. In some embodiments, the display is obscured from the interior such that the representation of the object is not visible from a first position within the interior. In some embodiments, the one or more programs include instructions for: detecting, via the one or more sensors, proximity of an object relative to the mobile system; and, in response to detecting the proximity of the object relative to the mobile system, displaying, via the display, a representation of the object such that the representation of the object is not visible from a first position within an interior that is at least partially surrounded by the exterior surface.

In some embodiments, a computer system that includes an exterior surface and that is in communication with one or more sensors and a display is described. In some embodiments, the exterior surface at least partially surrounds an interior. In some embodiments, the one or more sensors are configured to detect signals corresponding to an environment exterior to the exterior surface of the mobile system. In some embodiments, the signals correspond to proximity of an object relative to the mobile system. In some embodiments, the display is positioned on the exterior surface of the mobile system and configured to display a representation of the object. In some embodiments, the display is obscured from the interior such that the representation of the object is not visible from a first position within the interior. In some embodiments, the computer system includes one or more processors and memory storing one or more programs configured to be executed by the one or more processors. In some embodiments, the one or more programs include instructions for: detecting, via the one or more sensors, proximity of an object relative to the mobile system; and, in response to detecting the proximity of the object relative to the mobile system, displaying, via the display, a representation of the object such that the representation of the object is not visible from a first position within an interior that is at least partially surrounded by the exterior surface.

In some embodiments, a computer system that includes an exterior surface and that is in communication with one or more sensors and a display is described. In some embodiments, the exterior surface at least partially surrounds an interior. In some embodiments, the one or more sensors are configured to detect signals corresponding to an environment exterior to the exterior surface of the mobile system. In some embodiments, the signals correspond to proximity of an object relative to the mobile system. In some embodiments, the display is positioned on the exterior surface of the mobile system and configured to display a representation of the object. In some embodiments, the display is obscured from the interior such that the representation of the object is not visible from a first position within the interior. In some embodiments, the computer system includes means for performing each of the following steps: detecting, via the one or more sensors, proximity of an object relative to the mobile system; and in response to detecting the proximity of the object relative to the mobile system, displaying, via the display, a representation of the object such that the representation of the object is not visible from a first position within an interior that is at least partially surrounded by the exterior surface.

In some embodiments, a computer program product is described. In some embodiments, the computer program product comprises one or more programs configured to be executed by one or more processors of a computer system that includes an exterior surface and that is in communication with one or more sensors and a display is described. In some embodiments, the exterior surface at least partially surrounds an interior. In some embodiments, the one or more sensors are configured to detect signals corresponding to an environment exterior to the exterior surface of the mobile system. In some embodiments, the signals correspond to proximity of an object relative to the mobile system. In some embodiments, the display is positioned on the exterior surface of the mobile system and configured to display a representation of the object. In some embodiments, the display is obscured from the interior such that the representation of the object is not visible from a first position within the interior. In some embodiments, the one or more programs include instructions for: detecting, via the one or more sensors, proximity of an object relative to the mobile system; and in response to detecting the proximity of the object relative to the mobile system, displaying, via the display, a representation of the object such that the representation of the object is not visible from a first position within an interior that is at least partially surrounded by the exterior surface.

In some embodiments, a method that is performed at a computer system that includes an exterior surface and that is in communication with one or more sensors and a display is described. In some embodiments, the exterior surface at least partially surrounds an interior. In some embodiments, the one or more sensors are configured to detect signals corresponding to an environment exterior to the exterior surface of the mobile system. In some embodiments, the signals correspond to proximity of an object relative to the mobile system. In some embodiments, the display is positioned on the exterior surface of the mobile system and configured to display a representation of the object. In some embodiments, the display is obscured from the interior such that the representation of the object is not visible from a first position within the interior. In some embodiments, the method comprises: detecting, via the one or more sensors, proximity of an object relative to the mobile system; and in response to detecting the proximity of the object relative to the mobile system, displaying, via the display, a representation of the object such that the representation of the object is not visible from a first position within an interior that is at least partially surrounded by the exterior surface.

In some embodiments, a mobile system is described. In some embodiments, the mobile system comprises: an exterior surface at least partially surrounding an interior; a first display positioned on the exterior surface, the first display being disposed on a first side of a longitudinal centerline of the mobile system; and a second display positioned on the exterior surface, the second display being disposed on a second side of the longitudinal centerline of the mobile system, the second side being opposite to the first side, wherein the first display is configured to display a first representation of an object external to the interior, wherein the first representation corresponds to the position of the object with respect to the first side, the second display is configured to display a second representation of the object, and wherein the second representation corresponds to the position of the object with respect to the second side.

In some embodiments, a non-transitory computer-readable storage medium storing one or more programs configured to be executed by one or more processors of a computer system that includes an exterior surface and that is in communication with a first display and a second display is described. In some embodiments, the exterior surface at least partially surrounds an interior. In some embodiments, the first display is positioned on the exterior surface and disposed on a first side of a longitudinal centerline of the computer system. In some embodiments, the second display is positioned on the exterior surface and is disposed on a second side of the longitudinal centerline of the mobile. In some embodiments, the second side is opposite to the first side. In some embodiments, the first display is configured to display a first representation of an object external to the interior. In some embodiments, the first representation corresponds to the position of the object with respect to the first side. In some embodiments, the second display is configured to display a second representation of the object. In some embodiments, the second representation corresponds to the position of the object with respect to the second side. In some embodiments, the one or more programs includes instructions for: displaying, via the first display, a first representation of an object external to the interior, wherein the first representation corresponds to the position of the object with respect to the first side; and displaying, via the second display, a second representation of the object, and wherein the second representation corresponds to the position of the object with respect to the second side.

In some embodiments, a transitory computer-readable storage medium storing one or more programs configured to be executed by one or more processors of a computer system that includes an exterior surface and that is in communication with a first display and a second display is described. In some embodiments, the exterior surface at least partially surrounds an interior. In some embodiments, the first display is positioned on the exterior surface and disposed on a first side of a longitudinal centerline of the computer system. In some embodiments, the second display is positioned on the exterior surface and is disposed on a second side of the longitudinal centerline of the mobile. In some embodiments, the second side is opposite to the first side. In some embodiments, the first display is configured to display a first representation of an object external to the interior. In some embodiments, the first representation corresponds to the position of the object with respect to the first side. In some embodiments, the second display is configured to display a second representation of the object. In some embodiments, the second representation corresponds to the position of the object with respect to the second side. In some embodiments, the one or more programs includes instructions for: displaying, via the first display, a first representation of an object external to the interior, wherein the first representation corresponds to the position of the object with respect to the first side; and displaying, via the second display, a second representation of the object, and wherein the second representation corresponds to the position of the object with respect to the second side.

In some embodiments, a computer system that includes an exterior surface and that is in communication with a first display and a second display is described. In some embodiments, the exterior surface at least partially surrounds an interior. In some embodiments, the first display is positioned on the exterior surface and disposed on a first side of a longitudinal centerline of the computer system. In some embodiments, the second display is positioned on the exterior surface and is disposed on a second side of the longitudinal centerline of the mobile. In some embodiments, the second side is opposite to the first side. In some embodiments, the first display is configured to display a first representation of an object external to the interior. In some embodiments, the first representation corresponds to the position of the object with respect to the first side. In some embodiments, the second display is configured to display a second representation of the object. In some embodiments, the second representation corresponds to the position of the object with respect to the second side. In some embodiments, the one or more programs includes instructions for: displaying, via the first display, a first representation of an object external to the interior, wherein the first representation corresponds to the position of the object with respect to the first side; and displaying, via the second display, a second representation of the object, and wherein the second representation corresponds to the position of the object with respect to the second side. In some embodiments, the computer system comprises one or more processors and memory storing one or more programs configured to be executed by the one or more processors, the one or more programs including instructions for: displaying, via the first display, a first representation of an object external to the interior, wherein the first representation corresponds to the position of the object with respect to the first side; and displaying, via the second display, a second representation of the object, and wherein the second representation corresponds to the position of the object with respect to the second side.

In some embodiments, a computer system that includes an exterior surface and that is in communication with a first display and a second display is described. In some embodiments, the exterior surface at least partially surrounds an interior. In some embodiments, the first display is positioned on the exterior surface and disposed on a first side of a longitudinal centerline of the computer system. In some embodiments, the second display is positioned on the exterior surface and is disposed on a second side of the longitudinal centerline of the mobile. In some embodiments, the second side is opposite to the first side. In some embodiments, the first display is configured to display a first representation of an object external to the interior. In some embodiments, the first representation corresponds to the position of the object with respect to the first side. In some embodiments, the second display is configured to display a second representation of the object. In some embodiments, the second representation corresponds to the position of the object with respect to the second side. In some embodiments, the one or more programs includes instructions for: displaying, via the first display, a first representation of an object external to the interior, wherein the first representation corresponds to the position of the object with respect to the first side; and displaying, via the second display, a second representation of the object, and wherein the second representation corresponds to the position of the object with respect to the second side. In some embodiments, the computer system comprises means for performing each of the following steps: displaying, via the first display, a first representation of an object external to the interior, wherein the first representation corresponds to the position of the object with respect to the first side; and displaying, via the second display, a second representation of the object, and wherein the second representation corresponds to the position of the object with respect to the second side.

In some embodiments, a computer program product is described. In some embodiments, the computer program product comprises one or more programs configured to be executed by one or more processors of a computer system that includes an exterior surface and that is in communication with a first display and a second display is described. In some embodiments, the exterior surface at least partially surrounds an interior. In some embodiments, the first display is positioned on the exterior surface and disposed on a first side of a longitudinal centerline of the computer system. In some embodiments, the second display is positioned on the exterior surface and is disposed on a second side of the longitudinal centerline of the mobile. In some embodiments, the second side is opposite to the first side. In some embodiments, the first display is configured to display a first representation of an object external to the interior. In some embodiments, the first representation corresponds to the position of the object with respect to the first side. In some embodiments, the second display is configured to display a second representation of the object. In some embodiments, the second representation corresponds to the position of the object with respect to the second side. In some embodiments, the one or more programs includes instructions for: displaying, via the first display, a first representation of an object external to the interior, wherein the first representation corresponds to the position of the object with respect to the first side; and displaying, via the second display, a second representation of the object, and wherein the second representation corresponds to the position of the object with respect to the second side.

In some embodiments, a method that is performed at a computer system that includes an exterior surface and that is in communication with a first display and a second display is described. In some embodiments, the exterior surface at least partially surrounds an interior. In some embodiments, the first display is positioned on the exterior surface and disposed on a first side of a longitudinal centerline of the computer system. In some embodiments, the second display is positioned on the exterior surface and is disposed on a second side of the longitudinal centerline of the mobile. In some embodiments, the second side is opposite to the first side. In some embodiments, the first display is configured to display a first representation of an object external to the interior. In some embodiments, the first representation corresponds to the position of the object with respect to the first side. In some embodiments, the second display is configured to display a second representation of the object. In some embodiments, the second representation corresponds to the position of the object with respect to the second side. In some embodiments, the method comprises: displaying, via the first display, a first representation of an object external to the interior, wherein the first representation corresponds to the position of the object with respect to the first side; and displaying, via the second display, a second representation of the object, and wherein the second representation corresponds to the position of the object with respect to the second side.

In some embodiments, a mobile system is described. In some embodiments, the mobile system comprises: an exterior surface at least partially surrounding an interior; an illumination source positioned on the exterior surface, the illumination source configured to illuminate an environment exterior to the exterior surface, the mobile system configured to move relative to the environment in a first direction; and a display positioned on the exterior surface configured to display a representation of an object detected in the proximity of the exterior surface, the display being obscured from the interior.

In some embodiments, a non-transitory computer-readable storage medium storing one or more programs configured to be executed by one or more processors of a computer system that includes an exterior surface and that is in communication with an illumination source and a display is described. In some embodiments, the exterior surface at least partially surrounds an interior. In some embodiments, the illumination source is positioned on the exterior surface. In some embodiments, the illumination source is configured to illuminate an environment exterior to the exterior surface. In some embodiments, the mobile system is configured to move relative to the environment in a first direction. In some embodiments, the display is positioned on the exterior surface. In some embodiments, the display is configured to display a representation of an object detected in the proximity of the exterior surface. In some embodiments, the display is obscured from the interior. In some embodiments, the one or more programs includes instructions for: illuminating, via the illumination source, an environment exterior to the exterior surface; moving the computer system relative to the environment in a first direction; detecting an object in the proximity of the exterior surface; and, in response to detecting the object in the proximity of the exterior surface, displaying, via the display, a representation of the object, wherein the display is obscured from the interior.

In some embodiments, a transitory computer-readable storage medium storing one or more programs configured to be executed by one or more processors of a computer system that includes an exterior surface and that is in communication with an illumination source and a display is described. In some embodiments, the exterior surface at least partially surrounds an interior. In some embodiments, the illumination source is positioned on the exterior surface. In some embodiments, the illumination source is configured to illuminate an environment exterior to the exterior surface. In some embodiments, the mobile system is configured to move relative to the environment in a first direction. In some embodiments, the display is positioned on the exterior surface. In some embodiments, the display is configured to display a representation of an object detected in the proximity of the exterior surface. In some embodiments, the display is obscured from the interior. In some embodiments, the one or more programs includes instructions for: illuminating, via the illumination source, an environment exterior to the exterior surface; moving the computer system relative to the environment in a first direction; detecting an object in the proximity of the exterior surface; and, in response to detecting the object in the proximity of the exterior surface, displaying, via the display, a representation of the object, wherein the display is obscured from the interior.

In some embodiments, a computer system that includes an exterior surface and that is in communication with an illumination source and a display is described. In some embodiments, the exterior surface at least partially surrounds an interior. In some embodiments, the illumination source is positioned on the exterior surface. In some embodiments, the illumination source is configured to illuminate an environment exterior to the exterior surface. In some embodiments, the mobile system is configured to move relative to the environment in a first direction. In some embodiments, the display is positioned on the exterior surface. In some embodiments, the display is configured to display a representation of an object detected in the proximity of the exterior surface. In some embodiments, the display is obscured from the interior. In some embodiments, the computer system comprises one or more processors and memory storing one or more programs configured to be executed by the one or more processors. In some embodiments, the one or more programs includes instructions for: illuminating, via the illumination source, an environment exterior to the exterior surface; moving the computer system relative to the environment in a first direction; detecting an object in the proximity of the exterior surface; and, in response to detecting the object in the proximity of the exterior surface, displaying, via the display, a representation of the object, wherein the display is obscured from the interior.

In some embodiments, a computer system that includes an exterior surface and that is in communication with an illumination source and a display is described. In some embodiments, the exterior surface at least partially surrounds an interior. In some embodiments, the illumination source is positioned on the exterior surface. In some embodiments, the illumination source is configured to illuminate an environment exterior to the exterior surface. In some embodiments, the mobile system is configured to move relative to the environment in a first direction. In some embodiments, the display is positioned on the exterior surface. In some embodiments, the display is configured to display a representation of an object detected in the proximity of the exterior surface. In some embodiments, the display is obscured from the interior. In some embodiments, the computer system comprises means for performing each of the following steps: illuminating, via the illumination source, an environment exterior to the exterior surface; moving the computer system relative to the environment in a first direction; detecting an object in the proximity of the exterior surface; and, in response to detecting the object in the proximity of the exterior surface, displaying, via the display, a representation of the object, wherein the display is obscured from the interior.

In some embodiments, a computer program product is described. In some embodiments, the computer program product comprises one or more programs configured to be executed by one or more processors of a computer system that includes an exterior surface and that is in communication with an illumination source and a display. In some embodiments, the exterior surface at least partially surrounds an interior. In some embodiments, the illumination source is positioned on the exterior surface. In some embodiments, the illumination source is configured to illuminate an environment exterior to the exterior surface. In some embodiments, the mobile system is configured to move relative to the environment in a first direction. In some embodiments, the display is positioned on the exterior surface. In some embodiments, the display is configured to display a representation of an object detected in the proximity of the exterior surface. In some embodiments, the display is obscured from the interior. In some embodiments, the one or more programs includes instructions for: illuminating, via the illumination source, an environment exterior to the exterior surface; moving the computer system relative to the environment in a first direction; detecting an object in the proximity of the exterior surface; and, in response to detecting the object in the proximity of the exterior surface, displaying, via the display, a representation of the object, wherein the display is obscured from the interior.

In some embodiments, a method that is performed at a computer system that includes an exterior surface and that is in communication with an illumination source and a display is described. In some embodiments, the exterior surface at least partially surrounds an interior. In some embodiments, the illumination source is positioned on the exterior surface. In some embodiments, the illumination source is configured to illuminate an environment exterior to the exterior surface. In some embodiments, the mobile system is configured to move relative to the environment in a first direction. In some embodiments, the display is positioned on the exterior surface. In some embodiments, the display is configured to display a representation of an object detected in the proximity of the exterior surface. In some embodiments, the display is obscured from the interior. In some embodiments, the method comprises: illuminating, via the illumination source, an environment exterior to the exterior surface; moving the computer system relative to the environment in a first direction; detecting an object in the proximity of the exterior surface; and, in response to detecting the object in the proximity of the exterior surface, displaying, via the display, a representation of the object, wherein the display is obscured from the interior.

In some embodiments, a mobile system is described. In some embodiments, the mobile system comprises: an exterior surface at least partially surrounding an interior; a display positioned on the exterior surface; one or more processors; and memory storing one or more programs configured to be executed by the one or more processors, the one or more programs including instructions for: concurrently displaying, via the display: an indication of a state of the mobile system; and an indication of a state of an environment external to the mobile system.

In some embodiments, a non-transitory computer-readable storage medium storing one or more programs configured to be executed by one or more processors of a computer system that includes an exterior surface and that is in communication with a display is described. In some embodiments, the exterior surface at least partially surrounds an interior. In some embodiments, the display is positioned on the exterior surface. In some embodiments, the one or more programs include instructions for: concurrently displaying, via the display: an indication of a state of the mobile system; and an indication of a state of an environment external to the mobile system.

In some embodiments, a transitory computer-readable storage medium storing one or more programs configured to be executed by one or more processors of a computer system that includes an exterior surface and that is in communication with a display is described. In some embodiments, the exterior surface at least partially surrounds an interior. In some embodiments, the display is positioned on the exterior surface. In some embodiments, the one or more programs include instructions for: concurrently displaying, via the display: an indication of a state of the mobile system; and an indication of a state of an environment external to the mobile system.

In some embodiments, a computer system that includes an exterior surface and that is in communication with a display is described. In some embodiments, the exterior surface at least partially surrounds an interior. In some embodiments, the display is positioned on the exterior surface. In some embodiments, the computer system comprises one or more processors; and memory storing one or more programs configured to be executed by the one or more processors. In some embodiments, the one or more programs includes instructions for: concurrently displaying, via the display: an indication of a state of the mobile system; and an indication of a state of an environment external to the mobile system.

In some embodiments, a computer system that includes an exterior surface and that is in communication with a display is described. In some embodiments, the exterior surface at least partially surrounds an interior. In some embodiments, the display is positioned on the exterior surface. In some embodiments, the computer system comprises means for performing each of the following steps: concurrently displaying, via the display: an indication of a state of the mobile system; and an indication of a state of an environment external to the mobile system.

In some embodiments, a computer program product is described. In some embodiments, the computer program product comprises one or more programs configured to be executed by one or more processors of a computer system that includes an exterior surface and that is in communication with a display. In some embodiments, the exterior surface at least partially surrounds an interior. In some embodiments, the display is positioned on the exterior surface. In some embodiments, the one or more programs include instructions for: concurrently displaying, via the display: an indication of a state of the mobile system; and an indication of a state of an environment external to the mobile system.

In some embodiments, a method that is performed at a computer system that includes an exterior surface and that is in communication with a display is described. In some embodiments, the exterior surface at least partially surrounds an interior. In some embodiments, the display is positioned on the exterior surface. In some embodiments, the method comprises: concurrently displaying, via the display: an indication of a state of the mobile system; and an indication of a state of an environment external to the mobile system.

In some embodiments, a mobile system is described. In some embodiments, the mobile system comprises: an exterior surface at least partially surrounding an interior; a first display positioned on the exterior surface; a first illumination source that at least partially surrounds the first display; one or more processors; and memory storing one or more programs configured to be executed by the one or more processors, the one or more programs including instructions for: while the first display and the first illumination source are in an active state, detecting movement of an object in an environment that is outside of the mobile system; in response to detecting movement of the object in the environment that is outside of the mobile system: in accordance with a determination that the object is moving in a first direction, updating the first display based on the movement of the object in the first direction without updating the first illumination source based on the movement of the object; and in accordance with a determination that the object is moving in a second direction that is different from the first direction, updating the first display based on movement of the object in the second direction without updating the first illumination source based on the movement of the object.

In some embodiments, a non-transitory computer-readable storage medium storing one or more programs configured to be executed by one or more processors of a computer system that includes an exterior surface and that is in communication with a first display and a first illumination source is described. In some embodiments, the exterior surface at least partially surrounds an interior. In some embodiments, the first display is positioned on the exterior surface. In some embodiments, the first illumination source at least partially surrounds the first display. In some embodiments, the one or more programs include instructions for: while the first display and the first illumination source are in an active state, detecting movement of an object in an environment that is outside of the mobile system; and in response to detecting movement of the object in the environment that is outside of the mobile system: in accordance with a determination that the object is moving in a first direction, updating the first display based on the movement of the object in the first direction without updating the first illumination source based on the movement of the object; and in accordance with a determination that the object is moving in a second direction that is different from the first direction, updating the first display based on movement of the object in the second direction without updating the first illumination source based on the movement of the object.

In some embodiments, a transitory computer-readable storage medium storing one or more programs configured to be executed by one or more processors of a computer system that includes an exterior surface and that is in communication with a first display and a first illumination source is described. In some embodiments, the exterior surface at least partially surrounds an interior. In some embodiments, the first display is positioned on the exterior surface. In some embodiments, the first illumination source at least partially surrounds the first display. In some embodiments, the one or more programs include instructions for: while the first display and the first illumination source are in an active state, detecting movement of an object in an environment that is outside of the mobile system; and in response to detecting movement of the object in the environment that is outside of the mobile system: in accordance with a determination that the object is moving in a first direction, updating the first display based on the movement of the object in the first direction without updating the first illumination source based on the movement of the object; and in accordance with a determination that the object is moving in a second direction that is different from the first direction, updating the first display based on movement of the object in the second direction without updating the first illumination source based on the movement of the object.

In some embodiments, a computer system that includes an exterior surface and that is in communication with a first display and a first illumination source is described. In some embodiments, the exterior surface at least partially surrounds an interior. In some embodiments, the first display is positioned on the exterior surface. In some embodiments, the first illumination source at least partially surrounds the first display. In some embodiments, the computer system comprises one or more processors and memory storing one or more programs configured to be executed by the one or more processors. In some embodiments, the one or more programs includes instructions for: while the first display and the first illumination source are in an active state, detecting movement of an object in an environment that is outside of the mobile system; and in response to detecting movement of the object in the environment that is outside of the mobile system: in accordance with a determination that the object is moving in a first direction, updating the first display based on the movement of the object in the first direction without updating the first illumination source based on the movement of the object; and in accordance with a determination that the object is moving in a second direction that is different from the first direction, updating the first display based on movement of the object in the second direction without updating the first illumination source based on the movement of the object.

In some embodiments, a computer system that includes an exterior surface and that is in communication with a first display and a first illumination source is described. In some embodiments, the exterior surface at least partially surrounds an interior. In some embodiments, the first display is positioned on the exterior surface. In some embodiments, the first illumination source at least partially surrounds the first display. In some embodiments, the computer system comprises means for performing each of the following steps: while the first display and the first illumination source are in an active state, detecting movement of an object in an environment that is outside of the mobile system; and in response to detecting movement of the object in the environment that is outside of the mobile system: in accordance with a determination that the object is moving in a first direction, updating the first display based on the movement of the object in the first direction without updating the first illumination source based on the movement of the object; and in accordance with a determination that the object is moving in a second direction that is different from the first direction, updating the first display based on movement of the object in the second direction without updating the first illumination source based on the movement of the object.

In some embodiments, a computer program product is described. In some embodiments, the computer program product comprises one or more programs configured to be executed by one or more processors of a computer system that includes an exterior surface and that is in communication with a first display and a first illumination source. In some embodiments, the exterior surface at least partially surrounds an interior. In some embodiments, the first display is positioned on the exterior of the surface. In some embodiments, the first illumination source at least partially surrounds the first display. In some embodiments, the one or more programs include instructions for: while the first display and the first illumination source are in an active state, detecting movement of an object in an environment that is outside of the mobile system; and in response to detecting movement of the object in the environment that is outside of the mobile system: in accordance with a determination that the object is moving in a first direction, updating the first display based on the movement of the object in the first direction without updating the first illumination source based on the movement of the object; and in accordance with a determination that the object is moving in a second direction that is different from the first direction, updating the first display based on movement of the object in the second direction without updating the first illumination source based on the movement of the object.

In some embodiments, a method that is performed at a computer system that includes an exterior surface and that is in communication with a first display and a first illumination source is described. In some embodiments, the exterior surface at least partially surrounds an interior. In some embodiments, the first display is positioned on the exterior of the surface. In some embodiments, the first illumination source at least partially surrounds the first display. In some embodiments, the method comprises: while the first display and the first illumination source are in an active state, detecting movement of an object in an environment that is outside of the mobile system; and in response to detecting movement of the object in the environment that is outside of the mobile system: in accordance with a determination that the object is moving in a first direction, updating the first display based on the movement of the object in the first direction without updating the first illumination source based on the movement of the object; and in accordance with a determination that the object is moving in a second direction that is different from the first direction, updating the first display based on movement of the object in the second direction without updating the first illumination source based on the movement of the object.

In some embodiments, a mobile system is described. In some embodiments, the mobile system comprises: an exterior surface at least partially surrounding an interior; a display positioned on the exterior surface; one or more processors; and memory storing one or more programs configured to be executed by the one or more processors, the one or more programs including instructions for: concurrently displaying, via the display: an indication of an autonomous state of the mobile system; and an indication of a movement intention of the mobile system that is different from the indication of the autonomous state of the mobile system.

In some embodiments, a non-transitory computer-readable storage medium storing one or more programs configured to be executed by one or more processors of a computer system that includes an exterior surface and that is in communication with a display is described. In some embodiments, the exterior surface at least partially surrounds an interior. In some embodiments, the display is positioned on the exterior surface. In some embodiments, the one or more programs include instructions for: concurrently displaying, via the display: an indication of an autonomous state of the mobile system; and an indication of a movement intention of the mobile system that is different from the indication of the autonomous state of the mobile system.

In some embodiments, a transitory computer-readable storage medium storing one or more programs configured to be executed by one or more processors of a computer system that includes an exterior surface and that is in communication with a display is described. In some embodiments, the exterior surface at least partially surrounds an interior. In some embodiments, the display is positioned on the exterior surface. In some embodiments, the one or more programs include instructions for: concurrently displaying, via the display: an indication of an autonomous state of the mobile system; and an indication of a movement intention of the mobile system that is different from the indication of the autonomous state of the mobile system.

In some embodiments, a computer system that includes an exterior surface and that is in communication with a display is described. In some embodiments, the exterior surface at least partially surrounds an interior. In some embodiments, the display is positioned on the exterior surface. In some embodiments, the computer system comprises one or more processors; and memory storing one or more programs configured to be executed by the one or more processors. In some embodiments, the one or more programs includes instructions for: concurrently displaying, via the display: an indication of an autonomous state of the mobile system; and an indication of a movement intention of the mobile system that is different from the indication of the autonomous state of the mobile system.

In some embodiments, a computer system that includes an exterior surface and that is in communication with a display is described. In some embodiments, the exterior surface at least partially surrounds an interior. In some embodiments, the display is positioned on the exterior surface. In some embodiments, the computer system comprises means for performing each of the following steps: concurrently displaying, via the display: an indication of an autonomous state of the mobile system; and an indication of a movement intention of the mobile system that is different from the indication of the autonomous state of the mobile system.

In some embodiments, a computer program product is described. In some embodiments, the computer program product comprises one or more programs configured to be executed by one or more processors of a computer system that includes an exterior surface and that is in communication with a display. In some embodiments, the exterior surface at least partially surrounds an interior. In some embodiments, the display is positioned on the exterior surface. In some embodiments, the one or more programs include instructions for: concurrently displaying, via the display: an indication of an autonomous state of the mobile system; and an indication of a movement intention of the mobile system that is different from the indication of the autonomous state of the mobile system.

In some embodiments, a method that is performed at a computer system that includes an exterior surface and that is in communication with a display is described. In some embodiments, the exterior surface at least partially surrounds an interior. In some embodiments, the display is positioned on the exterior surface. In some embodiments, the method comprises: concurrently displaying, via the display: an indication of an autonomous state of the mobile system; and an indication of a movement intention of the mobile system that is different from the indication of the autonomous state of the mobile system.

In some embodiments, a mobile system is described. In some embodiments, the mobile system comprises: an exterior surface surrounding an interior; a suspension system; one or more processors; and memory storing one or more programs configured to be executed by the one or more processors, the one or more programs including instructions for: detecting an intent to change a motion state of the mobile system; and in response to detecting the intent to change the motion state of the mobile system: in accordance with a determination that the intent to change the motion state of the mobile system corresponds to a transition from a non-moving state to a moving state, elevating, via the suspension system, the mobile system; and in accordance with a determination that the intent to change the motion state of the mobile system corresponds to a transition from the moving state to the non-moving state, lowering, via the suspension system, the mobile system.

In some embodiments, a non-transitory computer-readable storage medium storing one or more programs configured to be executed by one or more processors of a computer system that includes an exterior surface and that is in communication with a suspension system is described. In some embodiments, the exterior surface surrounds an interior. In some embodiments, the one or more programs include instructions for: detecting an intent to change a motion state of the mobile system; and in response to detecting the intent to change the motion state of the mobile system: in accordance with a determination that the intent to change the motion state of the mobile system corresponds to a transition from a non-moving state to a moving state, elevating, via the suspension system, the mobile system; and in accordance with a determination that the intent to change the motion state of the mobile system corresponds to a transition from the moving state to the non-moving state, lowering, via the suspension system, the mobile system.

In some embodiments, a transitory computer-readable storage medium storing one or more programs configured to be executed by one or more processors of a computer system that includes an exterior surface and that is in communication with a suspension system is described. In some embodiments, the exterior surface surrounds an interior. In some embodiments, the one or more programs include instructions for: detecting an intent to change a motion state of the mobile system; and in response to detecting the intent to change the motion state of the mobile system: in accordance with a determination that the intent to change the motion state of the mobile system corresponds to a transition from a non-moving state to a moving state, elevating, via the suspension system, the mobile system; and in accordance with a determination that the intent to change the motion state of the mobile system corresponds to a transition from the moving state to the non-moving state, lowering, via the suspension system, the mobile system.

In some embodiments, a computer system that includes an exterior surface and that is in communication with a suspension system is described. In some embodiments, the exterior surface surrounds an interior. In some embodiments, the computer system comprises one or more processors; and memory storing one or more programs configured to be executed by the one or more processors. In some embodiments, the one or more programs includes instructions for: detecting an intent to change a motion state of the mobile system; and in response to detecting the intent to change the motion state of the mobile system: in accordance with a determination that the intent to change the motion state of the mobile system corresponds to a transition from a non-moving state to a moving state, elevating, via the suspension system, the mobile system; and in accordance with a determination that the intent to change the motion state of the mobile system corresponds to a transition from the moving state to the non-moving state, lowering, via the suspension system, the mobile system.

In some embodiments, a computer system that includes an exterior surface and that is in communication with a suspension system is described. In some embodiments, the exterior surface surrounds an interior. In some embodiments, the computer system comprises means for performing each of the following steps: detecting an intent to change a motion state of the mobile system; and in response to detecting the intent to change the motion state of the mobile system: in accordance with a determination that the intent to change the motion state of the mobile system corresponds to a transition from a non-moving state to a moving state, elevating, via the suspension system, the mobile system; and in accordance with a determination that the intent to change the motion state of the mobile system corresponds to a transition from the moving state to the non-moving state, lowering, via the suspension system, the mobile system.

In some embodiments, a computer program product is described. In some embodiments, the computer program product comprises one or more programs configured to be executed by one or more processors of a computer system that includes an exterior surface and that is in communication with a suspension system. In some embodiments, the exterior surface surrounds an interior. In some embodiments, the one or more programs include instructions for detecting an intent to change a motion state of the mobile system; and in response to detecting the intent to change the motion state of the mobile system: in accordance with a determination that the intent to change the motion state of the mobile system corresponds to a transition from a non-moving state to a moving state, elevating, via the suspension system, the mobile system; and in accordance with a determination that the intent to change the motion state of the mobile system corresponds to a transition from the moving state to the non-moving state, lowering, via the suspension system, the mobile system.

In some embodiments, a method that is performed at a computer system that includes an exterior surface and that is in communication with a suspension system is described. In some embodiments, the exterior surface surrounds an interior. In some embodiments, the method comprises: detecting an intent to change a motion state of the mobile system; and in response to detecting the intent to change the motion state of the mobile system: in accordance with a determination that the intent to change the motion state of the mobile system corresponds to a transition from a non-moving state to a moving state, elevating, via the suspension system, the mobile system; and in accordance with a determination that the intent to change the motion state of the mobile system corresponds to a transition from the moving state to the non-moving state, lowering, via the suspension system, the mobile system.

### BRIEF DESCRIPTION OF THE DRAWINGS

FIG. 1 is a top view of an illustrative mobile system with displays in various locations in accordance with some embodiments.

FIG. 2 is a side view of an illustrative display stack in accordance with some embodiments.

FIG. 3 is a top view of an illustrative light plate assembly with encapsulation material in accordance with some embodiments.

FIG. 4 is a top view of an illustrative light plate assembly with encapsulation material around multiple light-emitting components in accordance with some embodiments.

FIG. 5 is a side view of an illustrative light plate assembly with encapsulation material in accordance with some embodiments.

FIG. 6 is a top view of an illustrative light plate assembly having encapsulation material and multiple sections of dam material around each light-emitting component in accordance with some embodiments.

FIG. 7 is a top view of an illustrative light plate assembly having encapsulation material and a single section of dam material around each light-emitting component in accordance with some embodiments.

FIG. 8 is a top view of an illustrative light plate assembly having encapsulation material and a single section of dam material around the encapsulation material of each-light emitting component in accordance with some embodiments.

FIG. 9 is a side view of an illustrative display that includes a stack of antireflection layers in accordance with some embodiments.

FIGS. 10A-10F illustrate exemplary displays of a mobile system in accordance with some embodiments.

### DETAILED DESCRIPTION

The following description sets forth exemplary systems, methods, parameters, and the like. It should be recognized, however, that such description is not intended as a limitation on the scope of the present disclosure but is instead provided as a description of exemplary embodiments.

There is a need for systems to provide efficient methods and interfaces for indicating context. For example, a mobile system can indicate a state of the mobile system (e.g., whether the mobile system is accelerating, decelerating and/or turning in a specific direction) and/or the state of the physical environment (e.g., objects and/or hazards that are detected in the physical environment). The mobile system can indicate the state of the mobile system and/or the physical environment via one or more output devices that are in communication with the mobile system. Such techniques can reduce the cognitive burden on a subject who uses and/or interacts with the mobile system, thereby enhancing productivity and safety. Further, such techniques can reduce processor and battery power otherwise wasted on redundant user inputs.

The processes described below enhance the operability of systems and make the subject-system interfaces more efficient (e.g., by helping a subject to provide proper inputs and reducing mistakes when operating/interacting with a system) through various techniques, including by providing improved visual feedback to the subject, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of a system by enabling a subject to use the system more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In some embodiments, a system, such as a smart phone, a smart watch, a tablet, a laptop, a desktop computer, an accessory device, a movable computer system, a mobile computer system, a mobile system, a smart display, a smart speaker, a smart light, a vehicle, or other system, has components that emit light such as headlights, taillights, and/or other lights. Headlights may be used to provide headlight illumination to illuminate a roadway. The headlight illumination may allow occupants of the system to view the roadway at night and/or in other low ambient lighting conditions such as at dawn or dusk, when weather reduces ambient light, and/or when the system is traveling through a dark tunnel. Headlight illumination may also be used to assist autonomous driving systems. Taillights may be used to signal braking of the system and running status of the system, and other lights may be incorporated to communicate the upcoming actions of the system, such as turning, or may be incorporated into an interior of the system. Headlights, taillights, or other lights may be used to display information to people outside of the system, such as movement of the system, status of the system, or planned movement of the system.

In an illustrative arrangement, a mobile system may include a display (sometimes referred to as a display generation component) or other illumination source having a light plate assembly or other light source to provide illumination and/or to display information regarding the status of the mobile system. In particular, the display may include a light plate assembly having light-emitting components mounted on a substrate. Fill material may be provided around each of the light-emitting components. In particular, white fill material (or other high reflectivity material) may be provided around the light-emitting components and black fill material (or other high light absorption material) may surround the white fill material. Dam material may be included around the white fill material and/or the black fill material to contain the fill material during manufacturing. The black fill material may absorb exterior, ambient light, while the white fill material may improve efficiency of the display by redirecting stray light from the light-emitting components to the exterior. Moreover, the fill material may provide additional protection for the light-emitting components. In some embodiments, the display generation component is integrated with the mobile system. In some embodiments, the display generation component is separate from the mobile system. In some embodiments, “displaying” content includes causing to display the content (e.g., video data rendered or decoded by a display controller) by transmitting, via a wired or wireless connection, data (e.g., image data or video data) to an integrated or external display generation component to visually produce the content.

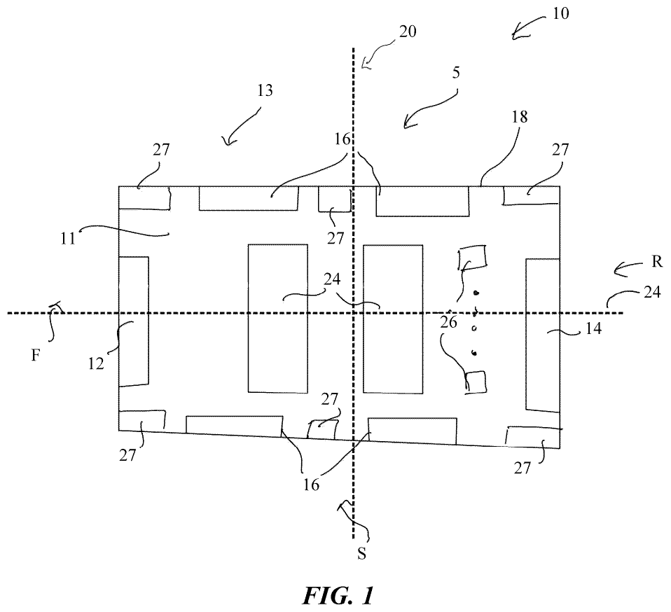

FIG. 1 is a cross-sectional top view of an illustrative mobile system that may one or more displays or illumination sources. In the example of FIG. 1, mobile system 10 is a type of vehicle that may carry passengers (e.g., an automobile, truck, or other automotive vehicle). However, mobile system 10 may be a robot (e.g., an autonomous robot) or another mobile system for transporting objects without transporting passengers, if desired. FIG. 1 includes longitudinal axis 22 of mobile system 10 and lateral axis 20 of mobile system 10. It should be recognized that, in some embodiments, longitudinal axis 22 and lateral axis 20 can be used to reference different axes and/or areas of mobile system 10 for discussion purposes and are not included in mobile system 10.

Mobile system 10 may be manually driven (e.g., by a human driver), may be operated via remote control, and/or may be autonomously operated (e.g., by an autonomous driving system implemented using the control circuitry, sensors, and other components of mobile system 10). If desired, a driving system (e.g., a computer-assisted driving system that is also optionally used to support fully autonomous driving) may be used to provide driving assistance functions while mobile system 10 is being driven under manual control.

Mobile system 10 may include a body such as body 18. Body 18 may include mobile system structures such as body panels formed from metal and/or other materials, may include doors, a hood, a trunk, fenders, a chassis to which wheels are mounted, a roof, etc. Windows 16 may be formed in doors on the sides S of body 18, or in other desired portions of mobile system 10, such as on a roof of mobile system 10. Windshield 12 may be formed at front F, and rear window 14 (also referred to as rear window 14 herein) may be formed at rear R of mobile system 10, if desired. Windows 16, windshield 12, rear window 14, doors in body 18, and other portions of body 18 may separate interior region 11 of mobile system 10 from the exterior environment that is surrounding mobile system 10 (exterior 13).

Mobile system 10 may have seating such as seats 24 in interior region 11. Seats 24 may include bucket seats, bench seats, and/or other seats on which mobile system occupants may sit. These seats may include forward-facing seats and/or rear-facing seats. The configuration of FIG. 1 in which interior region 11 of mobile system 10 contains one or more rearward-facing bucket seats and/or bench seats and one or more forward-facing bucket seats and/or bench seats is illustrative.

Mobile system 10 may be provided with components 26. Components 26 may include displays, speakers, interior and exterior lights, actuators for adjusting the position and motion of structures in mobile system 10, and input devices that gather user input. The input devices may include proximity sensors, touch sensors, force sensors, buttons, etc. Sensors may also be used in mobile system 10 to make measurements on environmental conditions (e.g., ambient light levels, temperatures, etc.). In some configurations, components 26 may contain wireless circuitry. The wireless circuitry may include ultrawideband (UWB) circuitry, near-field communications circuitry, Bluetooth® circuitry, wireless local area network circuitry, and/or other wireless circuitry. The wireless circuitry may be used to detect nearby devices (e.g., wireless key fobs, portable electronic devices such as wristwatches and cellular telephones emitting UWB signals and/or other short-range wireless signals, etc.). As an example, wireless circuitry may be used to detect the presence of a nearby electronic device and mobile system 10 may, in response, use an actuator to unlock a door in mobile system 10.

During operation, user input may be used to operate mobile system 10. Components 26 of mobile system 10 may include buttons, sensors, steering components (e.g., a steering wheel and steering system), pedals (e.g., an accelerator and brake pedal), and/or other components that serve as controllers for gathering user input to adjust mobile system operations. These input devices may be used for receiving user steering commands, for receiving user navigation commands for an autonomous driving system, for receiving user input to adjust lighting, media playback, heating and air-conditioning, for receiving input to open and close doors (and windows), for receiving input to lock and unlock doors (and windows), for receiving input to otherwise control doors and/or windows, for receiving input to control other mobile system operations, and for receiving other user input. In an illustrative configuration, mobile system 10 includes sensor circuitry (e.g., a touch sensor, force sensor, proximity sensor, and/or other sensor(s)) to receive commands from users (e.g., mobile system occupants, subjects approaching mobile system 10 from the outside, etc.). The sensor circuitry may, as an example, include sensors that allow a user to supply user input that directs one or more electrically adjustable actuators to move a door from a stowed to a deployed position, to open and/or close the door, to lock/unlock the door, to open and/or close a window, etc.

Components 26 may include control circuitry and input-output devices. Control circuitry and/or input-output devices in components 26 may be configured to operate mobile system systems such as the steering and propulsion system based on user input, to operate mobile system systems such as the steering and propulsion system autonomously in connection with running an autonomous driving application, to run a navigation application (e.g., an application for displaying maps on a display), to run software for controlling climate control devices, lighting, media playback, window movement, door operations, seating position devices, and/or to support the operation of other mobile system functions. The control circuitry and/or input-output devices (sensor circuitry, other input-output components, etc.) may include processing circuitry and storage and may be configured to perform operations in mobile system 10 using hardware (e.g., dedicated hardware or circuitry), firmware and/or software. Software code for performing operations in mobile system 10 and other data is stored on non-transitory computer readable storage media (e.g., tangible computer readable storage media) in the control circuitry. Remote storage and other remote-control circuitry (e.g., circuitry on remote servers, etc.) may also be used in storing the software code. The software code may sometimes be referred to as software, data, program instructions, computer instructions, instructions, or code. The non-transitory computer readable storage media may include non-volatile memory such as non-volatile random-access memory, one or more hard drives (e.g., magnetic drives or solid-state drives), one or more removable flash drives or other removable media, or other storage. Software stored on the non-transitory computer readable storage media may be executed on the processing circuitry of components 26 and/or the processing circuitry of remote hardware such as processors associated with one or more remote servers that communicate with components 26 over wired and/or wireless communications links. The processing circuitry may include application-specific integrated circuits with processing circuitry, one or more microprocessors, a central processing unit (CPU) or other processing circuitry.

The input-output components (input-output devices) of components 26 may include displays, sensors, buttons (e.g., sensors based on movable button members that press against switches), light-emitting diodes and other light-emitting devices for providing interior and/or exterior lighting, haptic devices, speakers, door locks, actuators for moving portions of doors, windows, and/or other components, and/or other devices such as input devices for gathering environmental measurements, information on mobile system operations, and/or user input. The sensors in components 26 may include ambient light sensors, touch sensors, force sensors, proximity sensors (e.g., optical proximity sensors and/or capacitive proximity sensors based on self-capacitance sensors and/or mutual capacitance sensor circuitry), optical sensors such as cameras operating at visible, infrared, and/or ultraviolet wavelengths (e.g., fisheye cameras and/or other cameras), capacitive sensors, resistive sensors, ultrasonic sensors (e.g., ultrasonic distance sensors), microphones, three-dimensional and/or two-dimensional images sensors, radio-frequency sensors such as radar sensors, lidar (light detection and ranging) sensors, door open/close sensors, seat pressure sensors and other mobile system occupant sensors, window sensors, position sensors for monitoring location, orientation, and movement, speedometers, satellite positioning system sensors, and/or other sensors. Output devices in components 26 may be used to provide mobile system occupants and others with haptic output (e.g., force feedback, vibrations, etc.), audio output, visual output (e.g., displayed content, light, etc.), and/or other suitable output. Components 26 may be mounted in interior region 11 and/or an exterior region outside of body 18 and/or may, if desired, be attached to and/or mounted to other portions of body 18.

As shown in FIG. 1, mobile system 10 may include one or more light sources 27 at front F, at rear R, or at sides S of body 18. Light sources 27 may be, for example, displays having light plate assemblies that include light-emitting diodes that provide illumination and/or display content (e.g., images, text, patterns). Light sources 27 may be formed from openings in body 18, may be mounted on an exterior surface of body 18, or may otherwise be coupled to body 18.

In embodiments in which light sources 27 are located at front F of mobile system 10, light sources 27 may form headlights and/or displays that display information at the exterior of mobile system 10. In embodiments in which light sources 27 are located at rear R of mobile system 10, light sources 27 may form taillights and/or displays that display information at the exterior of mobile system 10. In embodiments in which light sources 27 are located at side(s) S of mobile system 10, light sources 27 may displays that display information at the exterior of the mobile system 10 and/or that illuminate exterior 13 at side(s) S.

The information displayed by light source(s) 27 when the light sources are used as displays may reflect the operating status of mobile system 10 and/or may be used to inform a viewer of the displays of upcoming movements by mobile system 10. For example, a controller in mobile system 10 (e.g., part of components 26) may determine information regarding the operating state of mobile system 10 and may control the displays based on that information. In other words, light source(s) 27 may display information regarding the intent of a driver of mobile system 10 or of mobile system 10 itself if driven in an autonomous mode.

For example, light source(s) 27 may display text, symbols, images, patterns, or other information to indicate that mobile system 10 is turning (e.g., based on a turning motion), is about to turn, is moving in a particular direction (e.g., accelerating, deceleration, or reversing), as planning to move in a particular direction, is changing speed, or needs assistance (e.g., may function as hazard lights). Additionally or alternatively, light source(s) 27 may display information regarding the position or location of mobile system 10, a speed of mobile system 10, an upcoming lane change of mobile system 10, the route that mobile system 10 is taking, etc. These examples are merely illustrative of the types of information that light source(s) 27 may display, and, in general, light source(s) 27 may display any relevant information.

Although FIG. 1 shows light source(s) 27 at the exterior of mobile system 10, one or more light source(s) may be formed in the interior of mobile system 10, if desired. For example, light source(s) 27 formed in the interior of mobile system 10 may provide illumination and/or may display information for a driver or passenger of mobile system 10.

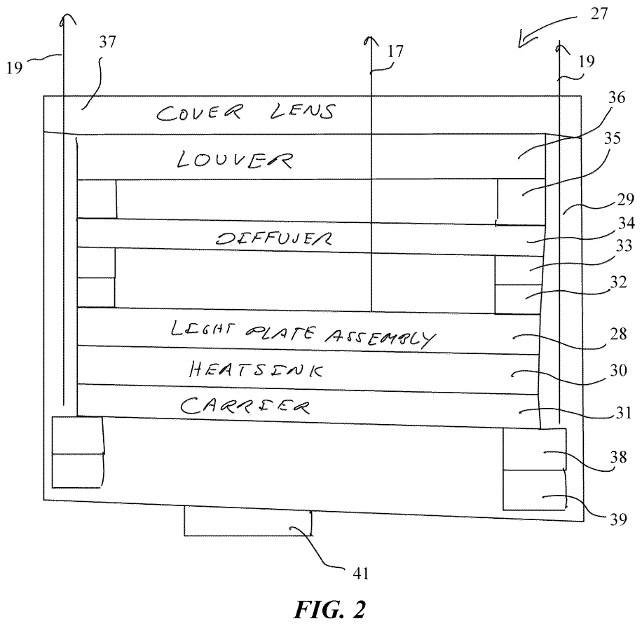

An illustrative stack of layers that may form light source(s) 27 (and/or other light source) in mobile system 10 is shown in FIG. 2. As shown in FIG. 2, light source(s) 27 may include light plate assembly 28 mounted on heatsink 30 and carrier 31. Diffuser 34, louver 36, and cover lens 37 may be formed over light plate assembly 28. Spacer 32 may maintain space between light plate assembly 28 and diffuser 34. Diffuser 34 may be attached to spacer 32 with adhesive 33, and louver 36 may be attached to diffuser 34 with adhesive 35. Adhesives 33 and 35 may be pressure sensitive adhesives (PSAs), for example. In some embodiments, light source(s) 27 is a light source.

Substrate 39 may be formed below carrier 31 and may be formed on substrate 39. All of the components of light source(s) 27 may be mounted in housing 29. Controller 41 may be mounted to a rear portion of housing 29.

In operation, light plate assembly 28, which may include a plurality of light-emitting components, such as light-emitting diodes (e.g., microLEDs), may emit light 17 through diffuser 34, which may homogenize light 17, through louver 36, and through cover lens 37. Diffuser 34 may be formed from any desired diffusive material, such as particles in a transparent binder, or diffusive structures (e.g., protrusions or recesses) formed on a surface of a substrate. Louver 36 may include material that absorbs visible light to reduce reflections of ambient light from interfering with light 17 emitted by light plate assembly 28. The light-absorbing material may have small openings through which light from light plate assembly 28 can pass, while external light may be absorbed. Cover lens 37 may be formed from a transparent or semi-transparent material. For example, cover lens 37 may be a glass, ceramic, or polymer layer through which at least some of the light emitted by light plate assembly 28 may pass.

The light emitted by light plate assembly 28 may provide illumination and/or may form content (e.g., when light source(s) 27 is used as a display). For example, light 17 may provide headlight, taillight, or ambient illumination for a mobile system. Alternatively or additionally, light 17 may form images, content, symbols, patterns, or other information for a viewer. For example, light 17 may form text, symbols, images, patterns, or other information to indicate that mobile system 10 is turning, is about to turn, is changing speed, needs assistance (e.g., may function as hazard lights), or may indicate another operating condition of mobile system 10. Additionally or alternatively, light 17 may form information regarding the position of mobile system 10, an upcoming lane change of mobile system 10, the route that mobile system 10 is taking, etc. For example, a controller in mobile system 10 (such as a controller in components 26 of FIG. 1) may control light plate assembly 28 to display desired information based on an operating condition of mobile system 10. In general, light 17 from light plate assembly 28 may be used to provide any desired illumination and/or display any desired content.

Light plate assembly 28 may be coupled to heatsink 30, which may prevent light plate assembly 28 from getting excessively hot during operation. If desired, heatsink 30 may include thermally conductive material to remove heat from light plate assembly 28. Additionally or alternatively, heatsink 30 may include a fan or other component to actively cool light plate assembly 28.

Light plate assembly 28 and heatsink 30 may be mounted to carrier 31 with any desired fasteners, such as screws. Light ring 38, which may be mounted on printed substrate 39, may be coupled to an opposite surface of carrier 31 and may emit light 19 around the periphery of light plate assembly 28 and through cover lens 37. In some embodiments, light ring 38 may be formed from one or more light-emitting components, such as light-emitting diodes, and may additionally include light guiding structures, such as light pipes or waveguides, if desired.

Although FIG. 2 shows light 19 being emitted by light ring 38 and exiting through cover lens 37 without being diffused by diffuser 34 or passing through louver 36 (also referred to as louver 36 or louver 36 herein), this arrangement is merely illustrative. If desired, diffuser 34, louver 36, and/or other desired layers may overlap light ring 38. In other words, light 19 may pass through 34, louver 36, and/or other desired layers.

In some embodiments, light 19 from light ring 38 may form a turn signal indicator that surrounds light plate assembly 28 (e.g., if light plate assembly 28 is used as a headlight or a taillight). In general, however, light ring 38 may be formed for any desired illumination.

Controller 41 may be used to control light plate assembly 28 and/or light ring 38. For example, controller 41 may send signals to driving circuitry on light plate assembly 28, which in turn may drive the light-emitting components on light plate assembly 28. Moreover, controller 41 may send signals to driving circuitry on substrate 39, which in turn may drive light ring 38. For example, controller 41 may receive signals based on an operating state of mobile system 10 (e.g., from a controller of mobile system 10), and may adjust light plate assembly 28 and/or light ring 38 based on the received signals.

In an illustrative embodiment, light source(s) 27 may have a circular shape (e.g., when viewed from the front of cover lens 37). For example, light plate assembly 28 may have a circular shape, and light ring 38 may have a corresponding circular shape and may surround light plate assembly 28. However, this is merely illustrative. In general, light source(s) 27 may have any desired shape, such as an oval shape, a rectangular shape, or any non-rectangular shape.

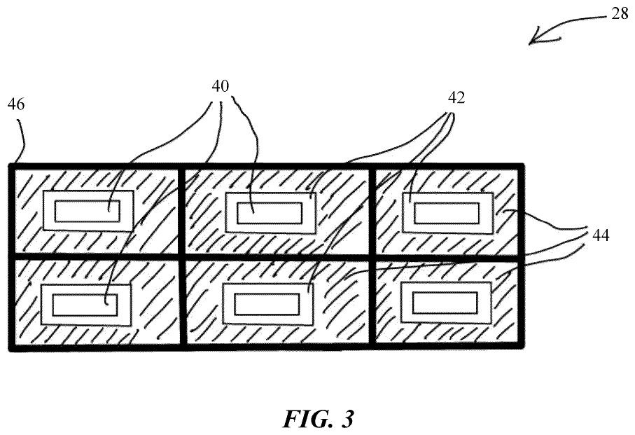

Regardless of the shape of light source(s) 27 and/or light plate assembly 28, light plate assembly 28 may include an array of light-emitting components. An illustrative example of a portion of light plate assembly 28 is shown in FIG. 3.

As shown in FIG. 3, light plate assembly 28 may include an array of light-emitting components 40. Light-emitting components may be light-emitting diodes, microLEDs, OLEDs, or other desired light components. Any desired number of light-emitting components 40 may be included in light plate assembly 28. For example, light plate assembly 28 may include at least 1000 light-emitting components 40, at least 7000 light-emitting components 40, or at least 75,000 light-emitting components 40. FIG. 3, which shows six light-emitting components 40, may merely be a portion of light plate assembly 28.

In some embodiments, it may be desirable to include material surrounding light-emitting components 40. As shown in FIG. 3, fill material 44 and fill material 42 may be formed around each light-emitting component 40. Together, fill material 44 and fill material 42 may help prevent damage to light-emitting components 40.

Fill material 44 may be formed from a light-absorptive material. For example, fill material 44 may absorb at least 75%, at least 80%, at least 90%, or at least 95% of visible light. In other words, fill material 44 may be an absorptive fill material. In some embodiments, fill material 44 may be a black fill material (e.g., a black dyed or otherwise colored silicone, epoxy, or other fill material). By surrounding each light-emitting component 40 with absorptive fill material 44, ambient light incident on light plate assembly 28 may be absorbed. In this way, fill material 44 may improve the contrast of light plate assembly 28 (e.g., by preventing ambient light from washing out the light emitted by light-emitting components 40).

Although fill material 44 has been described as being formed from absorptive material, such as black fill material, fill material 44 may be formed from transparent fill material In particular, if light plate assembly 28 is formed on an absorptive substrate, such as a black substrate (e.g., a substrate coated with black material), fill material 44 may allow ambient light to pass through to the substrate where it may be absorbed. The transparent material may be transparent polymer, epoxy, or silicone, as examples.

Fill material 42 may be included between light-emitting components 40 and fill material 44. Fill material 42 may be formed from a reflective material. For example, fill material 42 may reflect at least 70%, at least 75%, or at least 80% of visible light. In other words, fill material 42 may be a reflective fill material. In some embodiments, fill material 44 may be a white fill material (e.g., a white dyed or otherwise colored silicone, epoxy, or other fill material). As a result, fill material 42 may reflect stray light from light-emitting components, and the reflected stray light may exit light plate assembly 28. By including fill material 42 between light-emitting components 40 and fill material 44, the efficiency of light plate assembly 28 may be increased.

During manufacturing, it may be difficult to contain fill material 44 and/or fill material 42. Therefore, dam material 46 may be included to contain fill material 44 and/or fill material 42 in desired locations in light plate assembly 28. Dam material 46 may be formed from an epoxy, resin, polymer, or other desired material (e.g., a material that is cured prior to fill material 44 and 42 being deposited on the substrate), or may be a metal or plastic material. As shown in FIG. 3, for example, dam material 46 may surround each light-emitting component 40 and may contain fill material 44.

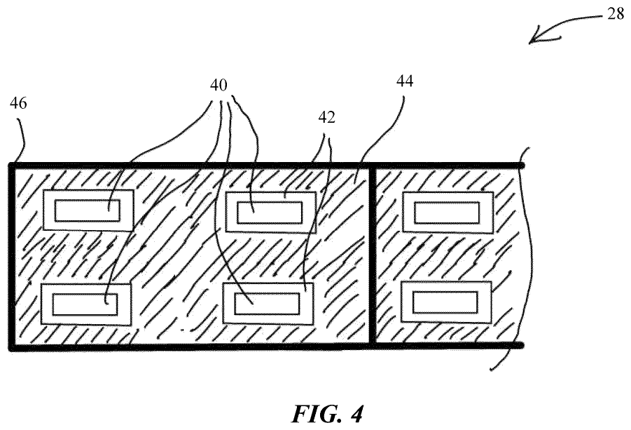

Although FIG. 3 shows dam material 46 surrounding each light-emitting component 40, this arrangement is merely illustrative. In general, dam material 46 may surround any desired number of light-emitting components 40. An illustrative example of a light plate assembly having dam material around multiple light-emitting components is shown in FIG. 4

As shown in FIG. 4, dam material 46 (and fill material 44) may surround four light-emitting components 40. In the example of FIG. 4, each light-emitting component 40 may be surrounded by individual portions of reflective fill material 42, while a continuous portion of fill material 44 may surround each of the four light-emitting components 40. In this way, the reflective fill material 42 around each light-emitting component 40 may improve the efficiency of light plate assembly 28, while the absorptive fill material 44 may absorb ambient light to improve the contrast of light plate assembly 28.

The example of FIG. 4 in which four light-emitting components 40 are surrounded by dam material 46 and fill material 44 is merely illustrative. In general, any number of light-emitting components 40, such as 8 light-emitting components or 9 light-emitting components, may be surrounded by the same dam material 46 and the same fill material 44.

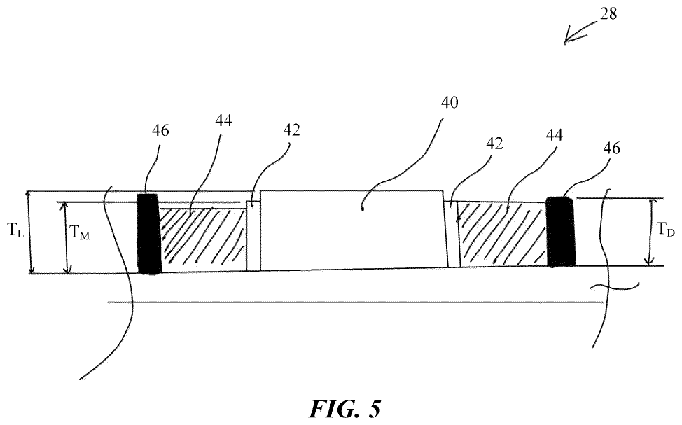

Regardless of the number of light-emitting components surrounded by a dam structure and fill material, the height of the light-emitting components should be greater than the height of the fill material to prevent the fill material from interfering with the light-emitting components. An illustrative example of a light plate assembly having a light-emitting component with a greater height than the surrounding fill material is shown in FIG. 5.

As shown in FIG. 5, light-emitting component 40 may be formed on substrate 48. Substrate 48 may be, for example, a printed circuit board or other substrate. Light-emitting component 40 may have height T_{L} above substrate 48. Height T_{L} may be at least 140 microns, at least 150 microns, at least 160 microns, 150 microns, or another suitable height.

Fill material 42 and 44 may have a maximum height T_{M} above substrate 48. Height T_{M} may be less than height T_{L}. For example, height T_{M} may be less than 150 microns, between 100 microns and 150 microns, less than 140 microns, or other suitable height. In general, by ensuring that height T_{M} is less than height T_{L}, fill material 42 and/or 44 may be prevented from spreading over the top of light-emitting component 40, thereby protecting light-emitting component 40 from interference from fill material 42 and 44.

Dam material 46 may have a height T_{D} above substrate 48. In general, height T_{D} may be any desired height that is greater than height T_{M} to contain fill material 42 and 44 between dam material 46 and light-emitting component 40. In some embodiments, height T_{D} may be greater than height T_{M} but less than height T_{L}. In this way, dam material 46 may contain fill material 42 and 44 without blocking stray light from light-emitting component 40.

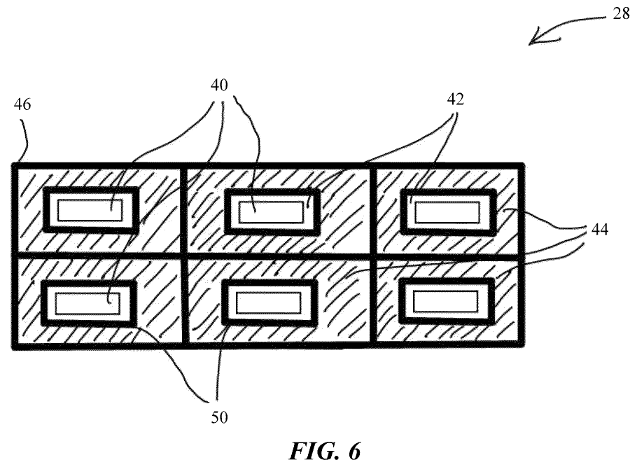

Although dam material 46 has been described as surrounding both fill material 42 and fill material 44, which are in direct contact, this is merely illustrative. In general, dam material may be included anywhere in light plate assembly 28 to contain fill material 42 and/or fill material 44. An illustrative example in which additional dam material is included between fill material 42 and fill material 44 is shown in FIG. 6

As shown in FIG. 6, light plate assembly 28 may include additional dam material 50. Additional dam material 50 may be between fill material 42 and fill material 44. In particular, it may be desirable to completely separate fill material 42 and fill material 44. Although fill material 42 and fill material 44 may be formed from materials that naturally stay separated (e.g., in the example of FIG. 3), dam material 50 may be used to ensure that the two fill materials do not overlap, if desired.

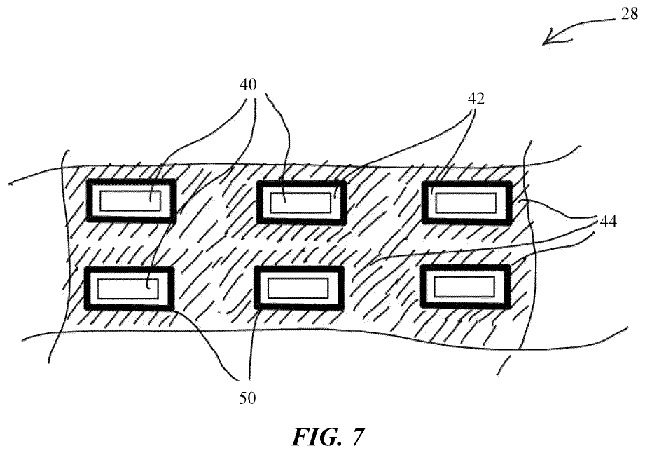

Alternatively, as shown in FIG. 7, dam material 46 may be omitted, and only dam material 50 between fill material 42 and fill material 44 may be present. In this embodiment, fill material 42 may be constrained by dam material 50, while fill material 44 is free to expand across light plate assembly 28.

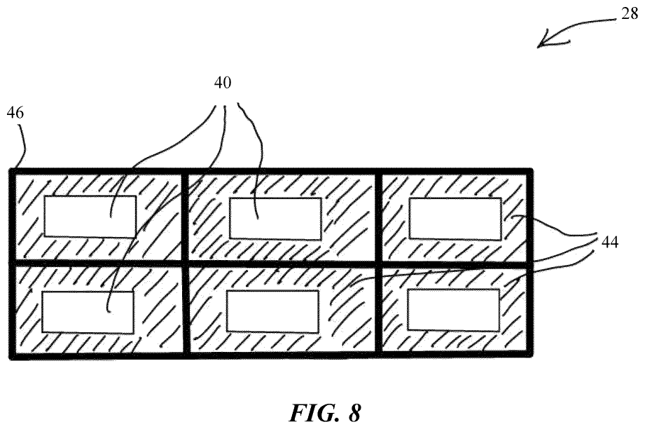

Moreover, in some embodiments, fill material 42 may be omitted entirely. As shown in the illustrative example of FIG. 8, fill material 44 may directly contact the sides of light-emitting components 40. In some embodiments, light-emitting components 40 may be pre-packaged with light-reflecting material, so additional reflective material may not be needed. Alternatively, in embodiments in which the display efficiency can be reduced, light-reflecting material may be omitted entirely. As shown in FIG. 8, dam material 46 may constrain fill material 44 between light-emitting components 40. However, dam material 46 may be omitted (e.g., as in FIG. 7) to allow fill material 44 to spread across light plate assembly 28.

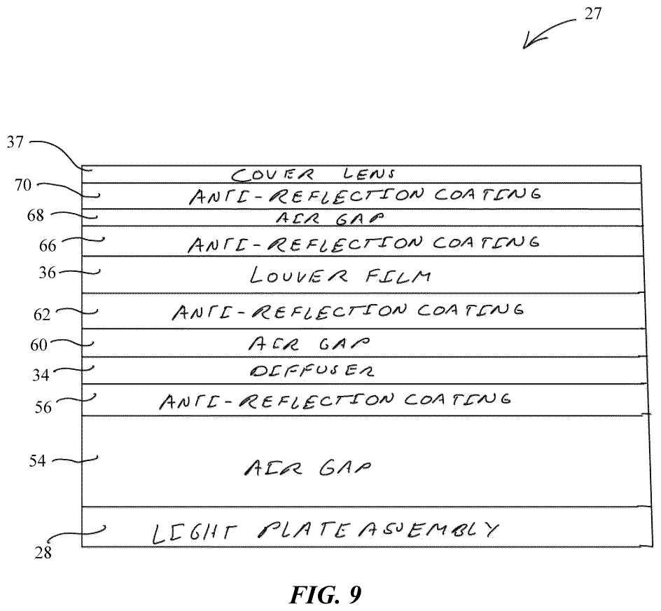

By including absorptive fill material 44 around light-emitting components 40, ambient light may be absorbed, thereby increasing the contrast of light plate assembly 28. Additionally, fill material 44 and/or 42 may provide protection for light-emitting components 40. Instead of, or in addition to, including fill material 44 to absorb ambient light and/or including fill material 42 to improve display efficiency, a stack of anti-reflection coatings may be included in a display (e.g., above a light plate assembly). An illustrative example of a display having a stack of anti-reflection coatings is shown in FIG. 9.

As shown in FIG. 9, a display, such as light source(s) 27, may include light plate assembly 28, diffuser 34, louver 36, and cover lens 37. The remaining display layers that were described above in connection with FIG. 1 are omitted for simplicity in FIG. 9, but some or all of the FIG. 1 display layers may be included.

Light source(s) 27 may include multiple anti-reflection coatings, such as anti-reflection coatings 56, 62, 66, and 70. In the illustrative example of FIG. 9, light source(s) 27 includes anti-reflection coating 56 between light plate assembly 28 and diffuser 34. Air gap 54 may separate light plate assembly 28 and anti-reflection coating 56.

Anti-reflection coating 62 may be formed between diffuser 34 and louver 36. Air gap 60 may separate anti-reflection coating 62 from diffuser 34. Antireflection coating 66 may be formed on louver 36, and antireflection coating 70 may be formed on cover lens 37. Air gap 68 may separate anti-reflection coating 70 from anti-reflection coating 66.

In general, the use of anti-reflection coatings may reduce the amount of ambient light that is reflected by light source(s) 27. For example, the anti-reflection coatings of FIG. 9 may reduce display reflections by at least 10%, at least 15%, or at least 20%. Moreover, light source(s) 27 may have a higher brightness due to the presence of the anti-reflection coatings. In this way, the anti-reflection coatings may improve the efficiency and contrast of light source(s) 27.

Although anti-reflection coatings 56, 62, 66, and 70 are shown as being in specific locations in FIG. 9, the arrangement of FIG. 9 is merely illustrative. Any desired number of anti-reflection coatings may be included in light source(s) 27, and the anti-reflection coatings may be formed in, on, or between any desired layers of light source(s) 27.

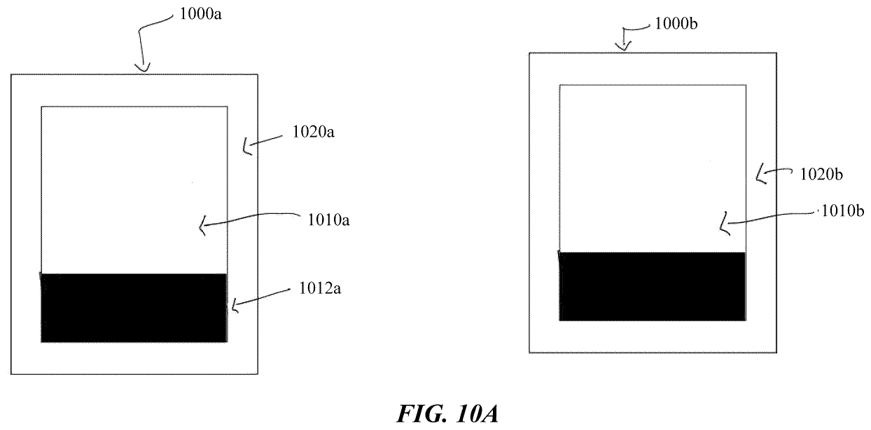

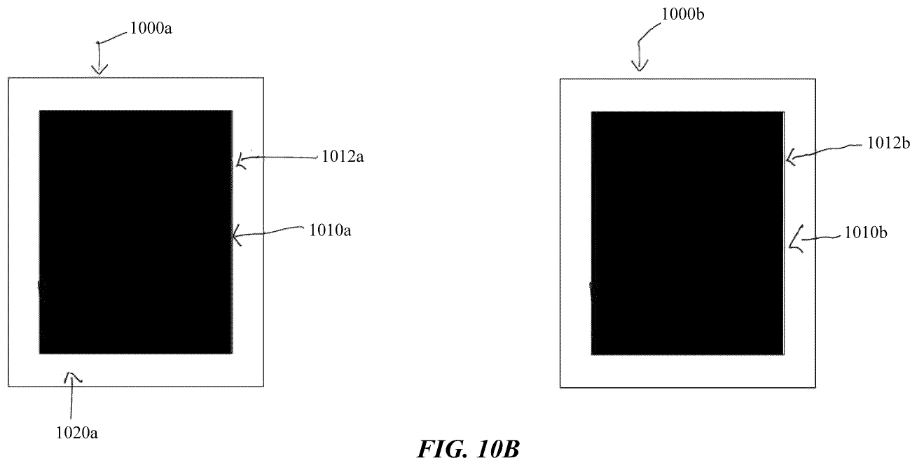

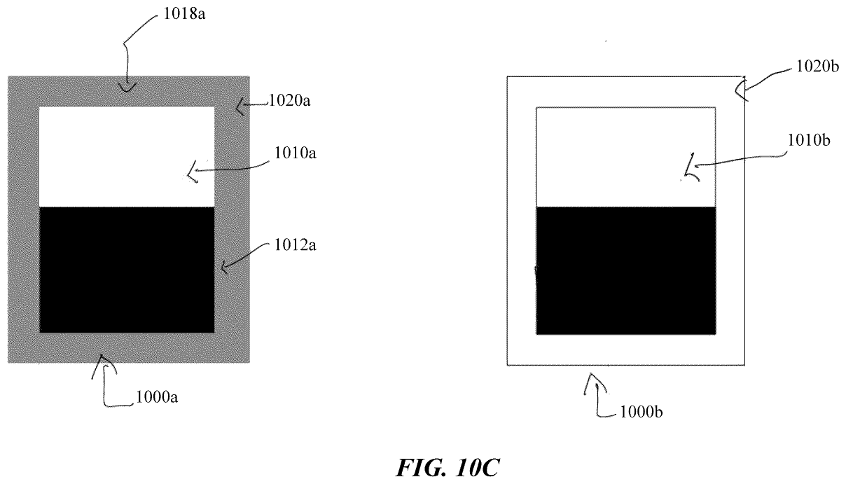

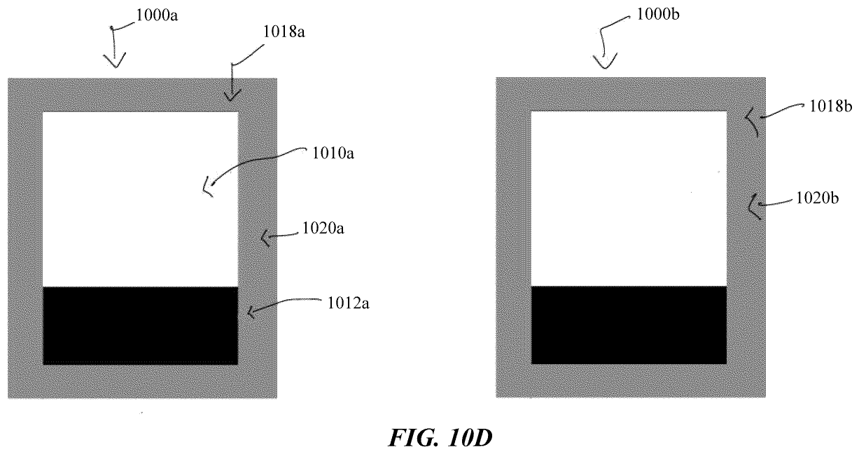

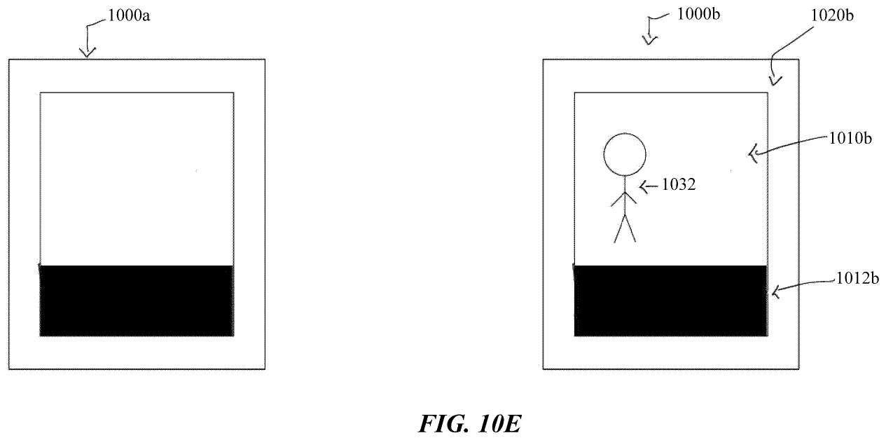

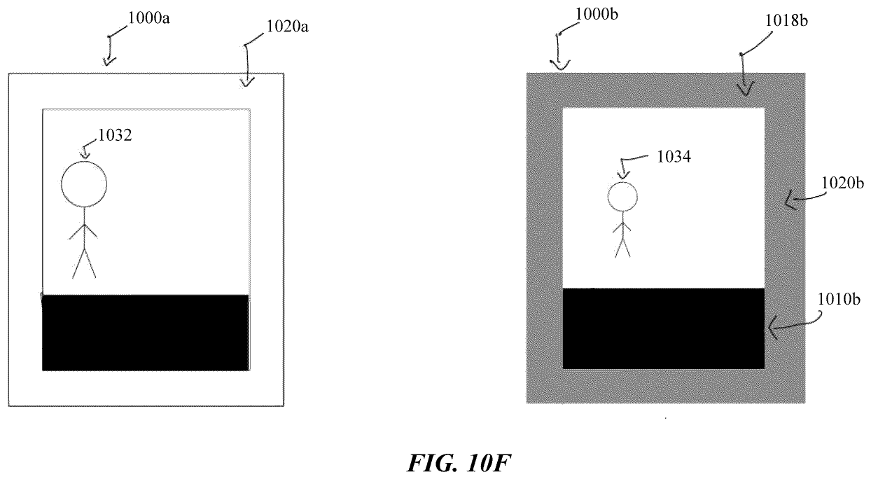

FIGS. 10A-10F illustrate exemplary user interfaces for indicating context in accordance with some embodiments. The user interfaces in these figures are used to illustrate some embodiments described herein.

In some embodiments, the techniques described below are directed to an accessibility feature, where a system (e.g., a computer system, a movable system, a movable computer system, a mobile system, and/or a mobile computer system, such as mobile system 10 of FIG. 1) communicates information via one or more display generation components (e.g., a display, a screen, a touch-sensitive display, a light source, and/or a projector, such as light source(s) 27 of FIG. 1) included with and/or in communication with the system. In some embodiments, the techniques described below allow for subjects in a physical environment including the system to obtain information concerning (1) current and/or intended movement of the system and/or (2) other information being conveyed by the system. In some embodiments, the one or more display generation components are disposed on the system such that the display generation components are facing away from the system and/or that subjects in the physical environment can see the information displayed by the one or more display generation components. In some embodiments, the system includes a mobile actuator that is configured to move the system in a first set of one or more directions (e.g., forward, backward, left, and/or right) and/or a second set of one or more directions (e.g., forward, backward, left, and/or right) different and/or perpendicular to the first set of one or more directions. In some embodiments, the system automatically displays and/or updates, via the one or more display generation components, one or more portions of a user interface based on movement of the system and/or movement of subjects in the physical environment.

FIGS. 10A-10F illustrate left display 1000a and right display 1000b. In some embodiments, left display 1000a and/or right display 1000b include one or more features, components, and/or functionalities as discussed above with respect to light source(s) 27. In some embodiments, left display 1000a is and/or corresponds to the bottom left instance of light source(s) 27 in FIG. 1. In some embodiments, right display 1000b is and/or corresponds to the top left instance of light source(s) 27 in FIG. 1.

In some embodiments, left display 1000a and right display 1000b are disposed on a common external surface (e.g., body 18) of the system. In some embodiments, left display 1000a and right display 1000b are positioned on the system at a common depth from the common external surface. For example, left display 1000a and right display 1000b can extend inwards and/or outwards from body 18 of mobile system 10 (e.g., as referenced above at FIG. 1) by the same amount. In some embodiments, left display 1000a and right display 1000b are on and/or coupled to a common side of the system (e.g., front of the system, side of the system, or rear of the system, such as front F of mobile system 10). In some embodiments, left display 1000a and right display 1000b are positioned on the system such that left display 1000a and right display 1000b are directed away from an interior (e.g., within body 18) of the system. In some embodiments, left display 1000a and right display 1000b are on opposite sides of a longitudinal axis (e.g., longitudinal axis 22 as discussed above in relation to FIG. 1) of the system and/or are on the same side of a lateral axis (e.g., left of lateral axis 20 as shown in FIG. 1) of the system. In some embodiments, left display 1000a and right display 1000b are facing and/or directed in different and/or non-overlapping directions. For example, left display 1000a can be facing toward a left area in front of the system while right display 1000b can be facing toward a right area in front of the system. In some embodiments, left display 1000a is closer to an edge (e.g., an edge corresponding to where front F meets side S on bottom left side of FIG. 1) of a first side (e.g., side S on bottom side of FIG. 1) of the system than to an edge (e.g., an edge corresponding to where front F meets side S on top left side of FIG. 1) of another side (e.g., side S on top side of FIG. 1) of the system. In some embodiments, right display 1000b is closer to an edge (e.g., an edge corresponding to where front F meets side S on top left side of FIG. 1) of a second side (e.g., different from the first side) (e.g., side S on top side of FIG. 1) of the system than to an edge (e.g., an edge corresponding to where front F meets side S on bottom left side of FIG. 1) of another side (e.g., side S on bottom side of FIG. 1) of the system. In some embodiments, left display 1000a is closer to the edge of the first side than to right display 1000b. In some embodiments, right display 1000b is closer to the edge of the second side than to left display 1000a.

In some embodiments, left display 1000a is covered by a cover lens (e.g., cover lens 37 as described above with respect to FIG. 2). In some embodiments, right display 1000b is covered by the same cover lens or a different cover lens as left display 1000a (e.g., cover lens 37 as described above with respect to FIG. 2).

In some embodiments, the system controls display operations of left display 1000a and/or right display 1000b. In some embodiments, another system (e.g., a smart phone, a smart watch, a tablet, a laptop, a desktop computer, an accessory device, a smart display, a smart speaker, and/or a smart light) (e.g., different from and/or external to the system, left display 1000a, and/or right display 1000b) controls (e.g., via the system and/or directly with left display 1000a and/or right display 1000b) display operations of left display 1000a and/or right display 1000b. In some embodiments, left display 1000a and/or right display 1000b control display operations of left display 1000a and/or right display 1000b.

FIGS. 10A-10F illustrate left display 1000a as displaying a user interface that includes inside area 1010a and outside area 1020a. In some embodiments, inside area 1010a and outside area 1020a are displayed via a single display generation component (e.g., left display 1000a). In some embodiments, inside area 1010a is displayed by a first display generation component (e.g., light plate assembly 28) and outside area 1020a is displayed by a second display generation component (e.g., light ring 38) different from the first display generation component. In some embodiments, the first display generation component is at a different depth relative to a surface (e.g., body 18) of the system from the second display generation component. In some embodiments, the first display generation component and/or the second display generation component is at a different depth relative to a surface (e.g., body 18) of the system than one or more lights (e.g., a headlight and/or a taillight located on the same size as the first display generation component and/or the second display generation component) (e.g., of the system). In some embodiments, inside area 1010a takes up the entire display of the first display generation component. In some embodiments, outside area 1020a takes up the entire display of the second display generation component. As illustrated in FIGS. 10A-10F, outside area 1020a surrounds and/or circumscribes inside area 1010a. It should be recognized that outside area 1020a might partially and/or not fully surround and/or circumscribe inside area 1010a in some embodiments.

FIGS. 10A-10F illustrate right display 1000b as displaying a user interface that includes inside area 1010b and outside area 1020b. In some embodiments, inside area 1010b and outside area 1020b are displayed via a single display generation component (e.g., right display 1000b). In some embodiments, inside area 1010b is displayed by a third display generation component (e.g., light plate assembly 28) (e.g., different from the first display generation component and/or the second display generation component) and outside area 1020b is displayed by a fourth display generation component (e.g., light ring 38) different from the third display generation component (and, in some embodiments, the first display generation component and/or the second display generation component). In some embodiments, the third display generation component is at a different depth relative to a surface (e.g., body 18) of the system from the fourth display generation component. In some embodiments, the third display generation component and/or the fourth display generation component is at a different depth relative to a surface (e.g., body 18) of the system than one or more lights (e.g., a headlight and/or a taillight located on the same size as the third display generation component and/or the fourth display generation component) (e.g., of the system). In some embodiments, inside area 1010a takes up the entire display of the third display generation component. In some embodiments, outside area 1020a takes up the entire display of the fourth display generation component. As illustrated in FIGS. 10A-10F, outside area 1020b surrounds and/or circumscribes inside area 1010b. It should be recognized that outside area 1020a might partially and/or not fully surround and/or circumscribed inside area 1010b in some embodiments.

In some embodiments, display of a portion of inside area 1010a (e.g., the portion including visual characteristic 1012a in FIG. 10A) and a portion of inside area 1010b (e.g., the portion including visual characteristic 1012b in FIG. 10A) are synchronized, such that the portion of inside area 1010a matches the portion of inside area 1010b. In some embodiments, inside area 1010a and inside area 1010b are synchronized while the system is moving, has determined to move within a predefined period of time (sometimes referred to herein as the initialization time), and/or has not detected a subject within a predefined area outside of the system while the system is stopped. In some embodiments, a portion of inside area 1010a (e.g., the portion not including visual characteristic 1012a in FIG. 10A) and a portion of inside area 1010b (e.g., the portion not including visual characteristic 1012b in FIG. 10A) are not synchronized when the system has detected a subject within a predefined area outside of the system while the system is stopped (and/or has determined to not move within a predefined period of time (sometimes referred to herein as a stopped time). In some embodiments, the display of inside area 1010a is synchronized with the display of inside area 1010b irrespective of the motion state of the system. In some embodiments, left display 1000a ceases, forgoes, and/or does not display visual characteristic 1012a based on a determination being made that the system is inactive, powered off, and/or the system is operating in a non-autonomous mode.

In some embodiments, inside area 1010a, outside area 1020a, inside area 1010b, and/or outside area 1020b is not visible from a position within the system. For example, inside area 1010a, outside area 1020a, inside area 1010b, and outside area 1020b can be not visible from a seated and/or standing position within the system.

In some embodiments, left display 1000a and right display 1000b (1) operate as headlights of the system (while, in some embodiments, the system does not include one or more other headlights) and (2) are coupled to a front portion (e.g., front F of mobile system 10) of the system (e.g., in close proximity to windshield 12). In some embodiments, left display 1000a and right display 1000b (1) operate as taillights of the system (while, in some embodiments, the system does not include one or more other taillights) and (2) are coupled to a rear portion (e.g., rear R of mobile system 10) of the system (e.g., in close proximity to rear window 14).

In some embodiments, the system includes one or more headlights in addition to left display 1000a and right display 1000b. In some embodiments, the one or more headlights are disposed on and/or coupled to the same side of the system as left display 1000a and/or right display 1000b. In some embodiments, the one or more headlights are facing a similar or same direction as left display 1000a and/or right display 1000b, such that the one or more headlights can light an area of the physical environment that has a view of left display 1000a and/or right display 1000b. In some embodiments, the system includes one or more taillights in addition to left display 1000a and/or right display 1000b. In some embodiments, the one or more taillights are disposed on and/or coupled to the same side of the system as left display 1000a and/or right display 1000b. In some embodiments, the one or more taillights are facing a similar, the same, and/or a different (e.g., opposite) direction as left display 1000a and/or right display 1000b. For example, the one or more taillights can light and/or output light to an area of the physical environment that has a view of left display 1000a and/or right display 1000b. For another example, the one or more taillights can light and/or output light to an area of the physical environment that does not have a view of left display 1000a and/or right display 1000b, such as when an area of the physical environment that has a view of left display 1000a and/or right display 1000b is toward a front portion (e.g., front F of FIG. 1) of the system and the one or more taillights are toward a rear portion (e.g., rear R of mobile system 10) of the system.

The description herein of left display 1000a, inside area 1010a, and/or outside area 1020a in FIGS. 10A-10F is applicable to right display 1000b, inside area 1010b, and/or outside area 1020b. That is, left display 1000a and right display 1000b, and their respective components, can have the same, consistent, and/or similar functionality. In some embodiments, because left display 1000a and right display 1000b are disposed on the same system (e.g., mobile system 10), left display 1000a and right display 1000b move throughout a physical environment in tandem. That is, when it is described below that left display 1000a moves in a respective direction in a physical environment, right display 1000b also moves in the respective direction or vice versa. In some embodiments, left display 1000a and right display 1000b do not move in tandem.

In some embodiments, left display 1000a and/or right display 1000b displays an indication (e.g., a graphical and/or textual indication) with respect to whether the system is on, active, moving, and/or will be moving within a predetermined period of time (e.g., via their respective display areas, such as within inside area 1010a and/or inside area 1010b). As illustrated in FIGS. 10A-10F, the indication takes the form of visual characteristic 1012a. As illustrated in FIGS. 10A-10F, visual characteristic 1012a is a color (e.g., black) that fills a portion of inside area 1010a. In some embodiments, the portion of inside area 1010a that is not filled with visual characteristic 1012a is filled with another color. In some embodiments, the portion of inside area 1010a that is not filled with visual characteristic 1012a is not filled with a color. In some embodiments, the indication and/or inside area 1010a includes more colors (e.g., more than two colors) than black and white as shown in FIG. 10A. For example, the indication can include (1) a first set of one or more colors that is representative of a driving mode (e.g., that the system is currently being autonomously driven and/or is navigating to a destination) and (2) a second set of one or more colors that is representative of whether the system is currently in a static state and/or has determined that the system will not move within the stopped time. In some embodiments, left display 1000a displays outside area 1020a with the same visual characteristic and/or pattern as visual characteristic 1012a. In some embodiments, instead of and/or in addition to a color, visual characteristic 1012a is a level of brightness, a level of tint, a respective tone, a level of pulsing frequency, and/or a respective hue. In some embodiments, visual characteristic 1012a is an image (e.g., an image that includes or does not include text) and/or is a video. It should be recognized that how visual characteristic 1012a is illustrated (e.g., as growing and/or shrinking in height) in FIGS. 10A-10F is intended to be an example and that other animations can be used with techniques described herein, such as expanding and contracting from an area, a visual representation of an anatomical feature (e.g., an eye), and/or with the use of changing to different colors.

Notably, in some figures, visual characteristic 1012a is included in a first portion of inside area 1010a while not included in another portion of inside area 1010a. In some embodiments, the first portion including visual characteristic 1012a (e.g., as illustrated in FIG. 10A) indicates that the system is currently being autonomously driven and/or is navigating to a destination. In some embodiments, the second portion not including visual characteristic 1012a (e.g., as illustrated in FIG. 10A) indicates that the system is currently in a static state and/or has determined that the system will not move within the stopped time.

In some embodiments, an appearance of the indication can change based on a motion state of the system (e.g., (1) whether the system is on, active, moving, and/or will be moving within the initialization time, (2) whether the system is being autonomously or manually navigated, (3) whether the system is moving, (4) a speed, acceleration, and/or direction of travel of the system, and/or (5) whether the system has determined to stop and/or move). For example, left display 1000a can display an indication whether the system is in an autonomous driving state, such as illustrated by visual characteristic 1012a in FIG. 10A. For another example, left display 1000a can display an indication whether the system has determined to move (e.g., while stopped) and/or is moving, such as illustrated by visual characteristic 1012a in FIG. 10B. For another example, left display 1000a can display an indication whether the system has determined to stop (e.g., while moving) and/or is stopping, such as illustrated by visual characteristic 1012a from FIG. 10B to FIG. 10D. It should be recognized that such examples of the indication and discussion below are just for discussion purposes and that different representations of the indication can be used with techniques described herein.

At FIG. 10A, a determination is made that the system will not be moving within the stopped time. In some embodiments, as a result of the determination that the system will not be moving within the stopped time, the system displays (1) visual characteristic 1012a within inside area 1010a and (2) visual characteristic 1012b within inside area 1010b.

At FIG. 10A, a determination is made that the system will begin moving within the initialization time. In some embodiments, the determination that the system will begin moving is based on detecting one or more actions of a user, such as a user interacting with the system, the user and/or the system starting to move, and/or the user sending one or more requests to the system. In some embodiments, the determination that the system will begin moving is based on one or more micro movements (e.g., small vibrations) made by the system, such as movements that can be detected by a gyroscope and/or a heart rate sensor that is external to the system (e.g., that is wearable by a driver and/or passenger). In some embodiments, the determination that the system will begin moving is based on an autonomous driving system that is navigating the system to a destination.

As illustrated in FIG. 10B, based on the determination being made that the system will begin moving within the initialization time and/or the system is moving outside of the initialization time, left display 1000a increases the size of visual characteristic 1012a. Accordingly, at FIG. 10B, visual characteristic 1012a covers more of inside area 1010a than visual characteristic 1012a covered at FIG. 10A. Additionally, at FIG. 10B, based on the determination being made that the system will begin moving within the initialization time and/or the system is moving outside of the initialization time, right display 1000b increases the size of visual characteristic 1012b.

In some embodiments, as a part of increasing the size of visual characteristic 1012a, left display 1000a displays an animation of visual characteristic 1012a filling up inside area 1010a over time (e.g., a slide up animation and/or a filling animation, where visual characteristic 1012a slowly rises upward to cover more of inside area 1010a). In some embodiments, the rate of the animation of visual characteristic 1012a filling up inside area 1010a is not based on a rate of movement of the system. That is, visual characteristic 1012a fills inside area 1010a at a constant rate irrespective of the rate at which the system accelerates. In some embodiments, left display 1000a completes the display of the animation of visual characteristic 1012a filling up inside area 1010a before the system moves in a direction (e.g., forward, backwards and/or to the side).

In some embodiments, based on the determination being made that the system will begin moving within a predetermined period of time (sometimes referred to as the raising time), an elevation of the system automatically (e.g., without intervening user input) raises. In some embodiments, the elevation of the system remains raised while the system is in motion (e.g., until the system determines to stop and/or during a lowering time, as discussed further below). In some embodiments, raising the elevation of the system includes raising an elevation of a front portion (e.g., at least a portion of the area to the left of lateral axis 20 in FIG. 1) of the system while raising or maintaining an elevation of a back portion (e.g., at least a portion of the area to the left of lateral axis 20 in FIG. 1) of the system. In some embodiments, the display of left display 1000a and/or right display 1000b change (e.g., to indicate the elevation of the system) as the elevation of the system changes. In some embodiments, the appearance of outside area 1020a and/or outside area 1020b do not change as the elevation of the system changes.

In some embodiments, the elevation of the system automatically (e.g., without intervening user input) decreases as the system is stopped and/or within a predetermined period of time from being stopped (sometimes referred to herein as the lowering time). For example, the elevation of the system decreases to an elevation of a sidewalk such that a passenger can safely exit the system. In some embodiments, decreasing the elevation of the system includes decreasing the elevation of the front portion of the system and raising or maintaining the elevation of the rear portion of the system. In some embodiments, the system outputs a sound as the elevation of the system decreases. In some embodiments, the audio characteristics (e.g., tone, bass, and/or pitch) of the sound that the system outputs changes as the elevation of the system changes. For example, the volume of the sound decreases as the elevation decrease. In some embodiments, left display 1000a displays visual characteristic 1012a within a portion of inside area 1010a (e.g., as illustrated in FIG. 10D) to indicate that the system is not moving and that the system is in an autonomous state. In some embodiments, the display of outside area 1020b change (e.g., to indicate the elevation of the system) as the elevation of the system changes. In some embodiments, the display of inside area 1012a, outside area 1020a, visual characteristics 1012b, and/or outside area 1020b change (e.g., to indicate the elevation of the system) as the elevation of the system changes. For example, inside area 1012a and/or visual characteristics 1012b can be progressively filled with one or more colors as the elevation of the system increases. For another example, inside area 1012a and/or visual characteristics 1012b can be progressively drained of one or more colors as the elevation of the system decreases.

In some embodiments, an appearance of outside area 1020a is based on different characteristics of the system than inside area 1012a. For example, the appearance of outside area 1020a can change based on an energy level of the system (e.g., a battery level of the system) and/or a driving direction (e.g., turn left or turn right) or indication (e.g., hazard) of the system as discussed further below. At FIG. 10B, left display 1000a does not change the display of outside area 1020a based on the determination being made that the system will begin moving within the initialization time.

At FIG. 10B, left display 1000a continues to display inside area 1010a and visual characteristic 1012a as presented in FIG. 10B until a determination is made that the system has stopped or is beginning to stop (e.g., as further discussed below in relation to FIGS. 10C-10D). At FIG. 10B, a determination is made that the system is turning left or intending to turn left. Further, at FIG. 10B, a determination is made that the system is coming to a stop and/or will stop moving within a predetermined period of time (sometimes referred to herein as the stopping time). In some embodiments, the determination is made that system is coming to a stop because a street sign, crosswalk a bike path, people, and/or a hazard is detected in the path of the system.

As explained above, the appearance of outside area 1020a is based on a characteristic of the system. As discussed in greater detail below, the appearance of outside area 1020a is at least based on the current direction of travel the system and/or a future direction of travel of the system. In some embodiments, the appearance of outside area 1020a can be based on a number of different characteristics of the system such as the speed of the system and/or an acceleration rate of the system.

As illustrated in FIG. 10C, based on the determination being made that the system is turning left (and/or intending to turn left), left display 1000a displays visual characteristic 1018a within outside area 1020a. Visual characteristic 1018a is an indication of the state of one or more characteristics of the system. More specifically, at FIG. 10C. visual characteristic 1018a is an indication that the system is turning left and/or intends to turn left. Though at FIG. 10C visual characteristic 1018a is similar in appearance to the visual characteristic 1012a (e.g., both are a solid color), the appearance of both visual characteristic 1018a and visual characteristic 1012a at FIG. 10C is merely exemplary. In some embodiments, visual characteristic 1018a within outside area 1020a is a different color, level of brightness, and/or hue than visual characteristic 1012a. In some embodiments, visual characteristic 1018a within outside area 1020a pulsates (e.g., similar to a turn signal) while visual characteristic 1012a does not pulsate. In some embodiments, left display 1000a concurrently changes the display of outside area 1020a and inside area 1010a based on a determination that the system (e.g., mobile system 10) will turn left. For example, left display 1000a changes the display of outside area 1020a and inside area 1010a when the system decelerates in order to make a left turn. In some embodiments, left display 1000a does not change the display of inside area 1010a based on a determination that the system will turn left.

In some embodiments, the appearance of outside area 1020a and outside area 1020b indicate different states of the system. For example, at FIG. 10C, right display 1000b does not display a respective visual characteristic within outside area 1020b because the determination was made that the system will turn left (and not right). That is, left display 1000a updates the appearance of outside area 1020a to indicate a first type of turn of the system (e.g., a left turn) and, as discussed in greater detail below at FIG. 10F, right display 1000b updates the appearance of outside area 1020b to indicate a second type of turn (e.g., a right turn) of the system. In some embodiments, both outside area 1020a and outside area 1020b are updated to indicate a change in the state of the system. For example, both outside area 1020a and outside area 1020b can be updated to indicate that the system is performing or intends to perform a u turn. For another example, outside area 1020a and/or outside area 1020b can be updated to indicate a system fault, such as one or more components not operating as intended (e.g., less air in a tire and/or one or more light sources not operating).

Returning to discussion of the display of visual characteristic 1012a, as the system comes to a stop, the display of visual characteristic 1012a changes to indicate that the system is coming to a stop. For example, visual characteristics 1012b can fade out, decrease in a frequency in which visual characteristic 1012a pulsates, change in an amount of tint and/or shading, and/or change color as the system comes to a stop. At FIG. 10C, based on the determination being made that left display 1000a is coming to a stop (e.g., deaccelerating), left display 1000a reduces the amount of visual characteristic 1012a displayed within inside area 1010a. At FIG. 10C, left display 1000a reduces the amount of visual characteristic 1012a displayed within inside area 1010a by displaying an animation of visual characteristic 1012a being removed from inside area 1010a (e.g., a sliding down animation and/or a fading out animation). In some embodiments, the rate of the animation (e.g., the speed at which visual characteristic 1012a is removed) is based on the rate at which the system is decelerating. For example, when the system comes to a stop at a faster rate, left display 1000a removes visual characteristic 1012a at a faster rate and when the system comes to a stop at a slower rate, left display 1000a removes visual characteristic 1012 at a slower rate. In some embodiments, left display 1000a outputs a sound while reducing the amount of visual characteristic 1012a. For example, left display 1000a can output a sound that mimics an automobile slowing down (e.g., the sound that brake pads made when brake pads come into contact with a rotor of a wheel and/or the sound an engine makes as the rotations per minute of the engine decrease). In some embodiments, the volume or tone of the sound decreases proportionally to the reduction in the amount of visual characteristic 1012a. At FIG. 10C, a hazard is detected (e.g., by left display 1000a, right display 1000b, and/or the system) within the physical environment.

At FIG. 10D, left display 1000a has completed reducing the amount of visual characteristic 1012a that is displayed within inside area 1010a based on the determination being made that the system is coming to a stop (e.g., decelerating). At FIG. 10D, the system has fully stopped, and most of visual characteristic 1012a has been removed from inside area 1010a. However, a portion of visual characteristic 1012a remains in inside area 1010a (e.g., the same portion that was present within inside area 1010a when left display 1000a was originally stopped in FIG. 10A).

In some embodiments, left display 1000a and/or right display 1000b can indicate information regarding conditions that are detected within the physical environment via outside area 1020a and/or outside area 1020b. For example, the appearance of outside area 1020a and/or outside area 1020b can be changed to indicate weather conditions, hazards in the path of the system, and/or hazards with respect to the operation of the system. Accordingly, outside area 1020a and/or outside area 1020b can be configured to indicate changes to the state of the system and/or conditions that are detected in the physical environment.

As illustrated in FIG. 10D, based on the determination that a hazard is within the physical environment, left display 1000a displays visual characteristic 1018a within outside area 1020a, and right display 1000b displays visual characteristic 1018b within outside area 1020b. In some embodiments, left display 1000a and right display 1000b concurrently display hazard information (e.g., identical visual characteristics in outside area 1020a and outside area 1020b) that pulsate at the same time and/or at the same frequency (e.g., similar to a hazard signal of a car). In some embodiments, outside area 1020a or outside area 1020b displays an indication of a hazard that is detected based on the positioning of the hazard relative to the system. For example, if the hazard is closer to the left display than the right display, then outside area 1020a will display the indication of the hazard and outside area 1020b will not display a respective indication of the hazard. In some embodiments, left display 1000a and right display 1000b display an indication of the hazard in outside area 1020a and outside area 1020b based on a determination that the system (e.g., mobile system 10) is malfunctioning and/or a determination is made that a user of the system would like to convey hazard information. For example, based on a determination that the user is drowsy, having a medical episode, and/or is incapable for operating the system, left display 1000a and/or right display 1000b can display an indication of the state of the user within outside area 1020a and/or outside area 1020b. As an additional example, based on a determination that the pressure per square inch (e.g., PSI) of a wheel of the system is below a threshold and/or that a turning signal of the system is inoperable, left display 1000a and/or right display 1000b can display an indication of the state of the system within outside area 1020a and/or outside area 1020b.

In some embodiments, left display 1000a and/or right display 1000b do not change the display of inside area 1010a and/or inside area 1010b based on the detection of a hazard. In some embodiments, left display 1000a and/or right display 1000b changes the appearance of inside area 1010a and/or inside area 1010b and does not change the appearance of outside area 1020a and/or outside area 1020b based on the detection of the hazard. For example, left display 1000a and right display 1000b can display a graphical and/or textual representation of the detected hazard within their respective display areas. In some embodiments, left display 1000a displays outside area 1020a with a different amount of a respective visual characteristic when left display 1000a indicates the detection of a hazard in contrast to when left display 1000a signals that the system is making a turn. For example, left display 1000a can display outside area 1020a with a light blue color based on a determination that the system is making a left turn and/or a will make a left turn, and left display 1000a can display outside area 1020a with a dark blue color in response to the detection of a hazard. As an additional example, left display 1000a can display outside area 1020a as a solid static color based on a determination that the system is making a left turn and/or a will make a left turn, and left display 1000a can display outside area 1020a with an appearance that rotates between two or more colors based on a determination that a hazard is detected.

At FIG. 10D, an individual is detected (e.g., by the system and/or by right display 1000b) within a predetermined area of right display 1000b (e.g., while the system is stopped). The first individual is detected to be an adult. In some embodiments, the first individual is detected via one or more sensors (e.g., one or more cameras and/or one or more depth sensors) of the system.

In some embodiments, in addition to displaying indications of the state of the system, left display 1000a and/or right display 1000b displays indications of various types of objects that are detected within the physical environment. For example, left display 1000a can display a static solid color, an animation of a color, a textual representation, and/or a graphical representation of the object that is detected in the physical environment. The appearance of the representation of the object can change as the object moves within the physical environment with respect to the system. For example, the representation of the object can grow in size as the distance between the object and the system decreases or the color of the representation of the object can increase in intensity as the distance between the object and the system increases. For another example, a pulsation frequency of the representation of the object can increase (or decrease) as the distance between the object and the system increases.

As illustrated in FIG. 10E, based on the detection of the first individual within the predetermined area of right display 1000b, right display 1000b displays representation of individual 1032 within inside area 1010b. For example, the first individual is 0.1-100 feet away from right display 1000b or the first individual is within a field of view of a camera that is in communication with and/or corresponds to right display 1000b. In some embodiments, representation of individual 1032 is only visible from a position that is outside the system. For example, representation of individual 1032 is obscured from a passenger of the system.

At FIG. 10E, right display 1000b does not update the display of outside area 1020b based on the detection of the first individual within the predetermined area of right display 1000b. In some embodiments, right display 1000b does not display a representation of a non-movable and/or non-mobile object (e.g., a tree, a building, and/or a traffic signal) (and/or non-people/animals) that is positioned within the physical environment irrespective of the distance between the non-movable and/or non-mobile object and the system. In some embodiments, left display 1000a and right display 1000b only display representations of movable and/or mobile objects that are positioned in the physical environment.

Right display 1000b displays the indication of the object detected in the environment with an appearance that is based on the appearance of the object. For example, because the first individual is detected to be an adult, the appearance of representation of individual 1032 corresponds to that of an adult. In some embodiments, the appearance of the indication of the detection of the object is not based on the appearance of the object. For example, in some embodiments, right display 1000b displays a blue circle when an animal is detected in the physical environment. In some embodiments, representation of individual 1032 is not a live feed and/or does not actually resemble (e.g., look like) the first individual. For example, representation of individual 1032 does not mimic the motions of the first individual. In some embodiments, representation of individual 1032 does not have a fixed shape (e.g., representation of individual 1032 is a blob), where a size and/or shape of the first individual is not represented by representation of individual 1032. However, representation of individual 1032, in some embodiments, includes one or more facial features of the first individual. In some embodiments, right display 1000b moves representation of individual 1032, such that representation of individual 1032 mimics the movement of the first individual in the physical environment.

In some embodiments, right display 1000b does not display representation of individual 1032 when the first individual is at a distance from right display 1000b (e.g., and/or the system) that is greater than a predetermined distance threshold (e.g., 1-100 feet). In some embodiments, right display 1000b initiates the display of representation of individual 1032 based on a determination being made that the distance between the first individual and the system transitions from being greater than the predetermined distance threshold to a distance from right display 1000b to less than the predetermined distance threshold. For example, right display 1000b can initiate display of representation of individual 1032 based on the system having moved closer to the first individual, the first individual moving towards the system or both the first individual and the system having moved closer towards each other. In some embodiments, right display 1000b displays representation of individual 1032 with a size that is based on the distance between right display 1000b and the first individual. For example, right display 1000b displays representation of individual 1032 with a larger size the closer the first individual is to the system and right display 1000b displays representation of individual with a smaller size the further the first individual is from the system.

In some embodiments, the display of representation of individual 1032 is dynamic and visual characteristic 1012b is static. For example, the display of the representation of individual 1032 can mimic movements and/or behavior of the first individual while visual characteristic 1012 is displayed as a solid static color. In some embodiments, right display 1000b ceases to display representation of individual 1032 when a determination is made that the first individual is no longer within the predetermined area or zone of right display 1000b. In some embodiments, right display 1000b does not display representation of individual 1032 while the system is in motion.

To note, at FIG. 10E, left display 1000a does not display an indication that the first individual is detected in the physical environment. Because a determination is made that the first individual is within the predetermined area (e.g., direction) of right display 1000b (e.g., and not left display 1000a), right display 1000b displays the indication of the first individual and left display 1000a does not.

Right display 1000b concurrently displays an indication of the state and an indication of objects that are detected in the physical environment. More specifically, as illustrated in FIG. 10E, right display 1000b displays representation of individual 1032 (e.g., for the individual that is within the predetermined area) in inside area 1010b while a portion of visual characteristic 1012b continues to be displayed in inside area 1010b. The display of representation of individual 1032 does not overlap with the display of visual characteristic 1012b (e.g., visual characteristic 1012b and representation of individual 1032 are displayed on different, non-overlapping portions of inside area 1010b). In some embodiments, representation of individual 1032 has the same color (or brightness) as visual characteristic 1012b. In some embodiments, representation of individual 1032 is displayed at a location that previously included visual characteristic 1012b (e.g., as illustrated in FIG. 10B).

At FIG. 10E, a determination is made that the first individual moves outside of the predetermined area of right display 1000b and within the predetermined area of left display 1000a. Further, at FIG. 10E, a determination is made that a second individual moves within the predetermined area of right display 1000b. At FIG. 10E, it is determined that the second individual is a child. Lastly, at FIG. 10E, a determination is made that the system will turn right.

Left display 1000a and right display 1000b can work in tandem to display the indication of the detected object as the object moves between the predetermined areas of left display 1000a and right display 1000b. At FIG. 10F, because a determination is made that the first individual moves outside of the predetermined area of right display 1000b and within the predetermined area of left display 1000a, right display 1000b ceases to display representation of individual 1032 and left display 1000a displays representation of individual 1032. Similar to right display 1000b, left display 1000a does not update the display of outside area 1020a based on the detection of the first individual within the predetermined area of left display 1000a. In some embodiments, left display 1000a and does not display a visual representation of a subject that is not an individual (and/or an animal) even if the subject is within the predetermined area of left display 1000a. Thus, in some embodiments, left display 1000a displays representations for some subjects within the physical environment and not others within the physical environment. In some embodiments, while the system is in motion and/or has determined to move within the initialization time, left display 1000a and/or right display 1000b does not display a representation of a subject.

At FIG. 10F, because a determination is made that the second individual 1040b moves within the predetermined area of right display 1000b, right display 1000b displays representation of individual 1034. As explained above, the indication of the object can have an appearance that is based on the appearance of the object that is detected. At FIG. 10F, because the second individual is detected to be a child, the appearance of representation of individual 1034 corresponds to that of a child.

Additionally, because a determination is made that the system is turning right, right display 1000b displays visual characteristic 1080b within outside area 1020b. Accordingly, as illustrated in FIG. 10F, right display 1000b concurrently displays visual characteristic 1020b, visual characteristic 1012b and representation of individual 1032. In some embodiments, the predetermined area (e.g., of left display 1000a and/or right display 1000b) is a continuous area. The predetermined area of left display 1000a can include a continuous area that does not have any holes, gaps, or other breaks of continuity. For another example, the predetermined area of left display 1000a and the predetermined area of right display 1000b can be a continuous area with redundancy (and/or overlap) between the predetermined area of left display 1000a and the predetermined area of right display 1000b. In such an example, an object moving from a predetermined area (e.g., of left display 1000a) to another predetermined area (e.g., of right display 1000b) can be visually represented in one or both of left display 1000a and right display 1000b during the entire movement from the predetermined area to the other predetermined area. In some embodiments, the predetermined area (e.g., of left display 1000a and/or right display 1000b) is not a continuous area. For example, the predetermined area of left display 1000a can include a sparse area where certain portions of the area are not represented in left display 1000a. For another example, an area that is between the predetermined area of left display 1000a and the predetermined area of right display 1000b might not be represented in either right display 1000a or left display 1000b. In such an example, an object moving from a predetermined area (e.g., of left display 1000a) to another predetermined area (e.g., of right display 1000b) might not be visually represented in either left display 1000a or right display 1000b during the entire movement from the predetermined area to the other predetermined area. In some embodiments, whether the predetermined area is continuous depends on a distance of an object from the system (e.g., the predetermined area of left display 1000a and/or right display 1000b can have a cone shape that expand a distance from the system increases). For example, as the object gets closer to the system, the predetermined area overlaps less, causing an object to be able to not be represented in either left display 1000a or right display 1000b when in a particular area between the predetermined area of left display 1000a and the predetermined area of right display 1000b. In such an example, when the object is at least a certain distance away from the system, the predetermined area can overlap such that an object is represented in at least one of left display 1000a and right display 1000b while moving from the predetermined area of left display 1000a to the predetermined area of right display 1000b.

While FIGS. 10A-10F have been described above in relation to an accessibility feature, it should be understood that the techniques above could be used in one or more other applications. For example, display areas 1010a and 1010b could be headlights on a mobile system, where the mobile system (e.g., a vehicle, a boat, a bike, a truck, and/or a truck) would display the user interface of FIGS. 10A-10F via inside area 1010a and inside area 1010b, using one or more techniques described herein, based on movement of the mobile system.

The foregoing is merely illustrative and various modifications can be made to the described embodiments. The foregoing embodiments may be implemented individually or in any combination.

The following is a description of an exemplary mobile system. The following exemplary mobile system is configured to indicate the detection of objects in a physical environment. Some of the features of the exemplary mobile system that are described below are optionally combined, modified, and/or omitted.

As described below, the exemplary mobile system provides an intuitive way for indicating the detection of objects in a physical environment. The below described exemplary mobile system increases the safety of the operation of the mobile system. For battery-operated mobile systems indicating the detection of objects in a physical environment in a faster and more efficiently conserves power and increases the time between battery charges.

In some embodiments, a mobile system (e.g., 10) comprises an exterior surface (e.g., 18) at least partially surrounding an interior (e.g., 11). In some embodiments, the exterior surface completely surrounds the interior. In some embodiments, the exterior surface does not completely surround the interior.

In some embodiments, the mobile system (e.g., 10) comprises one or more sensors (e.g., a telephoto camera, a wide angle camera, an ultra-wide angle camera, a, temperature sensor, a lidar sensor, a radar sensor, and/or a motion sensor) configured to detect signals corresponding to an environment (e.g., 13) exterior to (e.g., outside of, near, and/or within a distance from) the exterior surface (e.g., 18) of the mobile system (e.g., 10) (e.g., the environment completely and/or partially surrounds the mobile system and/or the environment encompasses the mobile system), the signals corresponding to (e.g., associated with, indicating, and/or used to determine) proximity of an object (e.g., an individual, an animal, and/or a static object (e.g., a tree, a fence, and/or a fire hydrant)) relative to the mobile system (e.g., relative to the exterior surface of the mobile system and/or relative to the one or more sensors). In some embodiments, the one or more sensors are attached to the exterior surface. In some embodiments, the one or more sensors are within the exterior surface. In some embodiments, the interior includes the one or more sensors. In some embodiments, the interior does not include the one or more sensors. In some embodiments, the signals are used to determine a location and/or orientation of the object. In some embodiments, the signals are used to determine a distance of the object from the mobile system.

In some embodiments, the mobile system (e.g., 10) comprises a display (e.g., 1000a and/or 1000b) (e.g., a display generation component (e.g., a projector, a display screen, and/or a touch-sensitive display), a projector, a display screen and/or a touch-sensitive display) positioned on (e.g., attached to, located at, and/or presenting content in a direction away from) the exterior surface (e.g., 18) of the mobile system (e.g., 10) (e.g., positioned on one or more portions of the exterior surface and/or the display spans across a majority of the exterior surface) and configured to display a representation (e.g., 1032 and/or 1034) of the object (e.g., in accordance with a. determination that one or more signals detected via the one or more sensors corresponds to the object and/or that the object is in proximity of the mobile system), the display being obscured (e.g., at least partially obscured) from the interior (e.g., 11) such that the representation of the object is not visible from a first position (and/or one or more positions) within the interior. In some embodiments, the display is configured to display the representation of the object with an appearance that corresponds to one or more characteristics (e.g., speed, movement size, and/or shape) of the object. In some embodiments, the representation of the object is displayed on one or more displays. In some embodiments, the display is configured to display the representation of the object with an appearance that is based on a state of the mobile system (e.g., the mobile system is coming to a stop, the mobile system is stopped, and/or the mobile system is accelerating). In some embodiments, the display is configured to display the representation of the object when a set of one or more criteria is satisfied (e.g., the object is within a field of view of one or more cameras of the mobile system, the brightness level of the physical environment is below a threshold amount, and/or the distance between the mobile system and the object is below a distance threshold). Having a display positioned on the exterior surface of the mobile system obscured from the interior of the mobile system that is configured to display a representation of objects in proximity to the mobile system provides subjects outside of the mobile system information on what the mobile system is detecting, thereby providing improved visual feedback and improving the safety of the operation of the mobile system.

In some embodiments, the exterior surface (e.g., 18) includes a first terminal end (e.g., end that corresponds to 12 or 14) (e.g., the front of the exterior surface, the back of the exterior surface, or a side of the exterior surface) and a second terminal end (e.g., end that corresponds to 12 or 14) (e.g., the front of the exterior surface, the back of the exterior surface, or a side of the exterior surface) different from the first terminal end. In some embodiments, the first terminal end is disposed on a first position of a longitudinal axis (e.g., 22) of the mobile system (e.g., 10) (e.g., an axis that spans along the length of the mobile system). In some embodiments, the second terminal end is disposed on a second position of the longitudinal axis of the mobile system. In some embodiments, the first position and the second position are on opposite sides of a transverse axis (e.g., 20) of the mobile system, (e.g., an axis that spans along the width of the mobile system). In some embodiments, the display (e.g., 1000a and/or 1000b) is positioned on the first terminal end of the exterior surface (and/or not on the second terminal end of the exterior surface). In some embodiments, the display is positioned on the first terminal end of the exterior surface and the second terminal end of the exterior surface. In some embodiments, the display is located on a first portion of the first terminal end and a second portion (e.g., that is different and/or distinct from the first portion) of the first terminal end. In some embodiments, a plurality of displays, including the display, are located on the first terminal end of the exterior surface. In some embodiments, the display is on the front of the exterior surface. In some embodiments, the mobile system is configured to move in a first direction corresponding to the first terminal end of the exterior surface (e.g., while in a first mode (e.g., moving forward)). In some embodiments, the mobile system is configured to move in a second direction (e.g., different from the first direction) corresponding to the second terminal end of the exterior surface (e.g., while in a second mode (e.g., moving backwards) different from the first mode). Having a display be disposed on the first terminal end of the exterior surface of the mobile system provides subjects who are in the principal direction of travel of the mobile system with visual feedback regarding the state of the mobile system and/or the state of the environment, thereby providing improved visual feedback and improving the safety of the operation of the mobile system.

In some embodiments, the display (e.g., 1000a and/or 1000b) is configured to display representations of objects (e.g., 1032 and/or 1034) of a first type (e.g., movable objects (e.g., individuals, and/or animals) and/or animate objects) (e.g., in accordance with a determination that an object of the first type is in a first orientation with respect to the one or more sensors and/or the mobile system and/or that the object of the first type is within a predefined distance from the one or more sensors and/or the mobile system) and is not configured to display representations of objects of a second type different from the first type (e.g., non-movable object (e.g., rocks, traffic signs, buildings, and/or trees) and/or inanimate objects) (e.g., in accordance with a determination that an object of the second type is in a second orientation (e.g., different from the first orientation) with respect to the one or more sensors and/or the mobile system) (e.g., in accordance with a determination that an object of the second type is not within the predefined distance from the one or more sensors and/or the mobile system) (e.g., in accordance with a determination that an object of the second type is in the second orientation with respect to the one or more sensors and/or the mobile system) (e.g., in accordance with a determination that an object of the second type is within the predefined distance from the one or more sensors and/or the mobile system). In some embodiments, the display is configured to display representations of both objects of the first type and objects of the second type. In some embodiments, the display is configured to display representations of objects of the second type and is not configured to display representations of objects of the first type. The display being configured to display objects of the first type and not the second type provides subjects outside of the mobile system information on what the mobile system is detecting while limiting such information to particular types of objects, thereby providing improved visual feedback and improving the safety of the operation of the mobile system.

In some embodiments, the mobile system (e.g., 10) has a first operational state (e.g., powered on, executing one or more operations, and/or configured to execute one or more operations), a second operational state (e.g., powered on, executing one or more operations, and/or configured to execute one or more operations) and a non-operational state (e.g., powered off, not configured to execute one or more operations, and/or in a lower (e.g., lower than the first operational state and/or the second operational state and/or an off) state) (and/or one or more other operational states) (and/or one or more other states). In some embodiments, the non-operational state is different from the second operational state and the first operational state. In some embodiments, the second operational state is different from the first operational state. In some embodiments, the first operational state corresponds to (e.g., is, includes, and/or is associated with) a mobile state (e.g., the mobile system is configured to move while the mobile system is in the first operational state). In some embodiments, the mobile system is moving and/or has determined to move within the predetermined period of time when and/or while in the first operational state. In some embodiments, the mobile system changes to the first operational state in response to a determination that the mobile system will move within the predetermined period of time. In some embodiments, the second operational state corresponds to (e.g., is, includes, and/or is associated with) a non-mobile state (e.g., the mobile system and/or a portion of the mobile is system is configured to not move (e.g., the mobile system is in a respective gear (e.g., a parked gear) and/or a brake of the mobile system is being applied to a set of one or more wheels (e.g., by a user and/or by the mobile system)) within the predetermined period of time when and/or while in the second operational state). In some embodiments, the mobile system is not moving and/or has determined to not move within the predetermined period of time when and/or while in the second operational state. In some embodiments, the mobile system changes to the second operational state in response to a determination that the mobile system will not move within the predetermined period of time. In some embodiments, the mobile system is not operational (e.g., the mobile system is powered off and/or the battery life of the mobile system is below a power threshold) (e.g., and/or configured not to move) while the mobile system is in the non-operational state. In some embodiments, the one or more sensors is not configured to detect signals corresponding to the environment while in the non-operational state, the first operational state, and/or the second operational state. In some embodiments, the one or more sensors is configured to detect signals corresponding to the environment while in the non-operational state, the first operational state, and/or the second operational state. In some embodiments, the mobile system is not moving while in the non-operational state. In some embodiments, the mobile system is not and/or has not executed an operation to move the mobile system while in the non-operational state. In some embodiments, the display is off and/or inactive in the non-operational state. In some embodiments, the display is on and/or active in the non-operational state. In some embodiments, the display is on and/or active in the first operational state and/or the second operational state. In some embodiments, the display is off and/or inactive in the first operational state and/or the second operational state. The mobile system having two operational states and a non-operational state allows the mobile system to configure displays and sensors differently depending on how the mobile system is operating, thereby providing improved visual feedback and improving the safety of the operation of the mobile system.

In some embodiments, the display (e.g., 1000a and/or 1000b) is configured to display the representation (e.g., 1032 and/or 1034) of the object in accordance with a determination (e.g., a determination that is made by the mobile system, a computer system that is in communication with the mobile system, and/or a computer system that is external to the mobile system) that (and/or when, while, and/or in response to) the mobile system (e.g., 10) has transitioned from the first operational state to the second operational state. In some embodiments, the display is configured to not display the representation of the object in accordance with a determination that that the mobile system has transitioned from the second operational state to the first operational state. In some embodiments, the display is configured to display representations of objects while the mobile system is in the second operational state and not in the first operational state and/or the non-operational state. In some embodiments, the display is not configured to display representations of objects while the mobile system is in the first operational state and/or the non-operational state. In some embodiments, the display is configured to not display representations of objects while the mobile system is in the first operational state and/or the non-operational state. In some embodiments, transitioning from the first operational state to the second operational state causes the mobile system to configure the display to display representations of objects detected via the one or more sensors. In some embodiments, transitioning from the second operational state to the first operational state causes the mobile system to configure the display to no longer display representations of objects detected via the one or more sensors. Having a display that is configured to display a representation of the object when a set of prescribed conditions are met automatically allows the mobile system to configure the display to perform a display operation that indicates the current operational state of the of the mobile system, thereby performing an operation when a set of conditions has been met without requiring further user input.

In some embodiments, the first position corresponds to a seated position (e.g., on the floor of the mobile system or on a chair, bench, and/or seat of the mobile system) (e.g., of a user, person, and/or subject) within the interior (e.g., 11) (e.g., as discussed above in relation to FIG. 10A). In some embodiments, the representation of the object is not visible from any position within the interior. The display not being visible to a subject in the seated position within the interior avoids the display from being a distraction to the subject, thereby providing improved visual feedback and improving the safety of the operation of the mobile system.

In some embodiments, the representation (e.g., 1032 and/or 1034) of the object is visible (e.g., essentially only visible, sometimes visible, only visible, and/or almost only visible) from the environment exterior (e.g., 13) to the exterior surface (e.g., 18) of the mobile system (e.g., 10) (e.g., a position external to and/or outside of the interior) (e.g., and not from a location within the interior). In some embodiments, the representation of the object is visible from a plurality of positions within the environment. In some embodiments, the representation of the object is not visible from a and/or any position within the interior. The display being visible to subjects exterior to the exterior surface of the mobile system allows the display to notify the subjects of what the mobile system is detecting, thereby providing improved visual feedback and improving the safety of the operation of the mobile system.

In some embodiments, while the display (e.g., 1000a and/or 1000b) is configured to display the representation (e.g., 1032 and/or 1034) of the object and in accordance with a determination (e.g., a determination that is made by the mobile system, a computer system that is in communication with the mobile system, and/or a computer system that is external to the mobile system) that the object has a first set of characteristics (e.g., size, color, speed of movement, distance from the mobile system, and/or shape of the object), the display is configured to display the representation of the object with a first set of visual characteristics (e.g., size, color, shape, movement on display, speed of the display of the representation of the object), (e.g., the first set of visual characteristics is based on and/or corresponds to the first set of characteristics) (e.g., as discussed above at FIG. 10E). In some embodiments, while the display (e.g., 1000a and/or 1000b) is configured to display the representation (e.g., 1032 and/or 1034) of the object an in accordance with a determination (e.g., a determination that is made by the mobile system, a computer system that is in communication with the mobile system, and/or a computer system that is external to the mobile system) that the object has a second set of characteristics (e.g., size, color, speed of movement, distance from the mobile system, and/or shape of the object) that is different (e.g., different number of characteristics, different size, different shape and/or different color) than the first set of characteristics, the display is configured to display the representation of the object with a second set of visual characteristics (e.g., size, color, speed of movement, distance from the mobile system, and/or shape of the representation of the object) (e.g., the second set of visual characteristics correspond to and/or are based on the second set of characteristics) that is different than the first set of visual characteristics (e.g., as discussed above at FIG. 10E). In some embodiments, the display is configured to display a first representation of a first object with the first set of visual characteristics and display a second representation of a second object with the second set of visual characteristics. In some embodiments, the display is configured to display the representation of the object with the first set of visual characteristics before or after the display displays the representation with the second set of visual characteristics. Having the display be configured to display the representation of the object with a respective set of visual characteristics based on characteristics of the object when a set of prescribed conditions are met automatically allows the mobile system to selectively configure the display based on one or more characteristics of the object, thereby performing an operation when a set of conditions has been met without requiring further user input.

In some embodiments, (e.g., while the mobile system is not moving or moving) the display (e.g., 1000a and/or 1000b) is configured to display a first indication (1012a and/or 1012b) (e.g., an animation of a graphical indication and/or an animation of a textual indication) of a determination (e.g., a determination that is made by the mobile system, a computer system that is in communication with the mobile system, and/or a computer system that is external to the mobile system) whether (and/or that) the mobile system (e.g., 10) will be in a moving state (and/or moving) within a first predetermined amount of time (e.g., 1-30 seconds) (e.g., the mobile system will transition from a moving state to a non-moving state or the mobile system will remain in a non-moving state) (e.g., the mobile system will transition from a non-moving state to a moving state or the mobile system will remain in a moving state). In some embodiments, the display ceases to be configured to display the first indication in accordance with a determination (e.g., a determination that is made by the mobile system, a computer system that is in communication with the mobile system, and/or a computer system that is external to the mobile system) that the mobile system will not be in the moving state within the predetermined amount of time (e.g., 1-30 seconds). In some embodiments, the display ceases to be configured to display the first indication in accordance with a determination (e.g., a determination that is made by the mobile system, a computer system that is in communication with the mobile system, and/or a computer system that is external to the mobile system) that the mobile system will be in the moving state within the predetermined amount of time (e.g., 1-30 seconds). In some embodiments, the display is concurrently configured to display an indication of a determination that the mobile system will not be in the moving state within the first predetermined amount of time and the representation of the object. In some embodiments, the display is concurrently configured to display the first indication with the representation of the object. Having the display be configured to display an indication that the mobile system will be moving within a predetermined amount of time provides subjects external to the mobile system with visual feedback regarding how long the mobile system will remain in a non-moving state, thereby providing improved visual feedback and improving the safety of the operation of the mobile system.

In some embodiments, (e.g., while the mobile system is not moving or moving) the display (e.g., 1000a and/or 1000b) is configured to display the representation (e.g., 1032 and/or 1034) of the object with a second indication (e.g., 1012a and/or 1012b) (e.g., an animation of a graphical indication and/or an animation of a textual indication) of a determination (e.g., a determination that is made by the mobile system, a computer system that is in communication with the mobile system, and/or a computer system that is external to the mobile system) that the mobile system (e.g., 10) will not be in a moving state (e.g., the mobile system will transition from a moving state to a non-moving state or the mobile system will remain in a non-moving state) within a second predetermined amount of time (e.g., 1-30 seconds). In some embodiments, the display ceases to be configured to display the second indication in accordance with a determination that the mobile system will be in a moving state within the predetermined amount of time. Having the display be configured to display an indication that the mobile system will not be moving within a predetermined amount of time provides subjects external to the mobile system with visual feedback regarding when the mobile system will transition from a moving state to a non-moving state, thereby providing improved visual feedback and improving the safety of the operation of the mobile system.

In some embodiments, while the display (e.g., 1000a and/or 1000b) is configured to display the representation (e.g., 1032 and/or 1034) of the object and in accordance with a determination that the object is a first type of object (e.g., an animate object (e.g., an individual or an animal) or an inanimate object (e.g., a vehicle, a tree, a building, a traffic sign, and/or a traffic light)) (and/or that the object is a first subject), the display is configured to display the representation as a first type of representation (e.g., the object has a particular color, size, shape and/or positional orientation on the display) (and/or with a first visual appearance) (e.g., as described above in relation to FIG. 10E-10F). In some embodiments, the first type of representation and/or the first visual appearance is different from an appearance of the object. In some embodiments, while the display (e.g., 1000a and/or 1000b) is configured to display the representation (e.g., 1032 and/or 1034) of the object and in accordance with a determination that that the object is a second type of object (e.g., an animate object (e.g., an individual or an animal) or an inanimate object (e.g., a vehicle, a tree, a building, a traffic sign, and/or a traffic light)) different from the first type of object (e.g., different size, different weight, different color, brand, different model, and/or different species) (and/or that the object is a second subject different form the first subject), the display is configured to display the representation as a second type of representation that is different (e.g., different color, size, shape and/or positional orientation on the display) from the first type of representation e.g., as described above in relation to FIGS. 10E-10F) (and/or with a second visual appearance different from the first visual appearance). In some embodiments, appearance of the representation of the object is based on the appearance of the object. In some embodiments, the second type of representation and/or the second visual appearance is different from an appearance of the object.

In some embodiments, the mobile system (e.g., 10) further comprises a set of one or more audio output devices (e.g., speakers, televisions, subwoofers, tweeter speakers, horns, and/or air horns). In some embodiments, (e.g., before, after, and/or while the display is configured to display the representation of the object) in accordance with a determination (e.g., a determination that is made by the mobile system, a computer system that is in communication with the mobile system, and/or a computer system that is external to the mobile system) that the mobile system is transitioning from a moving state to a non-moving state (e.g., the mobile system is decelerating, the mobile system transitions from traveling at a speed above a threshold (e.g., 1-25 miles per hour) to a speed that is below the threshold, the mobile system will stop moving within a period of time (e.g., 1-60 seconds)), the set of one or more audio output devices is configured to output audio (e.g., one nor more audio tones, a single discrete tone, a continuous tone, and/or a repeating tone) based on a speed (e.g., a rate of movement) of the mobile system (e.g., as described in relation to FIG. 10C) (e.g., the pitch, tone, bass, treble of the audio is dependent on the speed of the mobile system). In some embodiments, in accordance with a determination that the mobile system is transitioning from the moving state to the non-moving state and that a current speed of the mobile system is a first speed (and/or that a current acceleration of the mobile system is a first acceleration), the set of one or more audio output devices is configured to output first audio. In some embodiments, in accordance with a determination that the mobile system is transitioning from the moving state to the non-moving state and that a current speed of the mobile system is a second speed different from the first speed (and/or that a current acceleration of the mobile system is a second acceleration different from the first acceleration), the set of one or more audio output devices is configured to output second audio different from the first audio. In some embodiments, in accordance with a determination (e.g., a determination that is made by the mobile system, a computer system that is in communication with the mobile system, and/or a computer system that is external to the mobile system) that the mobile system is transitioning from the non-moving state to the moving state (e.g., the mobile system is accelerating, the mobile system transitions from traveling at a speed that is below the threshold to traveling at a speed that is above the threshold, the mobile system will begin moving within the period of time) (e.g., as described above at FIG. 10A), the set of one or more audio devices is configured to output audio that is not based on the speed of the mobile system. In some embodiments, in accordance with a determination that the mobile system is transitioning from the non-moving state to the moving state and that a current speed of the mobile system is a third speed (and/or that a current acceleration of the mobile system is a third acceleration), the set of one or more audio devices is configured to output third audio. In some embodiments, in accordance with a determination that the mobile system is transitioning from the non-moving state to the moving state and that a current speed of the mobile system is a fourth speed different from the third speed (and/or that a current acceleration of the mobile system is a fourth acceleration different from the third acceleration), the set of one or more audio devices is configured to output the third audio. In some embodiments, the third speed is the second speed. In some embodiments, the fourth speed is the first speed. In some embodiments, the third speed is the first speed. In some embodiments, the fourth speed is the second speed. In some embodiments, the third acceleration is the second acceleration. In some embodiments, the fourth acceleration is the first acceleration. In some embodiments, the third acceleration is the first acceleration. In some embodiments, the fourth acceleration is the second acceleration. Having the set of one or more audio output devices be configured to output audio based on a speed of the mobile system when a set of prescribed conditions are met (e.g., while the mobile system is transitioning from the moving state to the non-moving state) allows the mobile system to automatically provide an audio output that indicates the speed of the mobile system as the mobile system slows down, thereby configuring the set of one or more audio output devices to perform operation when a set of conditions has been met without requiring further user input.

In some embodiments, (e.g., before, after, and/or while the display is configured to display the representation of the object) in accordance with a determination (e.g., a determination that is made by the mobile system, a computer system that is in communication with the mobile system, and/or a computer system that is external to the mobile system) that the mobile system (e.g., 10) is in a first state (e.g., a moving state, a non-moving state, the mobile system is accelerating, the mobile system is decelerating, and/or the mobile system is not moving), the display (e.g., 1000a and/or 1000b) is configured to display a representation (e.g., a textual representation and/or a graphical representation) of the physical environment (e.g., as discussed at FIGS. 10E and 10F) (e.g., a representation of a characteristic of the environment (e.g., a temperature of the environment, a noise level of the environment, a pollution level of the environment, a brightness level of the environment) and/or an object in the environment) (e.g., an external state (e.g., external to the mobile system) of the physical environment). In some embodiments, in accordance with a determination (e.g., a determination that is made by the mobile system, a computer system that is in communication with the mobile system, and/or a computer system that is external to the mobile system) that the mobile system is in a second state (e.g., a moving state, a non-moving state, the mobile system is accelerating, the mobile system is decelerating, and/or the mobile system is not moving), different from the first state, the display is configured to not display the representation (e.g., 1032 and/or 1034) of the physical environment (e.g., as discussed at FIG. 10E) (and/or a representation of the physical environment and/or a representation of an external state of the physical environment). Having the display be configured to display a representation of the physical environment when a set of prescribed conditions are met allows the mobile system to automatically configure the display to alert subjects to the state of the mobile system (e.g., whether the mobile system is moving or not), thereby performing an operation when a set of conditions has been met without requiring further user input, providing improved visual feedback, and increasing the safety of the operation of the mobile system.

In some embodiments, the display (e.g., 1000a and/or 1000b) is a first display (1010a and/or 1010b). In some embodiments, the mobile system (e.g., 10) further comprises a second display (1010a and/or 1010b) different from the first display. In some embodiments, the second display is positioned on (e.g., attached to, located at, and/or presenting content away from) the exterior surface (e.g., 18) of the mobile system (e.g., positioned on one or more portions of the surface and/or the display spans across a majority of the exterior surface) and configured to display one or more representations (e.g., 1032 and/or 1034) of one or more objects (e.g., in accordance with a. determination that one or more signals detected via the one or more sensors corresponds to the one nor more objects and/or that the one or more objects is in proximity of the mobile system). In some embodiments, the second display is obscured (e.g., at least partially obscured) from the interior (e.g., 11) such that the one or more representations of the one or more objects is not visible from a second position (and/or one or more positions) within the interior. In some embodiments, the mobile system further comprises a first illumination source (e.g., 1020a and/or 1020b) at least partially surrounding the first display (and, in some embodiments, not the second display). In some embodiments, the first illumination source fully surrounds the first display. In some embodiments, the mobile system further comprises a second illumination (e.g., 1020a and/or 1020b) source at least partially surrounding the second display (and, in some embodiments, not the first display). In some embodiments, the second illumination source fully surrounds the second display. In some embodiments, the second illumination source is different (and/or separate) from the first illumination source. In some embodiments, (e.g., before, after, and/or while the display is configured to display the representation of the object) in accordance with a determination (e.g., a determination that is made by the mobile system, a computer system that is in communication with the mobile system, and/or a computer system that is external to the mobile system) that the mobile system is performing a first operation (e.g., signaling a change in the navigation of the mobile system (e.g., the mobile system will turn left)), the first illumination source and not the second illumination source is active (and/or outputting illumination) (e.g., the first illumination source is active and the second illumination source is not active (e.g., off, inactive, and/or in a lower-power state)). In some embodiments, (e.g., before, after, and/or while the display is configured to display the representation of the object) in accordance with a determination (e.g., a determination that is made by the mobile system, a computer system that is in communication with the mobile system, and/or a computer system that is external to the mobile system) that the mobile system is performing a third operation (e.g., signaling a change in the navigation of the mobile system (e.g., the mobile system will turn right)), the second illumination source and not the first illumination source is active (and/or outputting illumination) (e.g., the second illumination source is active and the first illumination source is not active (e.g., off, inactive, and/or in a lower-power state)). In some embodiments, in accordance with a determination (e.g., a determination that is made by the mobile system, a computer system that is in communication with the mobile system, and/or a computer system that is external to the mobile system) that the mobile system is performing a second operation different from the first operation (e.g., the mobile system is braking, signaling a status of the mobile system, and/or signaling a status of users within the mobile system), the first illumination source and the second illumination source are active (and/or outputting (e.g., concurrently and/or separately outputting) illumination).

Note that details of the exemplary mobile system described above are also applicable in an analogous manner to other exemplary mobile systems described herein. For brevity, these details are not repeated below.

The following is a description of an exemplary mobile system. The following exemplary mobile system is configured to selectively indicate the presence of an object in a physical environment. Some of the features of the exemplary mobile system that are described below are optionally combined, modified, and/or omitted.

As described below, the exemplary mobile system provides an intuitive way for selectively indicating the presence of an object in a physical environment. The below described features increases the safety of the operation of the mobile system. For battery-operated mobile systems, indicating the presence of an object in a physical environment in a faster and more efficiently conserves power and increases the time between battery charges.

In some embodiments, a mobile system (e.g., 10) comprises an exterior surface (e.g., 18) at least partially surrounding an interior (e.g., 11) (e.g., the exterior surface surrounds the entirety of the interior or less than the entirety of the interior).

In some embodiments, the mobile system (e.g., 10) comprises a first display (e.g., 1000a and/or 1000b) (e.g., a display screen and/or a touch-sensitive display) positioned on the exterior surface (e.g., 18), the first display being disposed on a first side of a longitudinal centerline (e.g., 22) of the mobile system (e.g., 10) (e.g., the first display is in communication with the mobile system and/or integrated into the mobile system on a first side of the longitudinal centerline).

In some embodiments, the mobile system (e.g., 10) comprises a second display (e.g., 1000a and/or 1000b) (e.g., a display screen and/or a touch-sensitive display) positioned on the exterior surface (e.g., 18), the second display being disposed on a second side of the longitudinal centerline (e.g., 22) of the mobile system (e.g., 10) (e.g., the first display is in communication with the mobile system and/or integrated into the mobile system on the first side of the longitudinal centerline), the second side being opposite to the first side (e.g., the second side is on the front left of the mobile system and the first side is on the front right of the mobile system or the second side is on a left side of the mobile system and the first side is on a right side of the mobile system), wherein the first display (e.g., 1000a and/or 1000b) is configured to display a first representation of an object (e.g., 1032 and/or 1034) external to the interior (e.g., 11) (e.g., the first display is configured to display the representation on a majority of the first display or less than a majority of the first display), wherein the first representation corresponds to the position of the object with respect to the first side, wherein the second display is configured to display a second representation of the object (e.g., 1032 and/or 1034) (e.g., the second display is configured to display the second representation on a majority of the second display or less than a majority of the second display), and wherein the second representation corresponds to the position of the object with respect to the second side. In some embodiments, the first display and/or the second display is configured to display the first representation and/or the second representation of the object with an appearance that corresponds to one or more characteristics (e.g., speed, movement size, and/or shape) of the object. In some embodiments, the first representation and/or the second representation of the object is displayed on one or more displays. In some embodiments, the first representation and the second representation have the same appearance. In some embodiments, the first representation and the second representation have different appearances. Having a first display on a first side of a longitudinal centerline of the mobile system be configured to display a first representation of the object and having a second display on a second side of the longitudinal centerline of the mobile system be configured to display a second representation of the object provides subjects with visual feedback regarding which objects in the environment the mobile system can detect, thereby providing improved visual feedback and improving the safety of the operation of the mobile system.

In some embodiments, the first display (e.g., 1000a and/or 1000b) has a first field of view (e.g., 0°-180°). In some embodiments, the second display (e.g., 1000a and/or 1000b) has a second field of view (e.g., 0°-180°) different (and/or distinct) from the first field of view. In some embodiments, the first field of view at least partially overlaps with the second field of view. In some embodiments, the first field of view does not overlap with the second field of view. In some embodiments, there is a common object within the first field of view and the second field of view. In some embodiments, there is not a common object within the first field of view and the second field of view. Having the first display have a first field of view and having the second display have a second field of view that is different from the first field of view allows each display to correspond to a different area of an environment and allow subjects to be able to view whichever display is more relevant to a particular area, thereby providing improved visual feedback and improving the safety of the operation of the mobile system.

In some embodiments, the second field of view does not overlap with the first field of view (e.g., as described above in relation to FIG. 10A). The fields of view not overlapping allows the mobile system to maximum display space while ensuring that subjects exterior to the interior of the mobile system can properly identify where they are being detected by the mobile system, thereby providing improved visual feedback and improving the safety of the operation of the mobile system.

In some embodiments, the first display (e.g., 1000a and/or 1000b) has a third field of view (e.g., 0°-360°). In some embodiments, the first display is configured to display the first representation (e.g., 1032 and/or 1034) while the object is within the third field of view. In some embodiments, the first display is configured to not display the first representation while the object is outside of the third field of view. In some embodiments, the first display is configured to display the first representation in accordance with a determination that the object is within the third field of view and not a field of view of the second display. Having the first display be configured to display the first representation when a set of prescribed conditions are met automatically allows the mobile system to automatically configure the first display to perform a display operation that indicates to subjects what objects in the environment are within the field of view of the first display and which objects in the environment are not within the field of view of the first display, thereby performing an operation when a set of conditions has been met without requiring further user input.

In some embodiments, the second display (e.g., 1000a and/or 1000b) has a fourth field of view (e.g., 0°-180°) (e.g., the fourth field of view is different than the third field of view). In some embodiments, the second display is configured to display the second representation while the object is within the fourth field of view. In some embodiments, the second display is configured to not display the second representation while the object is outside of the fourth field of view. In some embodiments, the second display is configured to display the second representation in accordance with a determination that the object is within the fourth field of view and not a field of view of the first display. Having the display be configured to display the second representation when a set of prescribed conditions are met automatically allows the mobile system to automatically configure the second display to perform a display operation that indicates to subjects what objects in the environment are within the field of view of the second display and which objects in the environment are not within the field of view of the second display, thereby performing an operation when a set of conditions has been met without requiring further user input.

In some embodiments, the first display (e.g., 1000a and/or 1000b) has a fifth field of view (e.g., 0°-180°). In some embodiments, the second display (e.g., 1000a and/or 1000b) has a sixth field of view (e.g., 0°-180°) (e.g., the fifth field of view is different and/or distinct from the sixth field of view). In some embodiments, the first display is configured to display the first representation (e.g., 1032 and/or 1034) (e.g., and the second display is configured to not display the second representation) (e.g., on a first portion of the first display (e.g., the first portion of the first display corresponds and/or is based on the position of the object)) while the object is positioned at a first position (e.g., within the physical environment that is exterior and/or surrounds the exterior surface of the mobile system) that is within the fifth field of view (e.g., and not the sixth field of view). In some embodiments, after the first display is configured to display the first representation while the object is positioned at the first position, the first display is configured to display the first representation (e.g., on a second portion of the first display (e.g., the second portion of the display is different and/or distinct from the first portion of the first display)) while the object is positioned at a second position (e.g., within the physical environment that is exterior and/or surrounds the exterior surface of the mobile system) (e.g., that is different/distinct from the first position) that is within the fifth field of view (e.g., as described above in relation to FIG. 10F) (e.g., and the sixth field of view) (e.g., and the second display is configured to display the second representation in accordance with a determination that the object is positioned at the second position that is within the fifth field of view (e.g., and the sixth field of view)). In some embodiments, the first display is configured to display the first representation at different portions of the first display based on where the object is positioned within the fifth field of view (e.g., the first representation is displayed at a portion of the first display corresponding to a position within the fifth field of view). In some embodiments, the second position is different from the first position. In some embodiments, after the first display is configured to display the first representation while the object is positioned at the second position, the first display is configured to not display the first representation while (and/or in response to) the object (e.g., is positioned at a third position (e.g., that is different/distinct from the first position and/or second position) (e.g., within the physical environment that is exterior and/or surrounds the exterior surface of the mobile system) that) is not within the fifth field of view (e.g., as described above in relation to FIG. 10F) (and/or within the sixth field of view). Having the first display be configured to display a first representation when a set of prescribed conditions are met allows the mobile system to automatically configure the first display to perform a display operation that indicates to subjects how the mobile system detects the movement of an object within the environment relative to the mobile system, thereby performing an operation when a set of conditions has been met without requiring further user input.

In some embodiments, the first display (e.g., 1000a and/or 1000b) has a seventh field of view (e.g., 0°-180°). In some embodiments, the second display has an eighth field of view (e.g., 0°-180°) (e.g., the eight field of view is different and/or distinct from the seventh field of view). In some embodiments, the second display (e.g., 1000a and/or 1000b) is configured to display the second representation (e.g., 1032 and/or 1034) (e.g., and the first display is configured to not display the first representation) (e.g., on a first portion of the second display (e.g., the first portion of the second display corresponds and/or is based on the position of the object)) while the object is positioned at a third position (e.g., within the physical environment that is exterior and/or surrounds the exterior surface of the mobile system) that is within the eighth field of view (e.g., and not the seventh field of view). In some embodiments, after the second display is configured to display the second representation while the object is positioned at the third position, the second display is configured to display the second representation (e.g., on a second portion of the second display (e.g., the second portion of the second display is different and/or distinct from the first portion of the second display)) while the object is positioned at fourth position (e.g., within the physical environment that is exterior and/or surrounds the exterior surface of the mobile system) (e.g., that is different/distinct from the third position) that is within the eighth field of view (e.g., and the seventh field of view) (e.g., and the first display is configured to display the first representation in accordance with a determination that the object is positioned at the fourth position that is within the seventh field of view (e.g., and the eighth field of view)). In some embodiments, the second display is configured to display the second representation at different portions of the second display based on where the object is positioned within the eighth field of view (e.g., the second representation is displayed at a portion of the second display corresponding to a position within the eight field of view). In some embodiments, the third position is different from the fourth position. In some embodiments, after the second display is configured to display the second representation while the object is positioned at the fourth position, the second display is configured to not display the second representation while (and/or in response to) the object (e.g., is positioned at a respective position n (e.g., that is different/distinct from the third position and/or fourth position) (e.g., within the physical environment that is exterior and/or surrounds the exterior surface of the mobile system) that) is not within the eighth field of view (and/or within the seventh field of view) (e.g., as described above at FIG. 10F). Having the second display be configured to display a second representation when a set of prescribed conditions are met allows the mobile system to automatically configure the second display to perform a display operation that indicates to subjects how the mobile system detects the movement of an object within the environment relative to the mobile system, thereby performing an operation when a set of conditions has been met without requiring further user input.

In some embodiments, the first display (e.g., 1000a and/or 1000b) has a ninth field of view (e.g., 0°-180°). In some embodiments, the second display (e.g., 1000a and/or 1000b) has a tenth field of view (e.g., 0°-180°) (e.g., the ninth field of view is different than the tenth field of view). In some embodiments, the first display is configured to display the first representation (e.g., 1032 and/or 1034) while the object is detected within the ninth field of view. In some embodiments, the first display is configured to not display the first representation while the object is not within the ninth field of view. In some embodiments, the second display is configured to display the second representation (e.g., 1032 and/or 1034) while the object is within the tenth field of view. In some embodiments, the second display is configured to not display the second representation while the object is not within the tenth field of view. Having the first display and the second display be configured to display a representation of an object when a set of prescribed conditions are met allows the mobile system to automatically configure the first display and the second display to perform a respective display operation that indicates to subjects what objects the mobile system detects within the environment, thereby performing an operation when a set of conditions has been met without requiring further user input.

In some embodiments, the object is a first type of object (e.g., moveable objects and/or living objects). In some embodiments, the first display (e.g., 1000a and/or 1000b) and the second display (e.g., 1000a and/or 1000b) are configured to not display representations (e.g., 1032 and/or 1034) of a second type (e.g., immovable objects, and/or non-living objects) of object different from the first type of object. In some embodiments, the first display and the second display are configured to display both animate and inanimate objects. In some embodiments, the appearance (e.g., size, color, and/or shape) of the representation is based on the appearance of the object. The displays being configured to display objects of the first type and not objects of the second type reduces amount of distractions and/or content included on displays when being viewed by subjects external to the interior of the mobile system, thereby providing improved visual feedback and improving the safety of the operation of the mobile system.

In some embodiments, (e.g., before, after, and/or while the first display is configured to display the first representation of the object and before, after, and/or while the second display is configured to display the second representation of the object) in accordance with a determination (e.g., made the by the mobile system, a computer system within the mobile system and/or a computer system external to the mobile system) that the mobile system (e.g., 10) is in a first state (e.g., a moving state, a non-moving state, acceleration state, and/or deceleration state), a first portion of the first display (e.g., 1000a and/or 1000b) (e.g., less than the entirety of the first display, a majority of the first display, a minority of the first display) and a second portion of the second display (e.g., 1000a and/or 1000b) (e.g., less than the entirety of the first display, a majority of the first display, a minority of the first display) are configured to be synchronized (e.g., as described above in relation to FIG. 10A) (e.g., display the same graphical objects and/or display the same animations). In some embodiments, (e.g., before, after, and/or while the first display is configured to display the first representation of the object and before, after, and/or while the second display is configured to display the second representation of the object) in accordance with a determination (e.g., made the by the mobile system, a computer system within the mobile system and/or a computer system external to the mobile system) that the mobile system is in a second state (e.g., a moving state, a non-moving state, acceleration state, and/or deceleration state), different from the first state, the first portion of the first display and the second portion of the second display are configured to be not synchronized (e.g., as described above in relation to FIG. 10A) (e.g., the first display and the second display do not display the same graphical objects and/or display the same animations). Having a portion of the first display and the second display be synchronized when a set of prescribed conditions are met allows the mobile system to automatically indicate to subjects whether the mobile system is in a moving state or a non-moving state, thereby performing a display operation when a set of conditions has been met without requiring further user input and improving the safety of the operation of the mobile system.

In some embodiments, the first display (e.g., 1000a and/or 1000b) and the second display (e.g., 1000a and/or 1000b) are disposed on a common side of a transverse axis (e.g., 20) of the mobile system (e.g., 10). The first display and the second display being disposed on a common side of a transverse axis of the mobile system allows the displays to cover a larger field of view in a particular direction while allows such content to be displayed in different locations, thereby providing improved visual feedback and improving the safety of the operation of the mobile system.

In some embodiments, the first display (e.g., 1000a and/or 1000b) and the second display (e.g., 1000a and/or 1000b) are disposed on the mobile system (e.g., 10) at a first depth (e.g., 0.1-36 inches) from a first surface (e.g., the front, top, bottom, back, and/or side surface) of the mobile system. In some embodiments, the first display and the second display are disposed on two or more surfaces of the mobile system (e.g., as described above in relation to FIG. 10A).

In some embodiments, the mobile system (e.g., 10) further comprises a third display (e.g., 1000a and/or 1000b) (e.g., a display screen and/or a touch-sensitive display). In some embodiments, the third display is configured to display a first movement intention (e.g., 1010a, 1010b, 1020a, and/or 1020b) (e.g., determination, operation to be performed, and/or an anticipated direction) of the mobile system (e.g., 10) (e.g., the mobile system is and/or will be turning within a predetermined amount of time (e.g., 1-360 seconds)). In some embodiments, the first display (e.g., 1000a and/or 1000b) and the second display (e.g., 1000a and/or 1000b) are not configured to display a movement intention (e.g., the first movement intention and/or a different movement intention) of the mobile system. Having a third display that is configured to display a first movement intention of the mobile system allows the mobile system to provide visual feedback to subjects regarding the present and future movement intentions of the mobile system, thereby providing improved visual feedback and increasing the safety of the operation of the mobile system.

In some embodiments, the first display (e.g., 1000a and/or 1000b) and the second display (e.g., 1000a and/or 1000b) are disposed on the mobile system (e.g., 10) at a second depth (e.g., 0.1-36 inches) from a second surface (e.g., the front, top, bottom, back, and/or side surface) of the mobile system. In some embodiments, the third display is disposed on the mobile system at a third depth (e.g., 0.1-36 inches), different from the second depth (e.g., the third depth is greater than or less than the second depth), from the second surface of the mobile system (e.g., as described above in relation to FIG. 10A). In some embodiments, the first display, the second display, and the third display are disposed on the mobile system at a common depth from the second surface. In some embodiments, the first display, the second display, and the third display are disposed on a common surface of the mobile system. In some embodiments, the first display is disposed on the mobile system at the second depth from a first respective surface. In some embodiments, the third display is disposed on the mobile system at the third depth from the first respective surface. In some embodiments, the second display is disposed on the mobile system at the second depth from a second respective surface different from the first respective surface.

In some embodiments, the mobile system (e.g., 10) further comprises a fourth display (e.g., 1000a and/or 1000b) (e.g., a display screen and/or a touch-sensitive display). In some embodiments, the fourth display is disposed at a fourth depth (e.g., 0.1-36 inches) along a longitudinal axis (e.g., 22) (e.g., a longitudinal axis along a centerline of the mobile system or a longitudinal axis that is offset from a centerline of the mobile system) of the mobile system. In some embodiments, the first display (e.g., 1000a and/or 1000b) and the second display (e.g., 1000a and/or 1000b) are disposed at a fifth depth (e.g., 0.1-36 inches), different from the fourth depth (e.g., greater than or less than the fourth depth), along the longitudinal axis. In some embodiments, the fourth display is configured to display a third movement intention (e.g., determination, operation to be performed, and/or an anticipated direction) of the mobile system.

In some embodiments, the mobile system further comprises a set of one or more illumination sources (e.g., 1020a and/or 1020b) that, at least, partially surrounds the first display (e.g., 1000a and/or 1000b). In some embodiments, in accordance with a determination that the mobile system (e.g., 10) is performing a first operation (e.g., signaling that direction of the navigation of the mobile system will change (e.g., the mobile system will turn left and/or the mobile system will turn right)), a first portion (e.g. less than all, a majority, or a minority) of the set of one or more illumination sources is configured to illuminate (e.g. illuminate in a steady state and/or illuminate in a pattern) and a second portion of the set of one or more illumination sources is configured to not illuminate (e.g., as described above at FIGS. 10C, 10D, and/or 10F). In some embodiments, in accordance with a determination that the mobile system is performing a second operation different from the first operation (e.g., signaling the mobile system is braking, signaling a status of the mobile system, and/or signaling a status of users within the mobile system), the first portion of the set of one or more illumination sources and the second portion of the set of one or more illumination sources is configured to illuminate (e.g., as described above at FIGS. 10C, 10D, and/or 10F). Having a set of one or more illumination sources be configured to a illuminate a respective portion of the set of one or more illumination sources when a set of prescribed conditions are met (e.g., whether the mobile system is signaling a turn or signaling a hazard) allows the mobile system to automatically configure the set of one or more illumination sources such that the mobile system can indicate to subjects whether the navigation direction of the mobile system will change or whether the mobile system has detected a hazard, thereby performing an operation when a set of conditions has been met without requiring further user input and improving the operation of the mobile system.

Note that details of the exemplary mobile system described above are also applicable in an analogous manner to other exemplary mobile systems described herein. For brevity, these details are not repeated below.

The following is a description of an exemplary mobile system. The following exemplary mobile system is configured to indicate the presence of an object in close proximity to the mobile system. Some of the features of the exemplary mobile system that are described below are optionally combined, modified, and/or omitted.

As described below, the exemplary mobile system provides an intuitive way for selectively indicating the presence of an object in close proximity to the mobile system. The below described features increases the safety of the operation of the mobile system. For battery-operated mobile systems, indicating the presence of an object in close proximity to the mobile system in a faster and more efficiently conserves power and increases the time between battery charges.

In some embodiments, a mobile system (e.g., 10) comprises an exterior surface (e.g., 18) at least partially surrounding an interior (e.g., 11) (e.g., the exterior surface surrounds the entirety of the interior or less than the entirety of the interior).

In some embodiments, the mobile system comprises, an illumination source (e.g., 1020a and/or 1020b) (e.g., a single source (e.g., a single light bulb or a single lamp) or an array of light sources (e.g., an array of light bulbs or an array of lamps)) positioned on the exterior surface (e.g., 18) (e.g., the illumination source is positioned on a portion (e.g., less than a majority) of the exterior surface or the illumination source is positioned on a majority of the exterior surface), the illumination source (e.g., 1020a and/or 1020b) configured to illuminate an environment (e.g., 13) exterior to the exterior surface (e.g., 1020a and/or 1020b), the mobile system (e.g., 10) configured to move relative to (e.g., within) the environment in a first direction.

In some embodiments, the mobile system comprises display (e.g., 1020a and/or 1020b) (e.g., display screen and/or a touch-sensitive display) positioned on the exterior surface (e.g., 18) (e.g., positioned on a majority of the exterior surface or and positioned on less than a majority of the exterior surface) configured to display a representation (e.g., a graphical representation and/or a textual representation) of an object (e.g., 1032 and/or 1034) detected in the proximity (e.g., 1-24 feet) of the exterior surface, the display being obscured from the interior (e.g., 11). Configuring the display to display a representation of an object detected in the proximity of the exterior surface provides subjects with visual feedback with respect to which objects in the environment that surrounds the mobile system are detected and which objects in the environment are not detected, thereby providing improved visual feedback.

In some embodiments, the display (e.g., 1000a and/or 1000b) is comprised of one or more of a light plate assembly (e.g., 28) (e.g. an assembly that includes a plurality of light-emitting components, cover lens (e.g., a glass, ceramic, and/or polymer layer through which light emitted by a set of one or more illumination sources shines light through), diffuser (e.g., 34), heatsink (e.g., 30) (e.g., an apparatus that draws heat from a heat source), carrier (e.g., 31), and a louver (e.g., 36) (e.g., a series of angled apertures). In some embodiments, spacers separate one of more components of the display. In some embodiments, the various elements of the display are connected via an adhesive and/or a fastener (e.g., screw and/or nail).

In some embodiments, the display (e.g., 1000a and/or 1000b) is configured to display a first indication (e.g., 1012a, 1012b, 1018a, and/or 1018b) (e.g., a textual and/or graphical indication) of a state of the mobile system (e.g., 10) in accordance with a determination that the mobile system is in a first operational state. In some embodiments, the display is configured to display a second indication (e.g., 1012a, 1012b, 1018a, and/or 1018b) (e.g., a textual and/or graphical indication) of the state of the mobile system in accordance with a determination that the mobile system is in a second operational state different from the first operational state. In some embodiments, the second indication is different from the first indication. In some embodiments, the second indication includes the first indication. In some embodiments, the display is configured to display a third indication of a transition of an operational state of the mobile system in accordance with a determination (e.g., the determination is made by the mobile system, a computer system that is in communication with the mobile system, and/or a computer system external to the mobile system) that the mobile system is transitioning from the first operational state to the second operational state (e.g., the mobile system is transitioning from a non-moving state to a moving state, the mobile system is transitioning from moving in a first direction to moving in a second direction, and/or the mobile system is transitioning from a first speed to a second speed) (e.g., or will transition within a predetermined amount of time) (e.g., or has transitioned within the predetermined amount of time). In some embodiments, the display is configured to display the first representation and/or the second representation at the same time as the first indication. In some embodiments, the display is configured to display one of (1) the first indication or (2) the first representation and/or the second. Having the display be configured to display an indication of a state of the mobile system in addition to a representation of an object detected in the proximity to the exterior surface when a set of prescribed conditions are met allows the mobile system to automatically selectively configure the display to indicate to subjects the present state of the mobile system and/or a future state of the mobile system, thereby performing an operation when a set of conditions has been met without requiring further user input.

In some embodiments, the mobile system (e.g., 10) further comprises a mobile actuator (e.g., an axle being rotated via an engine (e.g., such as by a drive shaft)). In some embodiments, the mobile actuator (e.g., a pneumatic hydraulic system, a set of springs, or an electric hydraulic system) is configured to cause the mobile system (e.g., the entirety of the mobile system or a portion of the mobile system) to move in the first direction (e.g., at a first time) and a second direction (e.g., at a second time different from the first time) perpendicular to the first direction (e.g., as described above in relation to FIG. 10A). In some embodiments, the mobile actuator is configured to cause the mobile system to move in a third direction that is perpendicular to the first direction and opposite of the second direction. In some embodiments, the mobile actuator is configured to cause a first portion of the mobile system to move in a fourth direction and a second portion of the mobile system to move in a fifth direction.

In some embodiments, the mobile system (e.g., 10) further comprises a first set of illumination sources (e.g., 1020a and/or 1020b) (e.g., one or more light sources or a single light source) (e.g., LED lights, compact fluorescent lamps, and/or halogen lamps) that at least partially surrounds the display (e.g., 1000a and/or 1000b) (e.g., the entire periphery or a portion of the periphery of the display). In some embodiments, the first set of illumination sources are configured to output illumination to indicate a direction of travel (e.g., future travel) (e.g., turning left and/or turning right), a state of the mobile system (e.g., hazard), and/or that the mobile system is braking. The first set of illumination sources at least partially surrounding the display allows subjects external to the interior of the mobile system to look in one general direction (e.g., toward the display) to see information from both the first set of illumination sources and the display, thereby providing improved visual feedback and improving the safety of the operation of the mobile system.

In some embodiments, the mobile system (e.g., 10) further includes a second set of one or more illumination sources (e.g., 1020a and/or 1020b) (e.g., one or more light sources or a single light source) (e.g., LED lights, compact fluorescent lamps, and/or halogen lamps) that at least partially surrounds the display (e.g., 1000a and/or 1000b) (e.g., the entire periphery or a portion of the periphery of the display). In some embodiments, the second set of one or more illumination sources is configured to emit light at least partially around (e.g., at a periphery of) a light plate assembly (e.g., 28) of the display and through a cover lens (e.g., 37) of the display.

In some embodiments, while the representation of the object (e.g., 1032 and/or 1042) is displayed, in accordance with a determination (e.g., the determination is made by the mobile system, a computer system that is in communication with the mobile system, and/or a computer system external to the mobile system) that the object is a first distance from the mobile system (e.g., 10) (e.g., the exterior surface, a sensor in communication with the mobile system, a sensor of the mobile system, and/or a portion of the mobile system) the representation is a first size. In some embodiments, while the representation of the object (e.g., 1032 and/or 1042) is displayed, in accordance with a determination that the object is a second distance from the mobile system, the representation is a second size different from (e.g., smaller or bigger) the first size. In some embodiments, after displaying the representation at the first size, the display is configured to display the representation at the second size in accordance with a determination that the object is the second distance from the mobile system. In some embodiments, after displaying the representation at the second size, the display is configured to display the representation at the first size in accordance with a determination that the object is the first distance from the mobile system. Having the representation at different sizes depending on distance of the object from the mobile system allows subjects external to the interior of the mobile system to identify distance of the object as detected by the mobile system, thereby providing improved visual feedback and improving the safety of the operation of the mobile system.

In some embodiments, (e.g., before, after, and/or while the display is configured to display the representation of the object) in accordance with a determination (e.g., the determination is made by the mobile system, a computer system that is in communication with the mobile system, and/or a computer system external to the mobile system) that the mobile system (e.g., 10) is in a first state (e.g., the mobile system is not moving, the mobile system is moving, the mobile system is decelerating, the mobile system is accelerating, the mobile system will transition from a non-moving state to a moving state within a predetermined amount of time (e.g., 1-60 seconds) and/or the mobile system will transition from a moving state to a non-moving state within a predetermined amount of time (e.g., 1-60 seconds)), the display (e.g., 1000a and/or 1000b) is configured to display a first amount of light (e.g., 1-10000 lux and/or lumens). In some embodiments, (e.g., before, after, and/or while the display is configured to display the representation of the object) in accordance with a determination (e.g., the determination is made by the mobile system, a computer system that is in communication with the mobile system, and/or a computer system external to the mobile system) that the mobile system is in a second state (e.g., the mobile system is not moving, the mobile system is moving, the mobile system is decelerating, the mobile system is accelerating, the mobile system will transition from a non-moving state to a moving state within a predetermined amount of time (e.g., 1-60 seconds) and/or the mobile system will transition from a moving state to a non-moving state within a predetermined amount of time (e.g., 1-60 seconds)) different from the first state, the display is configured to display a second amount of light (e.g., 1-10000 lux and/or lumens) different (e.g., greater than or less than) from the first amount of light. In some embodiments, the display transitions from being configured to display the first amount of light to being configured to display the second amount of light. Displaying different amounts of light depending on a state of the mobile system allows the mobile system to indicate to subjects external to the interior of the mobile system of the state of the mobile system, thereby providing improved visual feedback and improving the safety of the operation of the mobile system.

In some embodiments, (e.g., before, after, and/or while the display is configured to display the representation of the object) in accordance with a determination (e.g., the determination is made by the mobile system, a computer system that is in communication with the mobile system, and/or a computer system external to the mobile system) that the mobile system (e.g., 10) is accelerating (e.g., from a non-moving state), the display (e.g., 1000a and/or 1000b) is configured to increase amount of light output over time (e.g., to a maximum amount of light) (e.g., not based on an amount of acceleration (e.g., the amount of light increases at a rate that does not correspond to the amount of acceleration)). In some embodiments, after outputting the maximum amount of light, changes in acceleration do not affect the amount of light output by the display. In some embodiments, (e.g., before, after, and/or while the display is configured to display the representation of the object) in accordance with a determination (e.g., the determination is made by the mobile system, a computer system that is in communication with the mobile system, and/or a computer system external to the mobile system) that the mobile system is decelerating (e.g., to a stop and/or a non-moving state), the display is configured to decrease the amount of light output over time (e.g., to a minimum (e.g., non-zero) amount of light) (e.g., based on an amount of deceleration (e.g., the amount of light decreases at a rate that corresponds to the amount of deceleration)). In some embodiments, (e.g., before, after, and/or while the display is configured to display the representation of the object) in accordance with a determination (e.g., the determination is made by the mobile system, a computer system that is in communication with the mobile system, and/or a computer system external to the mobile system) that the mobile system is decelerating but not stopping, the display is configured to not decrease the amount of light output over time (e.g., remain at the maximum amount of light). Increasing the amount of light over time when the mobile system is acceleration allows the mobile system to indicate to subjects external to the interior of the mobile system of the state of the mobile system, thereby providing improved visual feedback and improving the safety of the operation of the mobile system.

In some embodiments, (e.g., before, after, and/or while the display is configured to display the representation of the object) in accordance with a determination (e.g., the determination is made by the mobile system, a computer system that is in communication with the mobile system, and/or a computer system external to the mobile system) that the object is a first type of object (e.g., an inanimate object (a building, a tree, a traffic symbol, a traffic light) or an animate object (e.g., an individual or an animal)) (and/or the object is a first subject), the display (e.g., 1000a and/or 1000b) is configured to display the representation (e.g., 1032 and/or 1034) as a first type of representation (and/or with a first visual appearance) (e.g., a textual representation, a graphical representation, a particular appearance, size, shape, and/or color). In some embodiments, the first type of representation and/or the first visual appearance is different from an appearance of the object. In some embodiments, (e.g., before, after, and/or while the display is configured to display the representation of the object) in accordance with a determination (e.g., the determination is made by the mobile system, a computer system that is in communication with the mobile system, and/or a computer system external to the mobile system) that the object is a second type of object (e.g., an inanimate object (e.g., a building, a tree, a traffic symbol, a traffic light) or an animate object (e.g., an individual or an animal)) different from the first type of object (e.g., different species, different size, different color and/or different size) (and/or that the object is a second subject different from the first subject), the display is configured to display the representation as a second type of representation different (e.g., different size, different color, different shape and/or different appearance) from the first type of representation (e.g. as described above in relation to FIGS. 10E and 10F) (and/or with a second visual appearance different from the first visual appearance). In some embodiments, the second type of representation and/or the second visual appearance is different from an appearance of the object).

Note that details of the exemplary mobile system described above are also applicable in an analogous manner to other exemplary mobile systems described herein. For brevity, these details are not repeated below.

The following is a description of an exemplary mobile system. The following exemplary mobile system is configured to concurrently display different types of indications. Some of the features of the exemplary mobile system that are described below are optionally combined, modified, and/or omitted.

As described below, the exemplary mobile system provides an intuitive way for concurrently displaying different types of indications. The below described features increases the safety of the operation of the mobile system. For battery-operated mobile systems, displaying different types of indications in a faster and more efficiently conserves power and increases the time between battery charges.

In some embodiments, a mobile system comprises an exterior surface (e.g., 18) at least partially surrounding an interior (e.g., 11), a display (e.g., 1000a and/or 1000b) (e.g., a single display, a single display component, a single illumination source, a headlight, and/or a single headlight) positioned on the exterior surface (e.g., 18), one or more processors, and memory storing one or more programs configured to be executed by the one or more processors, the one or more programs including instructions for concurrently displaying, via the display (e.g., 1000a and/or 1000b) an indication of a state (e.g., an internal and/or movement state) of the mobile system (e.g., 1018a, 1018b, 1012a, and/or 1012b) (e.g., 10) (e.g., speed, acceleration, deacceleration, an indication of the detected temperature, noise level, brightness level and/or number of occupants of the mobile system) and an indication of a state (e.g., an external and/or ambient state) of an environment (e.g., 1032 and/or 1034) external to the mobile system (e.g., 10) (e.g., objects (e.g., animate and/or inanimate objects) that are detected in the environment, temperature of the environment, traffic signs detected in the environment). In some embodiments, the display of the indication of the state of the environment overlaps with the display of the state of the environment external to the mobile system. In some embodiments, the display of the indication of the state of the environment does not overlap with the display of the state of the environment external to the mobile system. In some embodiments, the display of the indication of the state of the environment occupies a first percentage of the display and the display of the indication of the mobile system occupies a second percentage of the display that is different (e.g., smaller and/or larger) than the first percentage. In some embodiments, the display ceases to display the indication of the state of the environment and the state of the mobile system in accordance with a determination that the mobile system transitions from a moving state to a non-moving state or vice versa. In some embodiments, the mobile system includes a movement (e.g., wheels, tires, pulleys, skis, and/or axels), wherein the mobile system is configured to traverse (e.g., traverse a surface (e.g., a ground, a road, a path, and/or a street) and/or through a medium, such as the air) an environment (e.g., a physical environment and/or the physical world) via the movement system. Concurrently displaying an indication of the state of the mobile system and the state of the environment external to the mobile system allows the mobile system to concurrently communicate to subjects which objects present in the environment that the mobile system detects and the state of the mobile system, thereby providing improved visual feedback and increasing the safety of the operation of the mobile system (e.g., by alerting subjects how and/or if the mobile system will move).

In some embodiments the indication of the state of the environment (e.g., 1032 and/or 1034) is displayed while the mobile system (e.g., 10) is in a first state (e.g., the mobile system is not moving, the mobile system will not be moving within a predetermined amount of time (e.g., 1-60 seconds), the mobile system is decelerating, the mobile system is moving, and/or the mobile system is accelerating). In some embodiments, the one or more programs further includes instructions for after displaying the indication of the state of the environment external to the mobile system and in accordance with a determination that the mobile system is in the first state, displaying the indication of the state of the environment external (e.g., as described above in relation to FIG. 10E). In some embodiments, the one or more programs further include instructions for after displaying the indication of the state of the environment external to the mobile system and in accordance with a determination that the mobile system is in a second state (e.g., the mobile system is not moving, the mobile system will not be moving within a predetermined amount of time (e.g., 1-60 seconds), the mobile system is decelerating, the mobile system is moving, and/or the mobile system is accelerating) that is different from the first state, forgoing displaying the indication of the state of the environment external to the mobile system (e.g., as described above in relation to FIG. 10E. In some embodiment, in accordance with a determination that the mobile system transitions from a moving state to a non-moving state, the indication of the state of the environment ceases to be displayed. In some embodiments, ceasing the display of the indication of the state of the environment external to the mobile system includes displaying an animation (e.g., a fading out animation, a rotation animation, and/or an animation of the of the indication translating to a side of the display). Displaying the indication of the state of the environment external to the mobile system when a set of prescribed conditions are satisfied allows the mobile system to automatically indicate to subjects which objects in the environment that the mobile system detects and which objects in the environment that the mobile system does not detect, thereby performing an operating when a set of conditions has been met without requiring further user input.

In some embodiments, the one or more programs further include instructions for: (e.g., before, after or while displaying the indication of the state of the mobile system and/or the indication of the state of the environment external to the mobile system) detecting (e.g., via one or more sensors that are in communication with the mobile system and/or via one or more cameras that are in communication with the mobile system) a first object (e.g., an inanimate object (e.g., a building, a tree, a traffic symbol, a traffic light) or an animate object (e.g., an individual or an animal)) within the environment (e.g., 13) external to the mobile system (e.g., 10). In some embodiments, the one or more programs further include instructions for in response to detecting the first object within the environment external to the mobile system and in accordance with a determination (e.g., made by the mobile system, made by a computer system within the mobile system, and/or a mobile system that is external to the computer system) that the first object is a first type of object (e.g., a moveable object (e.g., an object capable of moving on its own or) or a non-moveable object (e.g., an object incapable of moving on its own), displaying, via the display (e.g., 1000a and/or 1000b), a first representation (e.g., 1032 and/or 1034) of the first object. In some embodiments, the one or more programs further include instructions for in response to detecting the first object within the environment external to the mobile system and in accordance with a determination that the first object is a second type of object (e.g., a moveable object (e.g., an object capable of moving on its own or) or a non-moveable object (e.g., an object incapable of moving on its own) different from the first type of object, forgoing displaying the first representation of the first object (e.g., as described above in relation to FIG. 10E) (and/or any representation of the first object). In some embodiments, the display displays a respective representation for both the first type of object and the second type of object. Displaying the first representation when a set of prescribed conditions is satisfied allows the mobile system to automatically indicate to subjects the type of object the mobile system detects in the environment, thereby performing an operation when a set of conditions has been met without requiring further user input.

In some embodiments, the one or more programs further include instructions for: (e.g., before, after or while displaying the indication of the state of the mobile system and/or the indication of the state of the environment external to the mobile system) detecting (e.g., via one or more sensors that are in communication with the mobile system and/or via one or more cameras that are in communication with the mobile system) a second object (e.g., an inanimate object (e.g., a building, a tree, a traffic symbol, a traffic light) or an animate object (e.g., an individual or an animal)) within the environment (e.g., 13) external to the mobile system (e.g., 10). In some embodiments, the one or more programs further include instructions for in response to detecting the second object within the environment external to the mobile system and in accordance with a determination (e.g., the determination is made by the mobile system, a computer system that is in communication with the mobile system, and/or a computer system external to the mobile system) that the second object is a third type of object (e.g., an inanimate object (e.g., a building, a tree, a traffic symbol, a traffic light) or an animate object (e.g., an individual or an animal)), displaying, via the display (e.g., 1000a and/or 1000b), a representation (e.g., 1032 and/or 1034) (e.g., a textual representation and/or a graphical representation) of the second object with a first set of visual characteristics. In some embodiments, the one or more programs further include instructions for in response to detecting the second object within the environment external to the mobile system and in accordance with a determination (e.g., the determination is made by the mobile system, a computer system that is in communication with the mobile system, and/or a computer system external to the mobile system) that the object is a fourth type of object (e.g., an inanimate object (e.g., a building, a tree, a traffic symbol, a traffic light) or an animate object (e.g., an individual or an animal)) different from (e.g., different species, different size, different color and/or different size) the third type of object, displaying, via the display the representation of the second object (e.g., 1032 and/or 1034) with a second set of visual characteristics different from the first set of visual characteristics. In some embodiments, the appearance of the representation of the object is based on the appearance of the object. In some embodiments, the display displays the second representation of the object before, after, and/or while the display displays the first representation of the object. Displaying the representation with a respective set of visual characteristics when a set of prescribed conditions is satisfied allows the mobile system to automatically perform a display operation that indicates to subjects the type of object that the mobile system has detected, thereby performing an operation when a set of conditions has been met without requiring further user input.

In some embodiments, the indication of the state of the mobile system (e.g., 1018a, 1018b, 1012a, and/or 1012b) corresponds to (and/or includes in indication of) movement of the mobile system (e.g., the mobile system is presently moving or will be moving within a predetermined amount of time (e.g., 1-60 seconds)). In some embodiments, the indication of the state of the mobile system includes a representation (e.g., a textual representation and/or a graphical representation) (e.g., a static representation or a dynamic representation (e.g., a looping animation) of the movement of the mobile system (e.g., the speed of the mobile system, the acceleration of the mobile system, and/or the direction of movement of the mobile system). In some embodiments, the display ceases to display the indication of the state of the mobile system in accordance with a determination that the mobile system stops moving. In some embodiments, the display displays the indication of the state of the mobile system while the mobile system is moving at a speed that is greater than a speed threshold (e.g., 1-25 mph). Displaying an indication of the state of the mobile system while the mobile system is moving provides subjects with visual feedback regarding the state of one or more detected characteristics (e.g., the speed, acceleration, and/or deacceleration) of the movement of the mobile system at a point in time where the one or more detected characteristics are of heightened interest, thereby providing improved visual feedback and improving the safety of the operation of the mobile system.

In some embodiments, (e.g., in accordance with a determination (e.g., a determination made by the mobile system, a computer system that is in communication with the mobile system and/or a computer system external to the mobile system) that the environment includes an object) the indication of the state of the environment (e.g., 1032 and/or 1034) external to the mobile system (e.g., 10) includes a representation of an object (e.g., 1032 and/or 1034) that is detected (e.g., the object is detected via one or more sensors and/or one or more cameras that are in communication with the mobile system) within the environment. In some embodiments, the display ceases to display the indication of the object within the environment in accordance with a determination that the object is not detected within the environment. Displaying an indication of an object that is within the environment provides subjects with visual feedback with respect to which objects in the environment the mobile system detects and which objects in the environment the mobile system does not detect, thereby providing improved visual feedback and improving the safety of the operation of the mobile system.

In some embodiments, the object is a first type of object (e.g., the object is moveable (e.g., the object is moving towards or away from the mobile system)). In some embodiments, while displaying the representation of the object (e.g., 1032 and/or 1034) that is within the environment and in accordance with a determination (e.g., a determination made by the mobile system, a computer system that is in communication with the mobile system, and/or a computer system that is external to the mobile system) that the object is a first distance (e.g., 1-15 feet) from the display (e.g., 1000a and/or 1000b), the indication of the state of the environment (e.g., 1032 and/or 1034) external to the mobile system (e.g., 10) has a third set of visual characteristics (e.g., as described above in relation to FIG. 10E) (e.g., color, shape, size, brightness, and/or movement characteristics). In some embodiments, while displaying the representation of the object (e.g., 1032 and/or 1034) that is within the environment and in accordance with a determination (e.g., a determination made by the mobile system, a computer system that is in communication with the mobile system, and/or a computer system that is external to the mobile system) that the object is a second distance (e.g., 1-15 feet) from the display, that is different from the first distance, (e.g., the second distance is greater than or less than the first distance), the indication of the state of the environment external to the mobile system has a fourth d set of visual characteristics (e.g., color, shape, size, and/or movement characteristics) that is different than the first set of visual characteristics (e.g., as described above in relation to FIG. 10E) (e.g., different color, different size and/or different shape). In some embodiments, the display does not display a representation of an inanimate object detected in the environment external to the mobile system. In some embodiments, in accordance with a determination that the object is at the first distance from the display, the indication of the state of the environment external to the mobile system ceases to be displayed. Displaying the indication with a respective set of visual characteristics based on the distance between the display and the object allows the mobile system to automatically perform a display operation that indicates the distance between the mobile system and the object, thereby performing an operation when a set of conditions has been met without requiring further user input.

In some embodiments, the indication of the state of the environment (e.g., 1032 and/or 1034) external to the mobile system (e.g., 10) does not include a representation (e.g., a textual and/or graphical representation) of one or more objects of a second type (e.g., non-movable objects (e.g., buildings, sport balls, traffic signs, and/or rocks)) that are detected (e.g., detected by the mobile system, detected by a computer system that is in communication with the mobile system, and/or detected by a computer system that is external to the mobile system) in the environment (e.g., 13). In some embodiments, the indication of the state of the environment external to the mobile system does include indications of inanimate objects that are detected in the environment.

In some embodiments, the display (e.g., 1000a and/or 1000b) is positioned on the exterior surface (e.g., 18) such that the display is directed away from the interior (e.g., 11).

In some embodiments, the indication of the state of the environment (e.g., 1032 and/or 1034) external to the mobile system (e.g., 10) is displayed on a first portion (e.g., 1010a and/or 1010b) (e.g., a majority of the display or less than a majority of the display) of the display (e.g., 1000a and/or 1000b). In some embodiments, the indication of the state of the mobile system (e.g., 1018a, 1018b, 1012a, and/or 1012b) is displayed on a second portion (e.g., 1020a and/or 1020b), different from the first portion (e.g., a majority of the display or less than a majority of the display), of the display. In some embodiments, the first portion of the display and the second portion of the display overlap. In some embodiments, the first portion of the display and the second portion of the display do not overlap. In some embodiments, the first portion of the display and the second portion of the display are on opposite sides of the display. In some embodiments, the first portion occupies a larger percentage of the display than the second portion. In some embodiments, the first portion occupies half of the display. In some embodiments, the first portion of the display and the second portion of the display are different and/or distinct. Concurrently displaying the indication of the state of the environment external to the mobile system on a first portion of the display and displaying the indication of the state of the mobile system on a second portion of the display concurrently provides subjects with visual feedback regarding the state of one or more (e.g., detected by the mobile system) characteristics of the environment and the state of one or more (e.g., detected by the mobile system) characteristics of the state of the mobile system, thereby providing improved visual feedback and increasing the safety of the operation of the mobile system.

In some embodiments, the one or more programs further include instructions for: before displaying the indication of the state of the environment (e.g., 1032 and/or 1034) external to the mobile system (e.g., 10), displaying the indication of the state of the mobile system (e.g., 1018a, 1018b, 1012a, and/or 1012b) on the first portion of the display (e.g., 1010a and/or 1010b) and the second portion (e.g., 1020a and/or 1020b) of the display. In some embodiments, the first portion of the display and the second portion of the display accounts for the entirety of the display. In some embodiments, the first portion of the display and the second portion of the display are less than the entirety of the display. In some embodiments, while displaying the indication of the state of the environment external to the mobile system, the mobile system displays the indication of the state of the environment external to the mobile system on the first portion of the display and the indication of the state of the mobile system on the second portion of the display. Displaying the indication of the state of the mobile system on the first portion of the display and the second portion of the display provides subjects with visual feedback with respect to the state of one or more detected characteristics of the mobile system, thereby providing improved visual feedback and increasing the safety of the operation of the mobile system.

In some embodiments, the one or more programs further include instructions for: (e.g., while displaying the indication of the state of the mobile system on the first portion of the display and the second portion of the display) forgoing displaying the indication of the state of the environment (e.g., 1032 and/or 1034) external to the mobile (e.g., 10) on the second portion (e.g., 1020a and/or 1020b) of the display (e.g., 1000a and/or 1000b). In some embodiments, the second portion of the display does not include the indication of the state of the environment.

In some embodiments, the indication of the state of the mobile system (e.g., 1018a, 1018b, 1012a, and/or 1012b) is a static indication (e.g., the display does not animate the indication of the state of the mobile system and/or the display does not display the indication of the state of the mobile system as moving). In some embodiments, the indication of the state of the environment (e.g., 1032 and/or 1034) external to the mobile system is a dynamic (e.g., non-static) indication (e.g., the display animates the indication of the environment external to the mobile and/or the display displays the indication of the environment external to the mobile system as moving). Displaying the indication of the state of the environment external to the mobile system as a dynamic indication provides real-time visual feedback to subjects regarding real time detected changes to the state of the environment, thereby providing improved visual feedback and increasing the safety of the operation of the mobile system.

In some embodiments, an appearance of the indication of the state of the environment (e.g., 1032 and/or 1034) external to the mobile system (e.g., 10) includes at least one color included in the indication of the state of the mobile system (e.g., 1018a, 1018b, 1012a, and/or 1012b) (e.g., the color corresponds to the temperature, brightness, and/or noise of environment within the mobile system). In some embodiments, the color is dynamic and changes based on changes to the state of the mobile system. Displaying the indication of the state of the environment external to the mobile system with at least one color that corresponds to the state of the mobile system provides subjects with visual feedback regarding the present state of one or more detected characteristics (e.g., temperature, speed, acceleration state, deacceleration state, noise, and/or brightness) of the mobile system, thereby providing improved visual feedback and increasing the safety of the operation of the mobile system.

In some embodiments, the mobile system further comprises a set of one or more illumination sources (e.g., 1020a and/or 1020b) that, at least, partially surrounds the display (e.g., 1000a and/or 1000b). In some embodiments, the one or more programs further include instructions for: (e.g., while displaying the indication of the state of the mobile system and the indication of the state of the environment external to the mobile system) in accordance with a determination that the mobile system (e.g., 10) is performing a first operation (e.g., signaling that the direction of the mobile system will change (the mobile system will turn left the mobile system will turn right, and/or that the mobile system has detected a hazard), illuminating a first portion ((e.g. less than all, a majority, or a minority) of the set of one or more illumination sources (e.g. illuminate in a steady state and/or illuminate in a pattern) without illuminating a second portion of the set of one or more illumination sources (e.g., as described above in relation to FIGS. 10C and 10F) and in accordance with a determination that the mobile system is performing a second operation different from the first operation (e.g., signaling that the direction of the mobile system will change (the mobile system will turn left and/or the mobile system will turn right, signaling a status of the mobile system, signaling a status of users within the mobile system), illuminating the second portion of the set of one or more illumination sources without illuminating the first portion of the set of one or more illumination sources (e.g., as described above in relation to FIGS. 10C and 10F). Illuminating a respective portion of the set of one or more illumination sources based on what operation the mobile system is performing allows the mobile system to automatically indicate to subjects the present state of the mobile system, thereby performing an operation when a set of conditions has been met without requiring further user input and increasing the safety of the operation of the mobile system.

Note that details of the exemplary mobile system described above are also applicable in an analogous manner to other exemplary mobile systems described herein. For brevity, these details are not repeated below.

The following is a description of an exemplary mobile system. The following exemplary mobile system is configured to indicate the movement of the mobile system. Some of the features of the exemplary mobile system that are described below are optionally combined, modified, and/or omitted.

As described below, the exemplary mobile system provides an intuitive way for indicating the movement of the mobile system. The below described features increases the safety of the operation of the mobile system. For battery-operated mobile systems, indicating the movement of the mobile system in a faster and more efficiently conserves power and increases the time between battery charges.

In some embodiments, a mobile system comprises: an exterior surface (e.g., 18) at least partially surrounding an interior (e.g., 11), a first display (e.g., 1010a and/or 1010b) (e.g., a single display, a single display component, a single illumination source, a headlight, and/or a single headlight) positioned on the exterior surface (e.g., 18), a first illumination source (1020a and/or 1020b) that at least partially surrounds the first display (e.g., 1010a and/or 1010b), one or more processors, and memory storing one or more programs configured to be executed by the one or more processors, the one or more programs including instructions for: while the first display (e.g., 1010a and/or 1010b) and the first illumination source (1020a and/or 1020b) are in an active state (e.g., the first display and the first illumination source are powered on and/or the first display and the first illumination source are displaying a respective user interface object and/or a respective user interface), detecting (e.g., via one or more cameras and/or via one or more sensors that are in communication with the mobile system) movement of an object (e.g., an animate object (e.g., an individual and/or an animal) or an inanimate object (e.g., a building, a traffic sign, a sports ball, a rock and/or a billboard)) in an environment (e.g., 13) that is outside of the mobile system (e.g., 10) and in response to detecting movement of the object in the environment that is outside of the mobile system (e.g., 10) in accordance with a determination (e.g., a determination that is made by the mobile system, a computer system that is in communication with the mobile system, and/or a computer system that is external to the mobile system) that the object is moving in a first direction (e.g., the first object is moving to towards the mobile system, away from the mobile system, to the left of the mobile system and/or to the right of the mobile system relative to the position of the mobile system), updating the first display (e.g., 1010a and/or 1010b) based on the movement of the object (e.g., the brightness, the display of a respective user interface object (e.g., the movement of the respective user interface object, the size of the respective user interface object, the shape of the respective user interface object and/or the color of the respective user interface object), and/or the color of the first display) in the first direction without updating the first illumination source (1020a and/or 1020b) based on the movement of the object (e.g., as described above in relation to FIGS. 10E and 10F) and in accordance with a determination (e.g., a determination that is made by the mobile system, a computer system that is in communication with the mobile system, and/or a computer system that is external to the mobile system) that the object is moving in a second direction that is different from the first direction (e.g., the first direction is in an opposite direction than the second direction or the first direction and the second direction have a similar first directional component and a different second directional component (e.g., first direction is away and to the left of the mobile system and the right direction is away and to the right of the mobile system or the first direction is towards and to the right of the mobile system and the second direction is towards and to the left of the mobile system)), updating the first display (e.g., 1010a and/or 1010b) based on movement of the object (e.g., the brightness, the display of a respective user interface object (e.g., the movement of the respective user interface object, the size of the respective user interface object, the shape of the respective user interface object and/or the color of the respective user interface object), and/or the color of the first display) in the second direction without updating the first illumination source (1020a and/or 1020b) based on the movement of the object (e.g., as described above in relation to FIGS. 10E and 10F). In some embodiments, the mobile system comprises the movement system (e.g., wheels, tires, pulleys, skis, and/or axels), where the mobile system is configured to traverse (e.g., traverse a surface (e.g., a ground, a road, a path, and/or a street) and/or through a medium, such as the air) an environment via the movement system. Updating the first display based on a direction of the detected movement of the object provides subjects with visual feedback with respect to which objects in the environment the mobile system detects as moving and in which direction the mobile system detects the objects as moving, thereby providing improved visual feedback. Updating the first display in a particular manner based on a direction of the detected movement of the object within the environment when a set of prescribed conditions are met automatically allows the mobile system to perform a display operation that alerts subjects to the direction in which the mobile system detects one or more objects as moving, thereby performing an operation when a set of conditions has been met without requiring further user input.

In some embodiments, the one or more programs further include instructions for: while the first display (e.g., 1010a and/or 1010b) and the first illumination source (1020a and/or 1020b) are in the active state, displaying, via the first display, a first set of content (e.g., 1012a and/or 1012b) (e.g., one or more user interface objects, a representation of the state of the mobile system, a representation of one or more objects in the environment, and/or a respective user interface) and displaying, via the first illumination source, a second set of content (e.g., 1018a and/or 1018b) (e.g., one or more user interface objects, a representation of the state of the mobile system, a representation of one or more objects in the environment, and/or a respective user interface). In some embodiments, the first set of content and the second set of content are different. In some embodiments, the first set of content and the second set of content are the same. In some embodiments, an appearance of the first set of content and/or the second set of content are based on one or more detected objects in the environment. Displaying the first set of content and the second set of content when a set of prescribed conditions are met (e.g., the first display and the first illumination source are in the active state) allows the mobile system to automatically perform a display operation that indicates to subjects the state of the mobile system, thereby performing an operation when a set of conditions has been met without requiring further user input and providing improved visual feedback.

In some embodiments, the mobile system (e.g., 10) further comprises a second display (1010a and/or 1010b) (e.g., the second display is the same type of display as the first display or the second display and the first display are different types of displays) positioned on the exterior surface (e.g., 18) and a second illumination source (e.g., 1020a and/or 1020b) (e.g., a single illumination source or an array of illumination sources) that at least partially surrounds the second display. In some embodiments, the second display is different from the first display (e.g., 1010a and/or 1010b). In some embodiments, the second illumination source is different from the first illumination source (1020a and/or 1020b). In some embodiments, the one or more programs further include instructions for: while the second display and the second illumination source are active and in response to detecting (e.g., via one or more sensors and/or one or more cameras that are in communication with the mobile system) movement of the object in the environment, updating the second display based on the detected movement of the object in the environment (e.g., the second display displays a user interface object that mimics the movement of the object in the environment, the second display updates the size of a user interface object that corresponds to the movement of the object (e.g., if the object moves towards the mobile system, the second display increases the size of the user interface object or if the object moves away from the mobile system, the second display decreases the size of the user interface object) the second display changes the color a user interface object based on the speed of the movement of the object) without updating the second illumination source (e.g., as described above in relation to FIGS. 10E and 10F). In some embodiments, the second display and the first display are updated at the same time. In some embodiments, the first display is updated before or after the second display is updated. In some embodiments, the first display and the second display are updated in the same manner. In some embodiments, the first display and the second display are updated in different manners. Updating the second display based on the detected movement of the object in the environment in response to detecting movement of the object in the environment provides subjects with visual feedback with respect to how the mobile system detects object in the environment as the object moves throughout the environment, thereby providing improved visual feedback and improving the safety of the operation of the mobile system.

In some embodiments, the one or more programs further include instructions for: while the first illumination source (1020a and/or 1020b) is active, detecting (e.g., via one or more sensors and/or one or more cameras that are in communication with the mobile system) a hazard condition (e.g., a road condition (e.g., a pothole and/or an object in the road that is in the path of mobile system), one or more weather conditions (e.g., excess raining, excess snow, fire, and/or excess wind), presence of an individual in the path of the mobile system, mechanical malfunction of mobile system, and/or mobile system has reduced power supply) (e.g., detecting a hazard condition in the environment that is outside of the mobile system or detecting a hazard condition that is within an interior of the mobile system). In some embodiments, the one or more programs further include instructions for: in response to detecting the hazard condition, updating the illumination source (e.g., the brightness of the illumination source, the color of the illumination source, and/or the display of the illumination source) (e.g., without updating the first display) based on the detection of the hazard condition (e.g., as described above in relation to FIG. 10D) (e.g., the display, color and/or brightness of the illumination source corresponds to and/or indicates the detected hazard). In some embodiments, the illumination source ceases to be updated in accordance with a determination that the hazard condition is no longer detected. In some embodiments, the illumination source ceases to be updated in accordance with a determination that the hazard condition remains detected. In some embodiments, updating the illumination source includes updating a portion (e.g., less than the entirety) or the entirety of the illumination source of the illumination source is updated. Updating the illumination source in response to detecting the hazard condition allows the mobile system to indicate to users hazards in the environment the mobile system detects, thereby providing improved visual feedback and increasing the safety of the operation of the mobile system.

In some embodiments, the hazard condition is detected while the first display (e.g., 1010a and/or 1010b) is in the active state. In some embodiments, the one or more programs further include instructions for in response to detecting the hazard condition, forgoing updating the first display. In some embodiments, the first display is updated in response to detecting the hazard condition.

In some embodiments, the one or more programs further include instructions for detecting (e.g., via one or more sensors and/or one or more cameras that are in communication with the mobile system) a change in an intended direction of movement of the mobile system (e.g., 10) (e.g., the direction of the movement of the mobile system will change within a predetermined amount of time (e.g., 1-60 seconds) and/or a user of the mobile system performs an input that causes the direction of the movement of the mobile system to change within a predetermined amount of time) (e.g., the mobile system will make a turn (e.g., a left turn or a right turn), the mobile system will transition from moving in a forward direction to moving in a backwards direction, or the mobile system will transition from moving in a backwards direction to moving in a forward direction). In some embodiments, the one or more programs further include instructions for: in response to detecting the change in the intended direction of movement of the mobile system and in accordance with a determination (e.g., made by the mobile system, a computer system that is in communication with the mobile system, and/or a computer system that is external to the mobile system) that the intended direction of movement of the mobile system is in a first direction (e.g., the mobile system intends to turn left, turn right, traverse in a forward direction and/or traversed in a backward direction), concurrently updating the first display (e.g., 1010a and/or 1010b) in a first manner (e.g., the color, brightness, appearance of the display of the first display is changed and the illumination source (e.g., 1020a and/or 1020b) in a second manner (e.g., the first manner and the second manner are the same or different) (e.g., the color, brightness, appearance of the display of the illumination source is changed). In some embodiments, the one or more programs further include instructions for: in response to detecting the change in the intended direction of movement of the mobile system and in accordance with a determination (e.g., made by the mobile system, a computer system that is in communication with the mobile system, and/or a computer system that is external to the mobile system) that the direction of travel of the mobile system changes in a second direction (e.g., the mobile system intends to turn left, turn right, traverse in a forward direction and/or traversed in a backward direction), that is different from the first direction, concurrently updating the first display in a third manner that is different than the first manner and the illumination source in a fourth manner that is different than the second manner. In some embodiments, the first manner and the second manner are the same. In some embodiments, the first manner and the second manner are different. In some embodiments, the third manner and the fourth manner are the same. In some embodiments, the third manner and the fourth manner are different. Updating the first display and the illumination source in a respective manner when a set of prescribed conditions are met automatically allows the mobile system to perform a display operation that indicates the intended movement (e.g., future movement) of the mobile system to subjects, thereby performing an operation when a set of conditions has been met without requiring further user input and increasing the safety of the operation of the mobile system.

In some embodiments, the one or more programs further include instructions for: while the mobile system (e.g., 10) is moving (e.g., the mobile system will be moving within a predetermined time (e.g., 1-60 seconds) or the mobile system has been in a moving state for the predetermined time) (before, after, and/or while detecting the change in the intended direction of movement of the mobile system) detecting (e.g., via one or more sensors and/or one or more cameras that are in communication with the mobile system) a first movement characteristic of the movement of the mobile system (the mobile system is moving in a forward direction, the mobile system is moving in a backward direction, the mobile system transitions from a powered off state to a powered on state, the mobile system transitions from a powered on state to a powered off state, the mobile system is moving at a respective speed, the mobile system is moving at a respective acceleration). In some embodiments, the one or more programs further include instructions for: while the mobile system (e.g., 10) is moving, in response to detecting the first movement characteristic of the mobile system, updating the first display (e.g., 1010a and/or 1010b) (e.g., increasing the brightness, decreasing the brightness, changing the appearance of a user interface object that is displayed on the first display, displaying an animation on the first display, ceasing to display an animation on the first display, and/or ceasing to display a respective user interface object) based on the first movement characteristic without updating the first illumination source (1020a and/or 1020b) (e.g., as discussed above in relation to FIG. 10B). Updating the first display in response to detecting the first movement characteristic of the mobile system provides subjects with visual feedback with respect to how the mobile system is traversing and/or will traverse through the environment, thereby providing improved visual feedback and increasing the safety of the operation of the mobile system.

In some embodiments, the one or more programs further include instructions for:

(before, after, and/or while detecting the change in the intended direction of movement of the mobile system) detecting (e.g., via one or more sensors and/or one or more cameras that are in communication with the mobile system) (e.g., while the mobile system is moving (e.g., the mobile system will be moving within a predetermined time (e.g., 1-60 seconds) or the mobile system has been in a moving state for the predetermined time) a second movement characteristic of the movement of the mobile system (e.g., 10) (the mobile system is moving in a forward direction, the mobile system is moving in a backward direction, the mobile system transitions from a powered off state to a powered on state, the mobile system transitions from a powered on state to a powered off state, the mobile system is moving at a respective speed, the mobile system is moving at a respective acceleration) (e.g., the first movement characteristic and the second movement characteristic are the same or the first movement characteristic and the second movement characteristics are not the same). In some embodiments, the one or more programs further include instructions for: in response to detecting the second movement characteristic of the mobile system, updating the first illumination source (1020a and/or 1020b) (e.g., increasing the brightness, decreasing the brightness, changing the appearance of a user interface object that is displayed on the first illumination source, displaying an animation on the first illumination source, ceasing to display an animation on the first illumination source, and/or ceasing to display a respective user interface object) based on the second movement characteristic without updating the first display (e.g., 1010a and/or 1010b). Updating the first illumination source in response to detecting the second movement characteristic of the mobile system provides visual feedback to subjects with respect to how the mobile system is traversing and/or will traverse through the environment, thereby providing improved visual feedback and increasing the safety of the operation of the mobile system.

Note that details of the exemplary mobile system described above are also applicable in an analogous manner to other exemplary mobile systems described herein. For brevity, these details are not repeated below.

The following is a description of an exemplary mobile system. The following exemplary mobile system is configured to indicate various states of the mobile system. Some of the features of the exemplary mobile system that are described below are optionally combined, modified, and/or omitted.

As described below, the exemplary mobile system provides an intuitive way for indicating various states of the mobile system. The below described features increases the safety of the operation of the mobile system. For battery-operated mobile systems, indicating the various states of the mobile system in a faster and more efficiently conserves power and increases the time between battery charges.

In some embodiments, a mobile system (e.g., 10) comprises an exterior surface (e.g., 18) at least partially surrounding an interior (e.g., 11) (e.g., the exterior surface surrounds the entirety of the interior or less than the entirety of the interior) a display (e.g., 1000a and/or 1000b) (e.g., a single display, a single display component, a single illumination source, a headlight, and/or a single headlight) positioned on the exterior surface (e.g., 18) one or more processors and memory storing one or more programs configured to be executed by the one or more processors, the one or more programs including instructions for: concurrently displaying, via the display (e.g., 1000a and/or 1000b) an indication (e.g., a graphical indication and/or a textual indication) of an autonomous state of the mobile system (e.g., 1012a and/or 1012b) (e.g., a volume level of speakers that are integrated into the mobile system, the brightness level of lights that are integrated into the mobile system, a temperature of the mobile system, and/or a speed of the mobile system) and an indication (e.g., a graphical indication and/or a textual indication) of a movement intention (e.g., 1018a and/or 1018b) of the mobile system (e.g., 10) that is different from the indication of the autonomous state of the mobile system (e.g., 1012a and/or 1012b) (e.g., the mobile system will accelerate within a predetermined amount of time, the mobile system will deaccelerate within a predetermined amount of time, the mobile system will remain in motion, the mobile system will remain static). In some embodiments, the indication of the state of the mobile does not overlap with the indication of the movement intention of the mobile system. In some embodiments, the indication of the state of the mobile does overlap with the indication of the movement intention of the mobile system. Concurrently displaying an indication of the autonomous state of the mobile system and a movement intention of the mobile system provides subjects with visual feedback with respect to how the mobile system is being controlled and how the mobile system is presently moving and/or will move, thereby providing improved visual feedback and improving the safety of the operation of the mobile system.

In some embodiments, the indication of the autonomous state of the mobile system (e.g., 1012a and/or 1012b) and the indication of the movement intention of the mobile system (e.g., 1018a and/or 1018b) are concurrently displayed in accordance with a determination that the mobile system (e.g., 10) is operating autonomously (e.g., the mobile system senses the environment that the mobile system is within and operates without user involvement, the mobile system navigates to a destination without user involvement, the mobile system is navigating autonomously and/or the mobile system navigates without user input)) and that the mobile system is in a first movement state (e.g., the mobile system is moving or the mobile system will initiate movement within a threshold amount of time (e.g., 0.1-60 seconds)). Concurrently displaying the indication of the autonomous state of the mobile and system and the indication of the movement intention of the mobile system when a set of prescribed conditions are met allows the mobile system to automatically perform a display operation that alerts subjects to how the mobile system is being controlled and the present and/or future movements of the mobile system, thereby performing an operation when a set of conditions has been met without requiring further user input.

In some embodiments, the one or more programs further include instructions for, in accordance with a determination that the mobile system (e.g., 10) is operating autonomously (e.g., the mobile system senses the environment that the mobile system is within and operates without user involvement, the mobile system navigates to a destination without user involvement, the mobile system is navigating autonomously and/or the mobile system navigates without user input) and that the mobile system is in a second movement state (e.g., the mobile system is not moving or the mobile system will cease moving within a threshold amount of time (e.g., 0.1-60 seconds)), ceasing the display of the indication of the movement intention of the mobile system (e.g., 1018a, and/or 1018b) and continuing to display the indication of the autonomous state of the mobile system (e.g., 1012a and/or 1012b). In some embodiments, the indication of the movement intention of the mobile system is redisplayed in accordance with a determination that the mobile system is operating autonomously, and that the mobile system will transition from a non-moving state to a moving state within a predetermined amount of time. Ceasing display of the indication of the movement intention of the mobile system when a set of prescribed conditions are met allows the mobile system to automatically cease the performance of a display operation to indicate to subjects that the mobile system is in the second movement state (e.g., or will shortly enter the second movement state), thereby performing an operation when a set of conditions has been meet without requiring further user input.

In some embodiments, the one or more programs further include instructions for: after displaying the of indication of the autonomous state of the mobile system (e.g., 10) and the indication of the movement intention of the mobile system (e.g., while the indication of the autonomous state of the mobile system and the indication of the movement intention of the mobile system are not displayed) and in accordance with a determination that the mobile system is operating non-autonomously (e.g., navigation of the mobile system is controlled by a user, the mobile system responds in real time to a user redirecting the navigation of mobile system via a mechanical apparatus (e.g., a steering wheel), and/or the direction of one or more wheels of the mobile system are controlled by the user) and that the mobile system is in a third state (e.g., the mobile system is powered off, a battery of the mobile system does not supply power and/or a power control of the mobile system is active), or any combination thereof, forgoing displaying the indication of the movement intention of the mobile system and forgoing displaying the indication of the autonomous state of the mobile system. In some embodiments, the mobile system ceases to display the indication of the movement of the mobile system and the indication of the autonomous state of the mobile system in response to the mobile system transitioning from an active state to an idle state. In some embodiments, the mobile system ceases to display the indication of the movement of the mobile system and the indication of the autonomous state of the mobile system in response to the mobile system transitioning between drive settings (e.g., a reverse drive setting and/or a forward drive setting).

In some embodiments, the mobile system further comprises a second display (e.g., 1000a and/or 1000b) different from the first display (e.g., 1000a and/or 1000b) (e.g., the second display is different type of display or is the same type of display as the first type of display). In some embodiments, the one or more programs further include instructions for: (e.g., before, after, and/or while the indication of the autonomous state of the mobile system and/or the indication of the movement intention of the mobile system are displayed) synchronizing content output at a first portion of the first display with content output at a second portion of the second display (e.g., the first portion and the second portion are the same size, shape, and/or located on the same area of their respective display) (e.g., both the first portion of the first display and the second portion of the second display the same content, same color, same amount of light, same brightness and/or same animation). In some embodiments, the first portion of the first display and the second portion of the second display are the same size. In some embodiments, the first portion of the first display and the second portion of the second display are positioned on the same area of the respective display. In some embodiments, the second portion corresponds to the first portion. Synchronizing content output at a first portion of the first display with content output at a second portion of the second display provides improved visual feedback by increasing the visibility of the content such that the content is displayed over a wide angular range, thereby providing improved visual feedback and increasing the safety of the operation of the mobile system (e.g., by making the content visible to more subjects).

In some embodiments, a third portion of the first display (e.g., 1000a and/or 1000b)) is not synchronized with a corresponding fourth portion of the second display (1000a and/or 1000b) (e.g., the third portion and the fourth portion are the same size, shape, and/or located on the same area of their respective display). In some embodiments, the third portion of the first display and the fourth portion of the second display independently display representations of objects (e.g., the first display displays representations of objects within a first area, and the second display displays representations of objects within a second area different from the first area). Having a third portion of the display that is not synchronized with a corresponding fourth portion of the second display provides feedback by increasing the flexibility in the amount of content and/or the type of content that the mobile system can display at any point in time, thereby providing improved visual feedback and increasing the safety of the operation of the mobile system (e.g., via allowing the mobile system to display different types of content at the same time).

In some embodiments, the exterior surface (e.g., 18) includes a first terminal end (e.g., the front of the exterior surface, the back of the exterior surface, or a side of the exterior surface) and a second terminal end (e.g., the front of the exterior surface, the back of the exterior surface, or a side of the exterior surface) different from the first terminal end. In some embodiments, the first terminal end is disposed on a first position of a longitudinal axis (e.g., 22) of the mobile system (e.g., 10) (e.g., an axis that spans along the length of the mobile system). In some embodiments, the second terminal end is disposed on a second position of the longitudinal axis of the mobile system. In some embodiments, the first position and the second position are on opposite sides of a transverse axis (e.g., 20) of the mobile system, (e.g., an axis that spans along the width of the mobile system), In some embodiments, the distance between the first display and the first terminal end is less than the distance between the first display and the second display. In some embodiments, the distance between the second display and the second terminal end is less than the distance between the second display and the first display.

Note that details of the exemplary mobile system described above are also applicable in an analogous manner to other exemplary mobile systems described herein. For brevity, these details are not repeated below.

The following is a description of an exemplary mobile system. The following exemplary mobile system is configured to adjust the elevation of the mobile system. Some of the features of the exemplary mobile system that are described below are optionally combined, modified, and/or omitted.

As described below, the exemplary mobile system provides an intuitive way for adjusting the elevation of the mobile system. The below described features increases the safety of the operation of the mobile system. For battery-operated mobile systems, adjusting the elevation of the mobile system in a faster and more efficiently conserves power and increases the time between battery charges.

In some embodiments, a mobile system (e.g., 10) comprises an exterior surface (e.g., 18) surrounding an interior (e.g., 11) (e.g., the exterior surface surrounds the entirety of the interior or less than the entirety of the interior) a suspension system (e.g., an independent suspension system, a dependent suspension system, air suspension, a spring suspension system, a hydraulic suspension system and/or an electromagnetic suspension system) one or more processors and memory storing one or more programs configured to be executed by the one or more processors, the one or more programs including instructions for: detecting an intent to change a motion state of the mobile system (e.g., 10) (e.g., the mobile system is deaccelerating, the mobile system is accelerating, the mobile system will transition from a non-moving state to a moving state within a predetermined amount of time (e.g., 0-60 seconds) the mobile system will transition from a moving state to a non-moving state within a predetermined amount of time (e.g., 0-60 seconds) and in response to detecting the intent to change the motion state of the mobile system (e.g., 10) and in accordance with a determination that the intent to change the motion state of the mobile system (e.g., 10) corresponds to a transition from a non-moving state (e.g., the mobile system is not translating in a forward, backwards and/or sideways manner) to a moving state (e.g., the mobile system will begin to move forward, backwards, and/or to the side), elevating (e.g., raise, lift and/or heighten) (e.g., 1-24 inches), via the suspension system, the mobile system (e.g., the entire mobile system is raised or a portion of the mobile system is raised) (e.g., as described above in relation to FIG. 10B) and in accordance with a determination that the intent to change the motion state of the mobile system (e.g., 10) corresponds to a transition from the moving state to the non-moving state (e.g., the mobile system is deaccelerating, the mobile system is deaccelerating at a rate that is greater than a threshold, the mobile system will deaccelerate within a predetermined amount of time (e.g., 1-60 seconds), lowering (e.g., 1-24 inches), via the suspension system, the mobile system (e.g., as described above in relation to FIG. 10B) (e.g., the entire mobile system is lowered or a portion of the mobile system is lowered). In some embodiments, portions of the mobile system move while the mobile system is in the non-moving state. In some embodiments, no portion of the mobile system moves while the mobile system is in the non-moving state. Changing the elevation of the mobile system when a set of prescribed conditions are met (e.g., whether the mobile system has come to a stop or has resumed moving) allows the mobile system to automatically perform an operation that alerts subjects to whether the mobile system is currently in a moving state or a non-moving state and the prior motion state of the mobile system, thereby performing an operation when a set of conditions has been meet without requiring further user input.

In some embodiments, detecting the intent to change the motion state of the mobile system (e.g., 10) does not include detecting user input (e.g., as described above at FIG. 10A) (e.g., a user input directed to a control that, when selected, causes the mobile system to be lowered or elevated). In some embodiments, detecting the intent to change the motion state of the mobile system includes detecting user input.

In some embodiments, the one or more programs further include instructions for, while the mobile system (e.g., 10) is elevated (e.g., and after the mobile system is elevated to an elevated level), in accordance with a determination that a first set of one or more criteria is satisfied (e.g., the mobile system is in a moving state, the mobile system has not transitioned from a moving state to a nonmoving state, the speed of the mobile system is greater or less than a speed threshold, the mobile system is transitioning from a moving state to a nonmoving state, and/or the mobile system is transitioning from a nonmoving state to a moving state), maintaining the elevation (e.g., the elevated level) of the mobile system (e.g., as described above in relation to FIG. 10B). In some embodiments, in accordance with a determination that the set of one or more criteria is not satisfied, lowering, via the suspension system, the mobile system. Maintaining the elevation of the mobile system when a set of prescribed conditions are met allows the mobile system to automatically alert subjects to the current and/or future intended motion state of the mobile system, thereby performing an operation wen a set of conditions has been met without requiring further user input.

In some embodiments, the intent to change the motion state of the mobile system (e.g., 10) is detected while the mobile system is elevated (e.g., an elevation that is higher than an elevation of the mobile system while the mobile system is not in motion, beginning to move and/or coming to a stop). In some embodiments, the intent to change the motion state corresponds to a transition from the moving state to the non-moving state (e.g., as described above in relation to FIG. 10B). Lowering the mobile system from an elevated position when prescribed conditions are met (e.g., the mobile system has or will transition from the moving state to the non-moving state) allows the mobile system to automatically adjust its height to alert subjects that the mobile system is coming to a stop and/or is stopped, thereby performing an operation when a set of conditions has been met without requiring further user input and increasing the safety of the operation of the mobile system (e.g., via providing subjects with an indication of the movement intention of the mobile system).

In some embodiments, the one or more programs further include instructions for, while the mobile system (e.g., 10) is lowered (e.g., and after the mobile system is lowered to a lowered level), in accordance with a determination that a second set of one or more criteria is satisfied (e.g., the mobile system is in a moving state, the mobile system has not transitioned from a moving state to a nonmoving state, the speed of the mobile system is greater or less than a speed threshold, the mobile system is transitioning from a moving state to a nonmoving state, and/or the mobile system is transitioning from a nonmoving state to a moving state), maintaining the elevation (e.g., the lowered level) of the mobile system. Maintaining the elevation of the mobile system in the lowered position when a set of prescribed conditions are met (e.g., there is not an intention to change the motion state of the mobile system) allows the mobile system to automatically indicate to subjects that there is no intention for the mobile system to move, thereby performing an operation when a set of conditions has been met without requiring further user input and increasing the safety of the operation of the mobile system (e.g., via providing subjects with an indication of the movement intention of the mobile system).

In some embodiments, the intent to change the motion state of the mobile system (e.g., 10) is detected while the mobile system is lowered (e.g., an elevation that is lower than an elevation of the mobile system while the mobile system is in motion, beginning to move and/or coming to a stop). In some embodiments, the intent to change the motion state corresponds to a transition from the non-moving state to the moving state (e.g., as described above in relation to FIG. 10B). Elevating the mobile system when a set of prescribed conditions are met (e.g., the mobile system has or will transition from the non-moving state to the moving state) allows the mobile system to alert subjects that the mobile system will begin moving, thereby performing an operation when a set of conditions has been met without requiring further user input and increasing the safety of the operation of the mobile system (e.g., via providing subjects with an indication of the movement intention of the mobile system).

In some embodiments, the mobile system further comprises a set of one or more displays (e.g., 1000a and/or 1000b) (e.g., headlights, touch sensitive display, display screen, taillights, and/or a series of illumination sources). In some embodiments, the one or more programs further include instructions for: in response to detecting the intent to change the motion state of the mobile system (e.g., 10), changing an operation state of the set of one or more displays (e.g., as described above in relation to FIG. 10B) (e.g., activating the set of one of one or more displays, deactivating the set of one or more displays, activating a portion of the set of one or more displays, deactivating a portion of the set of one or more devices, displaying an animation, pulsing the set of one or more displays). In some embodiments, the mobile system is elevated or lowered at the same time that the operation state of the one or more displays is changed. In some embodiments, the mobile system is elevated or lowered before or after the operation state of the one or more displays is changed. In some embodiments, the operation state of the set of one or more displays is temporarily changed. Changing the operation state of the set of one or more displays in response to detecting the intent to change the motion state of the mobile system provides subjects with visual feedback that the motion state of the mobile system will change (e.g., the mobile system will begin moving or the mobile system will stop moving), thereby providing improved visual feedback and increasing the safety of the operation of the mobile system (e.g., via providing subjects with an indication of the movement intention of the mobile system).

In some embodiments, the mobile system (e.g., 10) further comprises a set of one or more illumination sources (e.g., 1020a and/or 1020b) (e.g., a single illumination source or an array of illumination sources), In some embodiments, the one or more programs further include instructions for, in response to detecting the intent to change the motion state of the mobile system, maintaining an operation state of the set of one or more illumination sources. In some embodiments, the set of one or more illumination sources at least partially surrounds a display of the mobile system. In some embodiments, the operation state of the set of one or more illumination sources is changed in response to detecting the intent to change the motion state of the mobile system. Maintaining the operation state of the set of one or more illumination sources (e.g., maintaining an amount of light output by the set of one or more illumination sources) allows illumination by the set of one or more illumination sources to stay consistent even when elevation of the mobile system changes, allowing a subject in the interior of the mobile system to see outside of the mobile system when dark and allowing subjects external to the mobile system to better see the mobile system, thereby providing improved visual feedback and increasing the safety of the operation of the mobile system.

In some embodiments, the mobile system (e.g., 10) further comprises a first set of one or more audio output devices (e.g., speakers, smart speakers, subwoofer speakers, horn, alarm and/or tweeter speaker). In some embodiments, the one or more programs further include instructions for, while changing the elevation of the mobile system (e.g., elevating the mobile system or lowering the mobile system), outputting, via the first set of one or more audio output devices, a first audio output (e.g., as described above in relation to FIG. 10B) (e.g., a onetime discrete tone, a repeating tone, a media item, and/or an alert). In some embodiments, the first set of one or more audio output devices output the audio output while the elevation of the mobile system changes. In some embodiments, the first set of one or more audio of one or more audio output devices output the audio output before and/or after the elevation of the mobile system changes. Outputting a first audio output while the elevation of the mobile system is changed allows the mobile system to automatically provide an audible alert to subjects that the elevation of the mobile system is changing and/or that the movement state of the mobile system is changing or will change, thereby providing improved feedback and increasing the safety of the operation of the mobile system (e.g., via providing subjects with an indication of the movement intention of the mobile system).

In some embodiments, the mobile system (e.g., 10) further comprises a second set of one or more audio output devices (e.g., speakers, smart speakers, subwoofer speakers, horn, alarm and/or tweeter speaker). In some embodiments, the one or more programs further include instructions for: while changing the elevation of the mobile system (e.g., elevating the mobile system or lowering the mobile system), outputting, via the second set of one or more audio output devices, a second audio output (e.g., a onetime discrete tone, a repeating tone, a media item, and/or an alert). In some embodiments, the one or more programs further include instructions for: while changing the elevation of the mobile system, in accordance with a determination that the elevation of the mobile system changes has first value, the second audio output has a first set of audio characteristics (e.g., pitch, volume level, amount of treble, amount of bass, and/or a set of speakers responsible for outputting the second audio output) (e.g., as described above in relation to FIG. 10B). In some embodiments, in accordance with a determination that the elevation of the mobile system has a second value different from the first value, the second audio output has a second set of audio characteristics (e.g., pitch, volume level, amount of treble, amount of bass, and/or a set of speakers responsible for outputting the second audio output) different from the first set of audio characteristics (e.g., as described above in relation to FIG. 10B). In some embodiments, the third and/or fourth value are different from the first value and/or the second value. In some embodiments, the second audio output ceases to be output when the elevation of the mobile system ceases to change. In some embodiments, the second audio output continues to be output after the elevation of the mobile system ceases to change. Outputting the second audio output with respective set of audio characteristics when a set of prescribed conditions are met (e.g., based on the elevation of the mobile system) as the elevation of the mobile system changes allows the mobile system to automatically alert subjects to how close the mobile system is to initiating movement or coming to a stop, thereby performing an operation when a set of conditions has been meet without requiring further user input and increasing the safety of the operation of the mobile system.

In some embodiments, the mobile system (e.g., 10) further comprises a first portion (e.g., a front portion, a rear portion and/or a side portion) and a second portion (e.g., a front portion, a rear portion and/or a side portion). In some embodiments, the first portion is disposed at a first terminal end (e.g., portion mobile system that corresponds to 13) of a longitudinal axis (e.g., 22) of the mobile system and the second portion (e.g., portion mobile system that corresponds to 14) is disposed at a second terminal end of the longitudinal axis of the mobile system different from the first terminal end. In some embodiments, lowering the mobile system includes decreasing the elevation of the first portion of the mobile system (e.g., via a suspension system of the mobile system) without deceasing the elevation of the second portion of the mobile system. In some embodiments, lowering the mobile system includes decreasing the elevation of the first portion of the mobile system and the second portion of the mobile system. In some embodiments, lowering the mobile system includes decreasing the elevation of the first portion of the mobile system and increasing the elevation of the second portion of the mobile system. In some embodiments, lowering the mobile system includes decreasing the elevation of the first portion of the mobile system and maintaining the elevation of the second portion of the mobile system. Decreasing the elevation of the first portion of the mobile system without decreasing the elevation of the second portion of the mobile system provides assistance to subjects within the mobile system with exiting and entering the mobile system, thereby increasing the safety of the operation of the mobile system.

In some embodiments, the mobile system (e.g., 10) further comprises a second set of one or more displays (e.g., 1010a and/or 1010b) (e.g., headlights, display screen, touch sensitive display, taillights, and/or a series of illumination sources) and a third set of one or more displays (e.g., 1010a and/or 1010b) (e.g., headlights, display screen, touch sensitive display, taillights, and/or a series of illumination sources). In some embodiments, the second set of one or more displays is disposed on the first portion of the mobile system (e.g., portion mobile system that corresponds to 13) and not the second portion of the mobile system (e.g., portion mobile system that corresponds to 14). In some embodiments, the third set of one or more displays is disposed on the second portion of the mobile system and not the first portion of the mobile system. In some embodiments, the first set of one or more displays is disposed on the first portion and the second portion of the mobile system. In some embodiments, the second set of one or more displays is disposed on the first portion and the second portion of the mobile system. Disposing displays on different portions of the mobile system allows the mobile system to communicate information to different areas around the mobile system using different sets of lights, thereby providing improved visual feedback and increasing the safety of the operation of the mobile system.

In some embodiments, the mobile system (e.g., 10) further comprises a second set of illumination sources (e.g., 1020a and/or 1020b) (e.g., a single illumination source or an array of illumination sources) that is disposed around (e.g., around the periphery of) at least a portion of the second set of one or more displays (e.g., 1010a and/or 1010b) and not the third set of one or more displays. In some embodiments, the second set of illumination sources is disposed around at least a portion of the second set of one or more displays and the third set of one or more displays. In some embodiments, the second set of illumination sources is disposed around the entirety of the second set of illumination sources and/or the third set of one or more illumination sources. The second set of illumination sources being disposed around at least a portion of the second set of one or more displays and not the third set of one or more displays allows the mobile system to output more and/or different types of content in certain portions of the mobile system and not others, thereby providing improved visual feedback and increasing the safety of the operation of the mobile system.

In some embodiments, the mobile system (e.g., 10) further comprises a third portion (e.g., portion mobile system that corresponds to 13) (e.g., a rear portion, a front portion and/or a side portion) and a fourth portion (e.g., portion mobile system that corresponds to 14) (e.g., a rear portion, a front portion and/or a side portion). In some embodiments, the third portion is positioned at a third terminal end of a second longitudinal axis (e.g., 22) of the mobile system and the third portion is positioned at a fourth terminal end of the second longitudinal axis of the mobile system different from the third terminal end. In some embodiments, elevating the mobile system includes raising the third portion of the mobile system without deceasing the elevation of the fourth portion of the mobile system. In some embodiments, elevating the mobile system includes raising the third portion of the mobile system and the fourth portion of mobile system. In some embodiments, elevating the mobile system includes raising the third portion of the mobile system and lowering the fourth portion of the mobile system.

In some embodiments, the mobile system (e.g., 10) further comprises a fourth set of one or more displays (e.g., 1000a and/or 1000b) (e.g., headlights, display screen, touch sensitive display, taillights, and/or a series of illumination sources) and a fifth set of one or more displays (e.g., 1000a and/or 1000b) (e.g., headlights, display screen, touch sensitive display, taillights, and/or a series of illumination sources). In some embodiments, the fourth set of one or more displays is disposed on the third portion (e.g., portion mobile system that corresponds to 13) of the mobile system and not the fourth portion of the mobile system (e.g., portion mobile system that corresponds to 114). In some embodiments, the fifth set of one or more displays is disposed on the fourth portion of the mobile system and not the third portion of the mobile system. In some embodiments, the fourth set of one or more displays is disposed on the third portion of the mobile system and the fourth portion of the mobile system. In some embodiments, the fifth set of one or more displays is disposed on the third portion of the mobile system and the fourth portion of the mobile system.

Note that details of the exemplary mobile system described above are also applicable in an analogous manner to other exemplary mobile systems described herein. For brevity, these details are not repeated below.

What is claimed is:

1. A mobile system, comprising:
an exterior surface at least partially surrounding an interior;
an illumination source positioned on the exterior surface, the illumination source configured to illuminate an environment exterior to the exterior surface, the mobile system configured to move relative to the environment in a first direction; and
a display positioned on the exterior surface configured to display a representation of an object detected in the proximity of the exterior surface, the display being obscured from the interior.

2. The mobile system of claim 1, wherein the display is comprised of one or more of a light plate assembly, a diffuser, a heatsink, a carrier, and a louver.

3. The mobile system of claim 1, wherein the display is configured to display a first indication of a state of the mobile system in accordance with a determination that the mobile system is in a first operational state, wherein the display is configured to display a second indication of the state of the mobile system in accordance with a determination that the mobile system is in a second operational state different from the first operational state, and wherein the second indication is different from the first indication.

4. The mobile system of claim 1, wherein the mobile system further comprises a mobile actuator, wherein the mobile actuator is configured to cause the mobile system to move in the first direction and a second direction perpendicular to the first direction.

5. The mobile system of claim 1, wherein the mobile system further comprises a first set of illumination sources that at least partially surrounds the display.

6. The mobile system of claim 1, wherein the mobile system further includes a second set of one or more illumination sources that at least partially surrounds the display, and wherein the second set of one or more illumination sources is configured to emit light at least partially around a light plate assembly of the display and through a cover lens of the display.

7. The mobile system of claim 1, wherein:
while the representation of the object is displayed:
in accordance with a determination that the object is a first distance from the mobile system, the representation is a first size; and
in accordance with a determination that the object is a second distance from the mobile system, the representation is a second size different from the first size.

8. The mobile system of claim 1, wherein:
in accordance with a determination that the mobile system is in a first state, the display is configured to display a first amount of light; and
in accordance with a determination that the mobile system is in a second state different from the first state, the display is configured to display a second amount of light different from the first amount of light.

9. The mobile system of claim 1, wherein:
in accordance with a determination that the mobile system is accelerating, the display is configured to increase amount of light output over time.

10. The mobile system of claim 1, wherein:
in accordance with a determination that the object is a first type of object, the display is configured to display the representation as a first type of representation; and
in accordance with a determination that the object is a second type of object different from the first type of object, the display is configured to display the representation as a second type of representation different from the first type of representation.

11. A non-transitory computer-readable storage medium storing one or more programs configured to be executed by one or more processors of a computer system that includes an exterior surface and that is in communication with an illumination source and a display, wherein the exterior surface at least partially surrounds an interior, wherein the illumination source is positioned on the exterior surface, wherein the display is positioned on the exterior surface, and wherein the one or more programs include instructions for:
illuminating, via the illumination source, an environment exterior to the exterior surface;
moving the computer system relative to the environment in a first direction;
detecting an object in the proximity of the exterior surface; and
in response to detecting the object in the proximity of the exterior surface, displaying, via the display, a representation of the object, wherein the display is obscured from the interior.

12. A computer system that includes an exterior surface and that is in communication with an illumination source and a display, wherein the exterior surface at least partially surrounds an interior, wherein the illumination source is positioned on the exterior surface, and wherein the display is positioned on the exterior surface, the computer system comprising:
one or more processors; and
memory storing one or more programs configured to be executed by the one or more processors, the one or more programs including instructions for:
illuminating, via the illumination source, an environment exterior to the exterior surface;
moving the computer system relative to the environment in a first direction;
detecting an object in the proximity of the exterior surface; and
in response to detecting the object in the proximity of the exterior surface, displaying, via the display, a representation of the object, wherein the display is obscured from the interior.
